(19) United States
(12) Patent Application Publication
(10) Pub. No.: US 2012/0185484 A1
(43) Pub. Date: Jul. 19, 2012

(54) METHOD AND SYSTEM OF SELECTING RESPONDERS

(75) Inventors: Scott A. Jones, Carmel, IN (US); Jeffrey Jockisch, Westfield, IN (US); Esther M. Friend, Indianapolis, IN (US); Eugene M. O'Donnell, Fishers, IN (US)

(73) Assignee: ChaCha Search, Inc., Carmel, IN (US)

(21) Appl. No.: 13/351,327

(22) Filed: Jan. 17, 2012

Related U.S. Application Data
(60) Provisional application No. 61/433,290, filed on Jan. 17, 2011.
(60) Provisional application No. 61/433,293, filed on Jan. 17, 2011.
(60) Provisional application No. 61/445,605, filed on Feb. 23, 2011.

(51) Int. Cl. G06F 17/30

(52) U.S. Cl. 707/740; 707/748; 707/E17.089; 707/E17.069

(57) ABSTRACT

A system and method of directing queries to human assistants who may be users of an information search system is described. An area of interest of a user is identified based on queries and/or other activities of the user. When a request is received analysis of available human assistants is performed to determine a suitable human assistant to aid in production of a response includes directing a task to a user associated with the type of request received.

### CROSS-REFERENCE TO RELATED APPLICATIONS

This disclosure claims priority to U.S. Provisional Application Ser. No. 61/433,290, inventor Scott A. Jones, titled “METHOD AND SYSTEM OF SHARING QUERY CONTENT”, filed Jan. 17, 2011, U.S. Provisional Application Ser. No. 61/433,293, inventor Scott A. Jones et al titled “METHOD AND SYSTEM OF SELECTING RESPONDERS”, Jan. 17, 2011; and U.S. Provisional Application Ser. No. 61/445,605, inventor Eugene M. O'Donnell titled “METHOD AND SYSTEM OF HUMAN ASSISTED DECISION MAKING”, filed Feb. 23, 2011; the contents of all which are incorporated herein by reference in their entirety.

### BACKGROUND

1. Field of the Invention

The present invention is related to processing of queries and specifically related to a method and system of selection a person to respond to a request for information.

2. Description of the Related Art

In a system wherein generalized queries are answered the cost to respond to a query is crucial to system performance. If this cost is high, usage of the service may be inhibited. To overcome this, classical answering services such as search engines are supported by advertising revenue in a manner similar to the Yellow pages or sponsored listings. But this model may be difficult to support when human intelligence is added to the system. While a person may greatly improve response quality, the cost of human effort is typically much higher than the cost of computation.

Some attempts to solve this problem are exemplified by peer-to-peer answering systems such as Mosio, Google Answers, Answerbag, and Aardvark. These systems solve the cost of answering by letting users respond to each other in a bulletin board type environment. But these systems have some intrinsic weaknesses. Query response time may be on the order of hours to days as a question is not posted to a person in real-time. Routing a query to a person interested in the topic may be difficult, particularly when the number of users is small. A large percentage of questions may be answered by a limited number of users which may limit the available expertise. Users may be unlikely to respond to queries of a conversational nature if they are not of interest to the user.

In order to overcome the problems of latency, quality, and diversity a paid searcher may be employed. Systems which pay people to answer queries have been implemented. Such systems produce much better results in a timely manner. But there may be times when the total number of queries is greater than the available number of human searchers or guides available to respond.

In light of these and other problems, a system for selectively routing queries to human responders would be greatly appreciated.

### SUMMARY

A system is provided which includes a query processing server which receives queries, determines an appropriate response, and distributes the query, a guide system operated by a human searcher receiving a request and providing a search result, a user system submitting a request, a user system of a user who has agreed to accept queries from other users and, a database recording information associated with processing of queries.

When a query is received by a search system, the query may be analyzed to determine if an automated response to the query is suitable. When an automated response is not suitable, the query may be analyzed to determine if it is probable that the query may be answered by a reviewer or expediter. Factors such as query content, user history, user profile, time of day, system loading and others may affect the probability that a query will be determined to be suitable for an expediter. An expediter may be selected based on query content. If it is determined by automated and/or human assisted processing that a query requires a searcher, the query may be directed to a paid searcher and/or to a user who has agreed to accept queries from other users also referred to as a responder. A responder may perform any task which can be assigned to a guide or searcher such as an expediter, searcher, transcriber, etc.

A responder may be selected based on content of a query. Attributes associated with the responder may be determined based on queries, answers, and/or other information obtained regarding a user. A user may be invited to become a responder based on user activities. A user may be selected to receive a query based on temporal information associated with a user activity.

Additional aspects and/or advantages will be set forth in part in the description which follows and, in part, will be apparent from the description or may be learned by practice of the invention. These together with other aspects and advantages, which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a database for users.

FIG. 4 illustrates a database for guides.

FIG. 5 illustrates a database for responders.

FIG. 6 is a flowchart of responding to a request.

FIG. 7 is a flowchart of registering and maintaining a responder.

FIG. 8 is an exemplary sequence of messages of a user and a responder in an embodiment.

FIG. 9 is an exemplary sequence of messages of registration of a responder in an embodiment.

FIG. 10 is a block diagram of an exemplary system embodiment.

FIG. 11 illustrates a database for requests.

FIG. 12 illustrates a database for users.

FIG. 13 illustrates a database for guides.

FIG. 14 illustrates a database for distributors.

FIG. 15 is a flowchart of registering a distributor.

FIG. 16 is a flowchart of processing a request.

FIG. 17 is a flowchart of distributing a request.

FIG. 18 illustrates a GUI (graphical user interface) for responding to a query in a forum.

FIG. 19 illustrates a GUI responding to queries in an expertise quiz environment.

FIG. 20 illustrates a GUI for a social network game environment.

FIG. 21 illustrates a GUI for responding to a query in a social network game environment.

FIG. 22 illustrates a sequence of messages for responding to a request in a messaging service environment.

FIG. 23 is a block diagram of an exemplary system embodiment.

FIG. 24 illustrates a database for requests.

FIG. 25 illustrates a database for users.

FIG. 26 illustrates a database for guides.

FIG. 27 is a flowchart of responding to a request.

FIG. 28 is a flowchart of a multi-level decision process.

FIG. 29 illustrates a typical confidence function and thresholds.

FIG. 30 illustrates a graphical user interface (GUI) for a preprocessing decision.

FIG. 31 illustrates a GUI for a review decision.

FIG. 32 illustrates a GUI for a routing decision.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a query and receiving a response, a search server receiving the query, a database storing information of queries, search results, searchers, users, and other information, a guide system receiving a query and providing a search result, and a responder system receiving and sending queries and answers.

A system is implemented to allow a user to submit a query and receive a response. A response may include any type of media such as text, URL's, audio, video, a web page, flash code, etc. A response may be produced automatically and/or using the assistance of a person.

Processing of a query may be divided into various layers. A first layer may consist of automated processing of the query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive.

A third layer of processing of a query may include a human assistant who responds to the query or “searcher”. A searcher may receive an interpreted query, information of a source of the query, and be provided with resources for performing a search responsive to a query. A searcher may formulate a response based on the interpreted query, and submit the response for delivery to a user responsive to the query.

A fourth layer of processing of a query may include a human assistant who audits and/or vets responses or “examiner” or “vetter”. For example an examiner may receive a query, information of a response, and may accept and/or revise the answer. In some instances an examiner may be provided with multiple responses and may select a response. Automated assistance may be provided to an examiner and/or applied to a response based on an examiner action which may include tools for correction of spelling, grammar, formatting, etc. of a response which may be used to provide an answer to a user query.

Any or all of the functionalities of expediter, searcher, or examiner may be performed by a user and/or a paid searcher. In order to determine whether a particular query will be directed to a paid searcher, a user or both various conditions may be evaluated. A paid searcher may receive a query preferentially. Paid searchers may be selected based on a ranking of the available paid searcher for a query. In at least one embodiment, expediters, searchers and examiners are selected based on content of a query. For example, a query may be categorized and a human assistant associated with the category may be given higher priority than a human assistant that is not associated with the category.

If it is determined that a query is to be routed to a responder, it may be necessary to select one or more responders to whom it will be directed. A responder profile may be used to determine whether a responder will receive a query. As many responder may be unwilling or unable to provide profile information which might be used to select queries which are provided to the responder, historical queries associated with the responder may be used to determine a profile. For example, if a responder has submitted queries regarding a particular topic, associated with a keyword, named entity, etc. that may be used to determine targeting information for a query to be provided to the responder. A user may be requested to opt-in to receive queries and act as a responder. For example, if a user asks for information about “General Motors”, the user might be asked if the user is willing to respond to questions regarding “General Motors” or keywords associated with “General Motors” like “Chevy Volt” or “American Cars”. In general, an ontology which is used to classify queries received might be used to determine what types of queries a responder might receive. If a user has signed up to receive unsolicited or “push” messages or “alerts” regarding a topic, keyword, etc., queries related to the alert topics may be given a higher priority for the user.

If a user opts-in to receive queries, the system may determine whether a responder is likely to accept a query. Factors such as recent submission of a query, frequency of submission of queries, response time, response frequency, and relationships to types and/or classes of queries may be used to determine whether a responder is to receive a query. In at least one embodiment, a user may receive a query when the user submits a query. In instances where presence information is available such as Instant Messaging presence information may be used to determine a priority for sending a query to a user. If a user is present and has recently submitted a query regarding a category, a query associated with the category might be directed to the user during a time period when the user is waiting for a response. Likewise, if a user is registered for a keyword, a query associated with the keyword might be directed to the user when a user has submitted a number of queries in a given time interval.

A responder in the expediter role may be provided with a generalized query and invited to respond with a free-form or personal response. This might be used to establish a form of ‘random conversation’. If a user receiving the query elects to converse, the system may route queries and responses back and forth between the originator of the query and the user receiving the query without revealing the identity or contact information of the users. Likewise, a user might elect to receive ‘random conversations’ from locations, types of persons, etc. A responder performing the expediter role might be offered a query and a number of highest ranking answers for a query, and asked to select an answer or ‘none of these’.

A responder in the searcher role may be invited to respond to a query using a free-form answer, and/or any other available answer. A searcher may or may not be provided with a tool set for responding to a query. For example, if a responder device has limited capabilities, the responder may be asked to respond in a limited manner, while if the user elects to respond using a more capable platform, various capabilities available to paid searchers might be made available.

A user in the examiner mode might be provided with an interface similar to that of an expediter. In some instances a simple query and answer with an ‘up/down’ selection might be provided. Any type of reviewing interface might be provided to an examiner. For example, an examiner might receive information of a query and multiple answers and make a selection as with an expediter.

A user may be eligible and/or registered for any or all roles, and may be prioritized for a role based on performance criteria associated with the role and/or other selection variables such as keywords, categories, geographic, demographic, affiliation, etc. associated with the user. A user may agree to perform a particular role, and/or may be provided with queries associated with a role based on performance evaluations. For example, if a user responds to queries associated with the expediter role frequently, but responds to queries associated with the searcher role infrequently, it may be more likely that the user will be presented with queries associated with the expediter role.

As used herein, a “request” means a request for information, products, and/or services. A request or search request or query may include various types of media, and may be provided by any user system which may establish communication with a server and/or other devices associated with a search service. A request may be referred to as a “search request”, “search query”, “query”, “search”, “question”, or “inquiry”.

A “user” is a person who submits a request and may receive any type of information responsive to a request. A user may be any person or entity. A “guide” is a person who assists in processing a request. A guide may be referred to as a “provider”, “searcher”, “human searcher”, “expediter”, “transcriber”, “specialist”, “generalist”, “examiner”, “vetter” or “auditor”. Guides may be assigned various roles. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

A “responder” is a user who elects to receive queries from the system. A responder may receive compensation for responding to queries. A responder may be able to perform any or all guide roles, and may be provided with any or all tools and/or resources available to a guide.

An “advertiser” is any person and/or entity which may provide promotional information or “advertisements” to be delivered to a user. An advertisement may take various forms and/or may include media of any sort which can be delivered to a user device. A “result”, “response”, “reply”, “answer” or “search result” is any information which has been determined to be a response to a request. A result may include an advertisement. A result may be any information which is determined to be a response to a request. A “resource” or “search resource” may be any source of information which may provide a search result. A resource may include a search engine, a web server, a software application, an API, printed media, an RSS feed, streaming media, a web page, etc. A “profile” may be any information associated with a person such as demographic data, geographic data, personality data, affiliations, etc.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication apparatus might be used to establish a communication session.

Communication between a user, a guide and/or a search system may include conversion of text to speech and speech to text. Any type of media which can be sent and/or received using a communication system may be part of a communication session. A communication session may be conducted using any or all communication services associated with a user, a guide, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, and/or a request may be rated. Rating information may be obtained from a user, a guide, and/or an administrator of a search system. Rating information may be used to select a user, a guide, a request, a result, a responder and/or any item based on information associated with an item indicated in a database. A search service may be compensated by advertising revenue. Advertising and/or content may be delivered to a user and/or a guide using any communication service associated with a user and/or a guide.

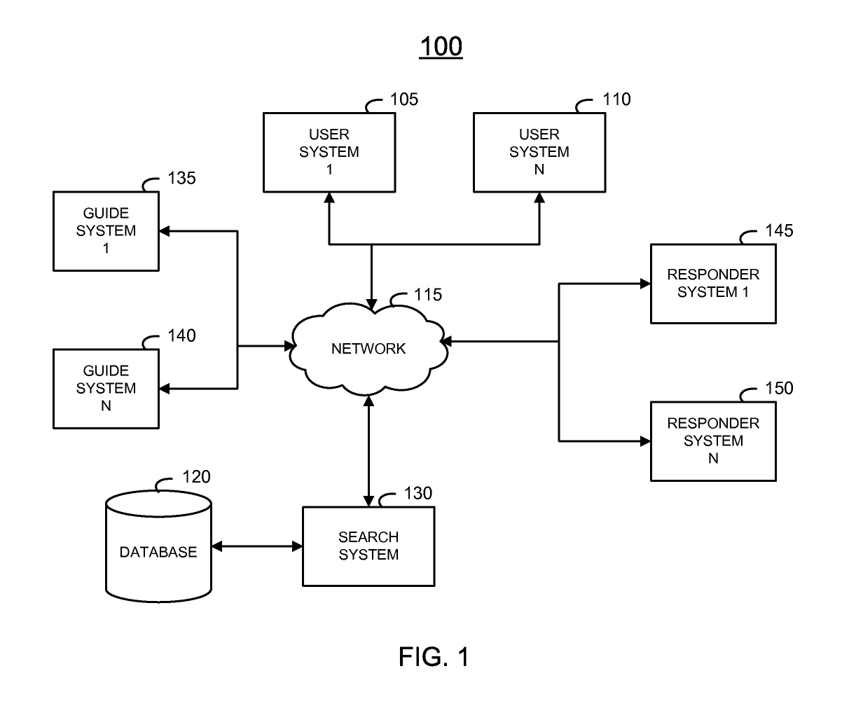

As illustrated in FIG. 1, system 100 includes user systems 105, 110, a network 115 such as the Internet, a search system 130, a database 120, which may comprise various records, guide systems 135, 140, and responder systems 145, 150.

While only a few systems associated with a user, a responder, and a guide are depicted in FIG. 1 it is within the scope of the disclosure for multiple systems for a user, responder, and guide to be utilized. In particular it is envisioned that many user, responder and guide systems may be implemented. A search system may be a composed of many components as described further herein.

Any user system (e.g. the user system 105) can be used, to submit a request to the search system 130 and/or receive a result and/or other information. Any user system may receive a response, and/or may provide compensation to the search system 130.

The network 115 may be a global public network of networks (i.e., the Internet) and/or may consist in whole or in part of one or more private networks and communicatively couples the user systems 105, 110, the guide systems 135, 140, and the responder systems 145, 150 with the other components of the system such as the search system 130, and the database 120. The network 115 may include one or more wireless networks which may enable wireless communication between the various elements of the system 100. For example, the search system 130 may receive messages which may be routed via a wireless network controlled by a wireless service to the user systems 105, 110. A wireless service may receive messages from the guide systems 135, 140 via a wireless network which is a part of the network 115, and provide the messages to the search system 130 via an internet connection which is part of the network 115. Similarly a voice communication via wired and/or wireless communication might be established between any elements of the system 100.

The search system 130 allows interaction to occur among the user systems 105, 110, the guide systems 135, 140, and the responder systems 145, 150. For example, a request can be transmitted from the user system 105 to the search system 130, which may provide information obtained from the database 120, which may include an advertisement provided by an advertiser to the user system 105. Similarly, a search result from a searcher operating the guide system 135 and/or a responder operating the responder system 145 might be routed to the search system 130, which might process the response and provide a message to the user system 105. Any type of communication between users, responders and/or guides may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one hardware server. Elements of the database 120 may reside in any suitable elements of the system 100. Any or all elements of the system 100 may include any or the entirety of the database 120.

The user systems 105, 110, the guide systems 135, 140, the responder systems 145, 150 and the search system 130 may include equipment, software, systems and personnel required to send and/or receive messages between a user system 105, 110, the guide systems 135, 140, the responder systems 145, 150 and/or the search system 130 using the network 115. The database 120 includes information which may allow the search system 130 to establish communication between any or all of the elements of the system 100.

A user system, a guide system, a responder system and/or a search system may be a desktop, tablet, or portable PC or Mac®, a mobile phone, a smart phone, a PDA, a hardware server system, a landline phone, a specialized communication terminal, a terminal connected to a mainframe, or any other communication device and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP®, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, responder systems and/or to implement the search system 130.

A user may be identified by the search system 130. When a user system, such as the user system 105, establishes a communication session with the search system 130, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 105 and a responder system, a guide system and/or the search system 130. Information such as a keyword, a category, a user profile, a request, a result, etc., may be associated with a user. A user may be required to provide profile information to the search system 130. A user may elect to receive requests from the search system 130. If a user elects to receive requests, the user may be requested to provide additional information which may be used to register the user as a responder such as a user of the responder system 145. Parameters and/or attributes may be associated with a responder as will be further described herein below. Information of a user may be stored in the database 120.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 135 in order to communicate with the search system 130. Multiple communication services may be associated with a guide and may allow a communication session to be established between a guide system such as the guide system 135 and a user system, a responder system, and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a responder system and/or the search system 130.

When a guide registers with the search system 130 the guide may be associated with one or more keywords, categories, and/or other information. Information associated with a guide may be stored in the database 120 and may be used for various purposes. Information associated with a guide may be used to rank requests, resources, results, advertisements and/or other information which may be presented to the guide. In at least one embodiment, payment information is associated with a guide. In at least one embodiment, a guide may be required to undergo testing to determine whether a guide is able to perform any tasks which may be required by an operator of the search system 130. For example, a guide may be assigned to a role such as translator, transcriber, expediter, generalist, specialist, examiner, etc.

Records may be maintained in the database 120 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein. An item may be any real and/or virtual object which may be tracked and/or represented by information included in a database such as the database 120.

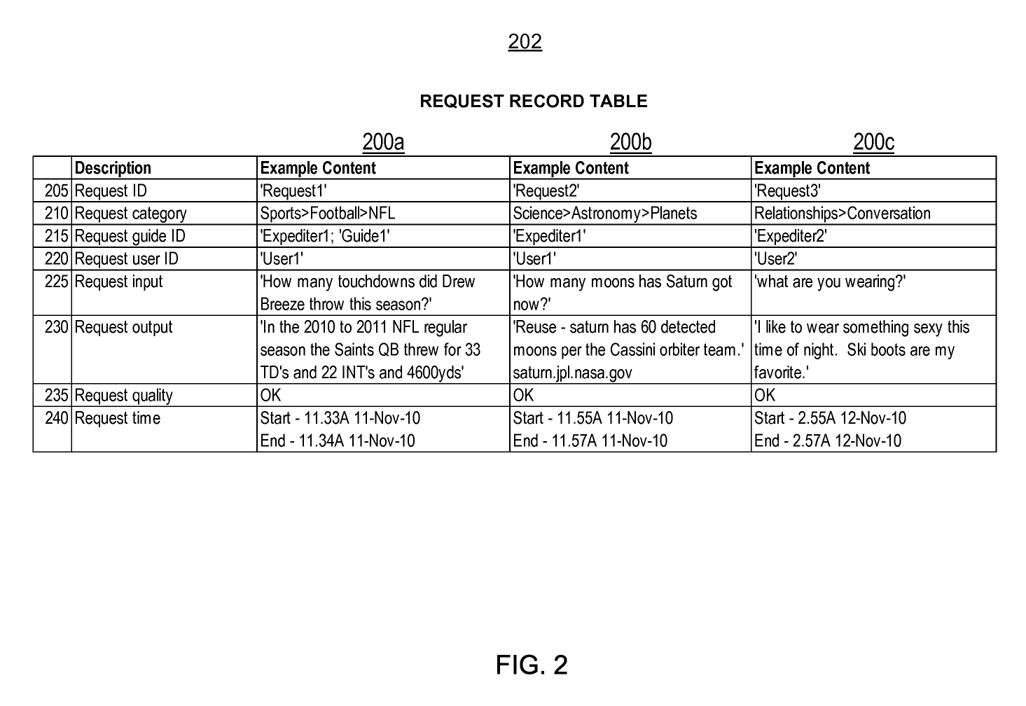

As illustrated in FIG. 2 an exemplary request record table 202 which may comprise a number of request records 200 of which one or more may be associated with or resident in the database 120 (FIG. 1) is provided. The request record table 202 may include information of requests which may be processed. The request records 200 may include a request ID field 205, a request category field 210, a request guide ID field 215, a request user ID field 220, a request input field 225, a request output field 230, a request quality field 235, and a request time information field 240.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category associated with a request may be used to rank guides who may be associated with the type of request. Likewise, a category associated with a request may be used to rank requests which may be presented to a responder. A category associated with a request may be determined based on factors such as keywords of the query, a profile of a user, a selection of a guide, etc. A category associated with a system taxonomy may be indicated in the request category field 210. A category may be associated with a request automatically and/or using the assistance of a person. Using the example in FIG. 2, ‘Request2’ may be categorized as ‘Science>Astronomy>Planets’ as indicated in the request record 200b. This may indicate that a person or item associated with the category ‘Science>Astronomy>Planets’ may have a higher ranking for responding to ‘Request2’. A category of a request may be associated with a user submitting the request.

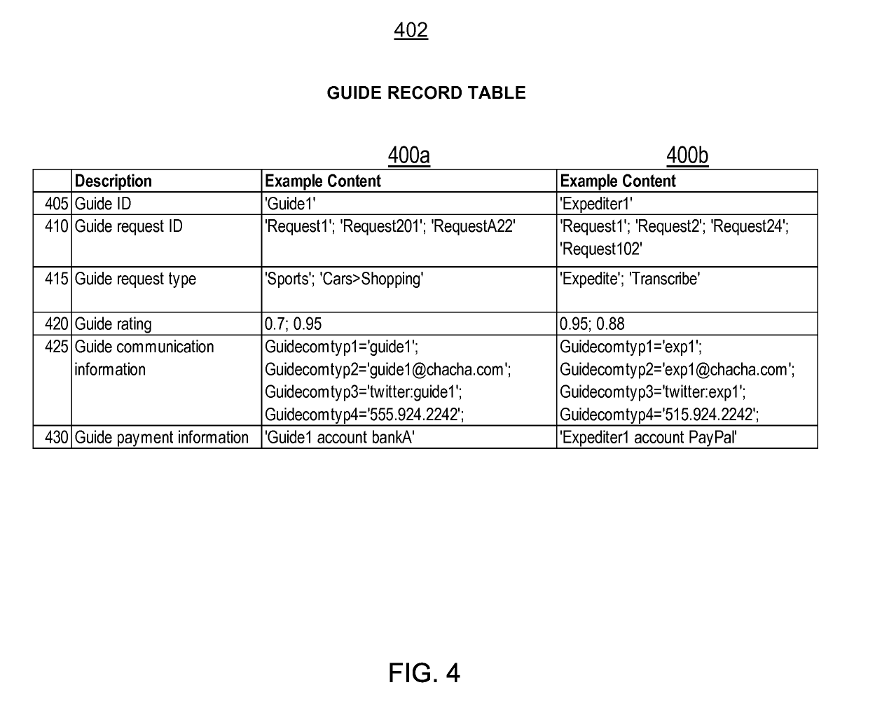

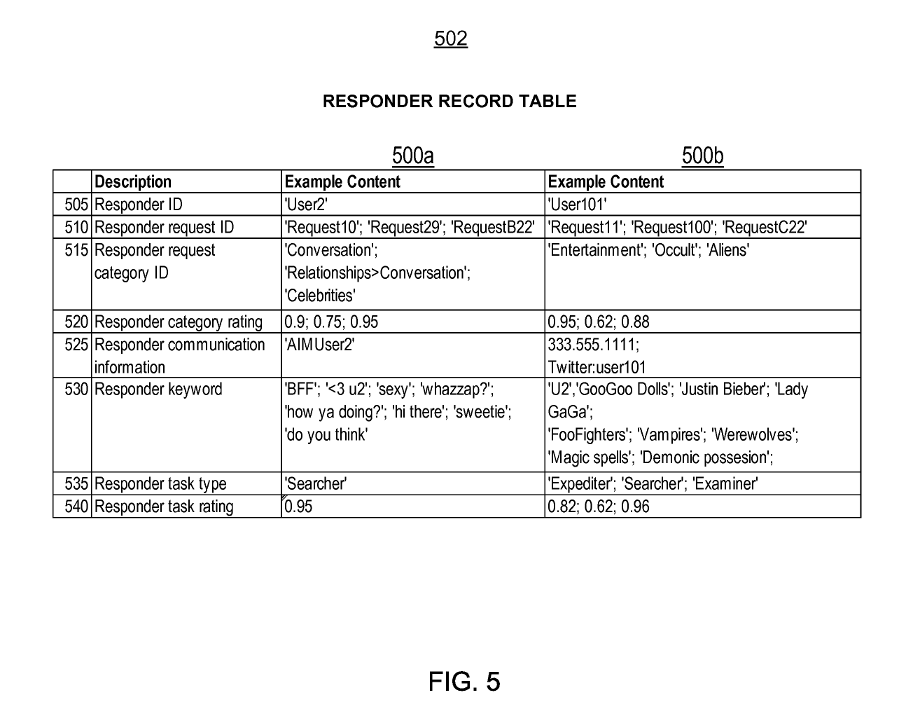

The request guide ID field 215 may include information of a number of guides and/or responders associated with a request. Content of the request guide ID field 215 may be used to obtain information of a guide and/or responder using a record such as the guide record 400a (FIG. 4) and/or the responder record 500b (FIG. 5). If a person is selected for a request, elects to receive a request, provides a response to a request, reviews a result of a request and/or completes a request, an identifier of the person may be indicated in the request guide ID field 215. Using the example in FIG. 2, ‘Expediter1’ and ‘Guide1’ are associated with ‘Request1’. This may for example indicate that ‘Request1’ has been processed by ‘Expediter1’ completed by ‘Guide1’.

The request user ID field 220 may include information of a number of users associated with a request. Content of the request user ID field 220 may be used to obtain information of a user associated with a request. For example, if a request is submitted by a user, an identifier of the user may be indicated in the request user ID field 220. A request may not be associated with a user request. For example, the search system 130 (FIG. 1) may provide requests to responders and/or guides which are not directly related to a user request. Using the example in FIG. 2, ‘User1’ is associated with ‘Request1’ and ‘Request2’ while ‘User2’ is associated with ‘Request3’. This may indicate that ‘Request1’ and ‘Request2’ were submitted by ‘User1’ while Request3′ was submitted by ‘User2’.

The request input field 225 may include information of a request. Content of the request input field 225 may be provided to a person who accepts a request. Content of the request input field 225 may include any type of information. For example, a pointer to audio, video, text, and/or other media may be indicated in the request input field 225. As illustrated in FIG. 2, the query ‘How many touchdowns did Drew Breeze throw this season?’ is the request input associated with ‘Request1’. In at least one embodiment, the request input field 225 may indicate an original user request, a categorization, and a rewritten user request.

The request output field 230 may include information of a response associated with a request. Content of the request output field 230 may be provided to a user responsive to a request. Content of the request output field 230 may be stored in the database 120 (FIG. 1). Content of the request output field 230 may be reviewed by a user, a guide, and/or an administrator. As illustrated in FIG. 2, the response ‘I like to wear something sexy this time of night. Ski boots are my favorite.’ is associated with ‘Request3’ as illustrated in the request record 200c. While a text response to a query is used for the purposes of illustration, any type of media may be indicated in the request output field 230. In at least one embodiment, a text response and a URL associated with a source of the text response may be indicated in the request output field 230.

The request quality field 235 may include information of a quality rating associated with a request. Content of the request quality field 235 may affect compensation provided and/or a rating and/or ranking of an item such as a guide, a response, etc. For example, if a guide achieves a specified level of quality performance, additional points may be credited to the guide. A quality rating may be any type of indication, such as a flag, a numeric value, etc. Content of the request quality field may be produced automatically and/or using the assistance of a person. For example, a confirmation and/or rejection of a response by an examiner may be used to determine content of the request quality field 235. Using the example in FIG. 2, the quality flag ‘OK’ is associated with all the request records 200, which may indicate that ‘Request1’, ‘Request2’, and ‘Request3’ have passed a quality check. In at least one embodiment, multiple responses may be associated with a request as indicated in the request output field 230, which may be linked to a quality rating in the request quality field 235.

The request time field 240 may include temporal information associated with a request. Content of the request time field 240 may be used for various purposes. For example, completion time of a request may be used to determine a period associated with compensation for completing the request. Temporal or time information associated with a request may be used to determine a rating of the request. For example, if a responder is taking a longer or shorter time than other persons for completing a request, a rating of the responder may be adjusted. Time information associated with a request may be used to select a responder. For example, if a responder has recently submitted a query, the responder may be more likely to be selected to receive a query than a responder who has not submitted a query recently.

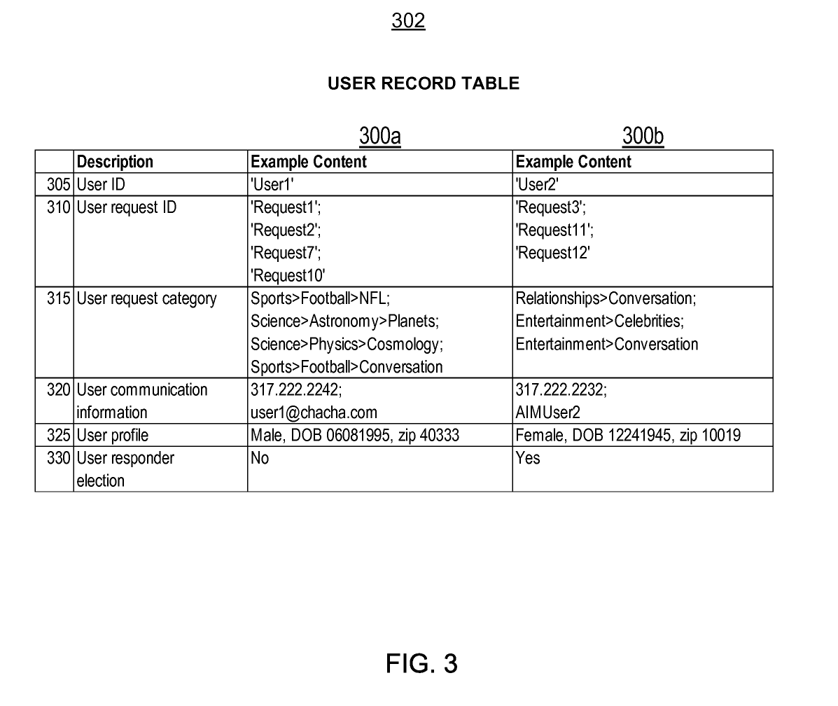

As illustrated in FIG. 3 an exemplary user record table 302 which may comprise a number of user records 300 of which one or more may be associated with or resident in the database 120 (FIG. 1) is provided. The user record table 302 may include information of users. The user records 300 may include a user ID field 305, a user request ID field 310, a user request category field 315, a user communication information field 320, a user profile field 325, and a user responder election field 330.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User1’ is the user ID associated with the user record 300a.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request3’ and ‘Request11’ and ‘Request12’ are associated with ‘User2’ as indicated in the user record 300b. This may indicate that ‘User2’ has submitted ‘Request3’ and ‘Request11’ and ‘Request12’. A number of queries associated with a user may affect a probability that a user receives a proposal to be a responder. For example, if a user has submitted a number of queries, or a user has submitted a number of queries regarding a keyword of category, or a user has registered to receive push notifications, the probability that a user will be invited to become a responder may be modified or adjusted.

The user request category field 315 may include information regarding a category or type associated with a user request. For example, if a request is directed to a type of processing or a category, etc. a type and/or category associated with the processing may be indicated in the user category type field 315. In at least one embodiment, the user request ID field 310 and the request user category field 315 are linked by for example a pointer. A count of requests associated with a category may affect a probability that a user receives a proposal to be a responder for queries associated with the category.

The user communication information field 320 may include information of a number of communication services associated with a user. Any information which may be used to establish communication with a user may be indicated in the user communication information field 320. For example, a telephone number, an email address, an IM credential, a URL, a username, a password, and/or other communication information may be indicated in the user communication information field 320. Using the example in FIG. 3, the phone number ‘317.222.2242’ and the email ‘user1@chacha.com’ are associated with the ‘User1’. Information indicated in the user communication information field 320 may be used to select a user to receive a frivolous query.

The user profile field 325 may include information of a profile associated with a user. For example, demographic, geographic, affiliation, personality, and/or other types of information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 3, ‘Female, DOB Dec. 24, 1945, zip 10019’ are associated with ‘User2’. Profile information may be used to match information provided by a user to other information. For example, a ranking of a guide for a query of a user may be adjusted based on a profile associated with the user.

The user responder election field 330 may include information of a type of query a user is willing to accept. For example, if a user elects to receive queries which are associated with sports this may be indicated in the user responder election field 330. In at least one embodiment, a user may be able to elect to receive queries filtered for content, topic, keyword, location, etc. As illustrated in FIG. 3, ‘User2’ has elected to respond to user queries.

As illustrated in FIG. 4 an exemplary guide record table 402 which may comprise a number of guide records 400 of which one or more may be associated with or resident in the database 120 (FIG. 1) is provided. The guide record table 402 (FIG. 4) may include information of guides. The guide records 400 may include a guide ID field 405, a guide request ID field 410, a guide request type field 415, a guide rating field 420, a guide communication information field 425, and a guide payment information field 430.

The guide ID field 405 includes an identifier of a guide which is preferably unique and is preferably used consistently. A guide ID serves to distinguish a guide record associated with a guide from a guide record associated with other guides. Any number of characters, numbers, and/or other indicators may be used to indicate a guide ID. In at least one embodiment, a random number is indicated in the guide ID field 405. In at least one embodiment, a pseudonym selected by a guide may be indicated in the guide ID field 405. Using the example in FIG. 4, ‘Guide1’ is the guide ID associated with the guide record 400a.

The guide request ID field 410 may include information of a number of requests associated with a guide. Content of the guide request ID field may be used to obtain information of a request. For example, if a user request has been determined to require a number of requests to be performed, the search system 130 (FIG. 1) may assign a unique ID to the requests and may distribute information of the requests to guides. Using the example in FIG. 4, ‘Request1’, ‘Request2’, ‘Request24’ and ‘Request102’ are associated with ‘Expediter1’ as indicated in the guide record 400b. This may indicate that ‘Expediter1’ has expedited ‘Request1’, ‘Request2’, ‘Request24’ and ‘Request102’.

The guide request type field 415 may include information of a number of types of requests which may be processed by a guide. For example, a category and/or keyword associated with a request, a type of request, temporal information associated with a request, etc., which may be used to determine if a guide is to be presented with a request may be indicated in the guide request type field 415. In at least one embodiment, a guide may be assigned to a particular type of request as part of a registration process. A guide may select a type of request which the guide may perform. A guide may be required to pass a test in order to be associated with a type of request. Using the example in FIG. 4, ‘Guide1’ is associated with ‘Sports’ and ‘Cars>Shopping’, which may for example indicate that ‘Guide1’ may be presented with and/or select requests associated with any search for information associated with ‘Sports’ and ‘Cars>Shopping’.

The guide rating field 420 may include information of a number of ratings associated with a guide. For example, quality, speed, peer review, etc., may be used to determine a rating of a guide. A rating of a guide may be used for purposes such as determining compensation for the guide (e.g. bonus points), selecting a guide to respond to a request, matching a request to a guide, etc. In at least one embodiment, the guide request type field 415 and the guide rating field 420 may be linked by, for example, a pointer. Using the example in FIG. 4, ‘Expediter1’ has a rating of ‘0.95’ associated with ‘Expedite’, and a rating of ‘0.88’ associated with ‘Transcribe’ which may be used to rank ‘Expediter1’ versus other guides associated with the request types ‘Expedite’ and ‘Transcribe’.

The guide communication information field 425 may include information of a number of communication services associated with a guide. For example, a user name and password, an email address, an IM credential, a phone number, a web page, a physical address, etc., may be indicated in the guide communication information field 425. Using the example illustrated in FIG. 4, ‘Guide1’ is associated with the login ID ‘guide1’, the email ‘guide1@chacha.com’, and the phone number ‘555.924.2242’. This may indicated that ‘Guide1’ may be contacted using the associated communication services.

The guide payment information field 430 may include information of a payment method associated with a guide. For example, banking information, a PayPal® account, a Western Union® account, etc., may be indicated in the guide payment information field 430. Content of the guide payment information field 430 may be used to provide compensation to a guide. For example, payment may be made by Automated Clearing House (ACH), wire transfer, etc., using information indicated in the guide payment information field 430.

As illustrated in FIG. 5 an exemplary responder record table 502 which may comprise a number of responder records 500 of which one or more may be associated with or resident in the database 120 (FIG. 1) is provided. The responder record table 502 (FIG. 5) may include information of responders. The responder records 500 may include a responder ID field 505, a responder request ID field 510, a responder request category ID field 515, a responder rating field 530, a responder task type field 535, and a responder task rating field 540.

The responder ID field 505 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a user ID associated with a user record may be indicated in the responder ID field 505. Using the example in FIG. 5, ‘User2’ is the responder ID associated with the responder record 500a. This may indicate that ‘User2’ has opted in to receive requests.

The responder request ID field 510 may include information of a number of requests associated with a responder. Content of the responder request ID field 510 may be used to obtain information of a request. For example, if a user request has been distributed to a requester, an identifier of the request may be indicated in the responder request ID field 510. Using the example in FIG. 5, ‘Request11’, ‘Request100’ and ‘RequestC22’ are associated with the responder ‘User101’ as indicated in the work record 500b. This may indicate that ‘User101’ has received and/or responded to ‘Request11’, ‘Request100’ and ‘RequestC22’.

The responder request category ID field 515 may include information of a number of categories of requests which may be processed by a responder. For example, a category and/or keyword associated with a request, a type of request, etc., which may be used to determine if a responder is to be presented with a request may be indicated in the responder request category ID field 515. In at least one embodiment, a responder may be assigned to a particular category of request as part of a registration process. A responder may select a type and/or category of request which the responder may receive. A responder may be required to pass a test in order to be associated with a type of request. Using the example in FIG. 5, ‘User2’ is associated with ‘Conversation’, ‘Relationships>Conversation’, and ‘Celebrities’.

The responder category rating field 520 may include information of a number of ratings associated with a responder. For example, quality, speed, peer review, etc., may be used to determine a rating of a responder. A rating of a responder may be used for purposes such as determining compensation for the responder, selecting a responder to respond to a request, matching a request to a responder, etc. In at least one embodiment, the responder request category ID field 515 and the responder category rating field 520 may be linked by, for example, a pointer. Using the example in FIG. 5, ‘User2’ has a rating of ‘0.90’ associated with ‘Conversation’, which may be used to rank ‘User2’ versus other responders associated with the request type or category ‘Conversation’. A responder may have ratings corresponding to various categories and/or parameters such as a keyword, profile, resource, affiliation, etc. A responder may have a general rating and/or ranking which may be based on one or more ratings associated with other items.

The responder communication information field 525 may include information of a number of communication services associated with a responder. For example, a user name and password, an email address, an IM credential, a phone number, a web page, a physical address, etc., may be indicated in the responder communication information field 525. A communication service indicated in the responder communication information field may for example be used to indicate a service by which a responder may elect to receive requests, a priority order of communication services, etc. Using the example illustrated in FIG. 5, the IM handle ‘AIMUser2’ is associated with ‘User2’. This may indicate that ‘User2’ may receive a request and provide a result using the AIM instant messaging service as ‘User2’. The user record 300b indicates that ‘User2’ may be contacted using the phone number ‘317.222.2232’ and ‘AIMUser2’, but ‘User2’ may have only elected to receive requests via ‘AIMUser2’.

The responder keyword field 530 may include information of a number of keywords associated with a responder. A match to a keyword indicated in the responder keyword field 530 may affect a probability that a request will be provided to a responder. For example, a match may prohibit a query from being directed to a responder, may increase a ranking of a responder, may be used to associated a category with a request, etc. In at least one embodiment, keywords included in requests for which a responder has provided an answer may be more highly ranked for a category associated with the query and the responder.

The responder task type field 535 may include information of a number of task types associated with a responder. A task type may include guide roles such as expediter, searcher, examiner, transcriber, translator, and/or other types of tasks which may be performed by a responder. A responder may be associated with a type of task based on an action of the responder. A responder may be unaware of a type associated with the responder. A task type associated with a responder may be used to determine whether a request will be directed to the responder. For example, if a responder agrees to respond to opinion requests, the responder may be provided with examiner tasks associated with the categories and/or keywords associated with the responder. If a responder agrees to respond to request associated with a category, the responder may be notified of searches which are associated with the category and the search type.

The responder type rating field 540 may include information of a number of ratings of a responder associated with a type of task. A rating of a responder associated with a type may be used to rank responders and may affect a probability that a request of the type will be provided to a responder. As illustrated in FIG. 5, ‘User101’ has a high rating associated with ‘Expediter’ and ‘Examiner’ but a low rating of 0.62 associated with ‘Searcher’, while ‘User2’ has a high rating of 0.95 associated with ‘Searcher’. This may indicate that a query associated with ‘Celebrities’ which required a ‘Searcher’ task would be more likely to be provided to ‘User2’ than ‘User101’.

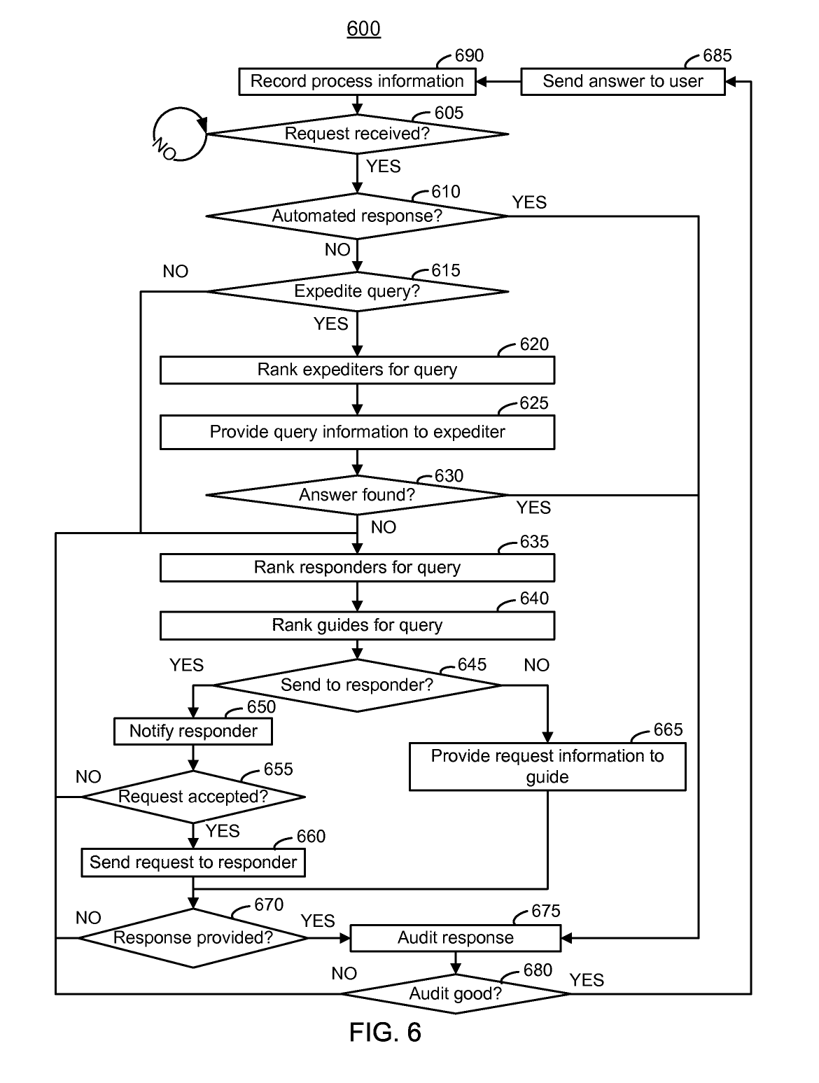

As illustrated in FIG. 6, a process 600 for responding to a request is provided. The process 600 may be performed in whole or in part by any suitable element of the system 100 (FIG. 1). In at least one embodiment, the process 600 is operative on a server associated with the search system 130 (FIG. 1).

In operation 605 (FIG. 6) a determination is made as to whether a request is received. If it is determined in operation 605 that a request is not received, control remains at operation 605 and process 600 continues. If it is determined in operation 605 that a request is received, control is passed to operation 610 and process 600 continues.

The determination in operation 605 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. In at least one embodiment, if a message is received at a server associated with the search system 130, it may be determined that a request is received.

In operation 610 (FIG. 6) a determination is made as to whether an automated response is acceptable. If it is determined in operation 610 that an automated response is acceptable, control is passed to operation 675 and process 600 continues. If it is determined in operation 610 that an automated response is not acceptable, control is passed to operation 615 and process 600 continues.

The determination in operation 610 may be made in various ways. For example, a query may be compared to a template, a Regular Expression (RegEx) expression, a historical query, etc. in order to determine whether an automated response is acceptable. An automated response may be any response that is produced by sending a query to a system which retrieves information without intervention by a person. For example, a search engine, an RSS feed, a database look-up of a query, a program resident on a computer system and/or other programmatic system for retrieving information may provide an automated response.

In operation 615 a determination is made as to whether a query is to be expedited. If it is determined in operation 615 that a query is to be expedited, control is passed to operation 620 and process 600 continues. If it is determined in operation 615 that a query is not to be expedited, control is passed to operation 635 and process 600 continues.

The determination in operation 615 may be made according to various criteria. A number of available expediters, a confidence factor associated with categorization and/or classification of a query, a number and type of responders and/or searchers available may be used to determine whether a query is to be expedited. Levels of activity and temporal information may be used to determine whether a query is to be expedited. In at least one embodiment, all queries are expedited.

In operation 620 expediters are ranked for a query. In at least one embodiment, a first available expediter may be a highest ranked expediter. In at least one embodiment, a responder may be ranked as an expediter. An expediter may be ranked based on a type, category, rating, profile, etc. Control is passed to operation 620 and process 600 continues.

In operation 625, information of a query is provided to an expediter guide. An expediter responder may be provided with information of a query. For example, an expediter responder may be provided with a query and a possible response to the query, an interpretation of the query, etc. In at least one embodiment, an expediter responder is presented with a question requiring a single judgment. A plurality of responders may receive different messages which may be combined to perform an expediter function. A number of responders may be selected based on a ranking of the responders. A number of highest ranking responders may be selected to be notified of a request. Responders may be notified of a request in a sequence based on ranking until a responder accepts the request. A number of responders utilized for a request may be based on an expected value or earning associated with a request and/or a cost associated with a responder. Control is passed to operation 630 and process 600 continues.

In operation 630, a determination is made as to whether an answer is found. If in operation 630 it is determined that an answer is found, control is passed to operation 675 and process 600 continues. If in operation 630 it is determined that an answer is not found, control is passed to operation 635 and process 600 continues.

The determination in operation 630 may be made based on various criteria. If an expediter selects a response based on a previous query, confirms a query can be answered programmatically, indicates that a query must be searched, fails to respond, responds in agreement with other expediters, etc. it may be determined that an answer is found. For example, if five expediter responders are presented with information of a request, and three of the responders concur regarding an answer it may be determined that an answer is found. Likewise, if a sequence of responses is received from a number of responders, it may be determined that an answer is found.

In operation 635, responders are ranked for a query. A responder may be ranked based on any suitable criteria such as response time, historical activity, percentage and/or number of responses, notifications accepted, responses accepted, categories and/or keywords associated with a responder, temporal information, a profile, etc. In at least one embodiment, a responder who has submitted a query within a predetermined time period prior to or after receipt of a request may be ranked higher than a responder who has not. Similarly, a responder who has responded to and/or accepted a high percentage of notifications or requests may be ranked higher. A quality rating of a responder may be used to rank a responder. Control is passed to operation 640 and process 600 continues.

In operation 640, guides are ranked for a query. A guide may be ranked based on any suitable criteria such as categories and/or keywords associated with the guide, temporal information, a profile, etc. A quality rating of a guide may be used to rank a guide. Control is passed to operation 645 and process 600 continues.

In operation 645, a determination is made as to whether a request is to be directed to a responder. If in operation 645 it is determined that a request is not to be directed to a responder, control is passed to operation 665 and process 600 continues. If in operation 645 it is determined that a request is to be directed to a responder, control is passed to operation 650 and process 600 continues.

The determination in operation 645 may be made based on various criteria. A number of available guides and/or responders, a rating of the guides and/or responders, a number of responders who have been notified, a time interval during which a request has been pending a response, etc. may affect a probability that a query will be sent to a responder. For example, if a query has been sent to ten responders, and has not been accepted within a preset time limit, it may be determined that a query is not to be sent to a responder. Similarly, if no guides are available of suitable rank or rating, it may be determined that a query is to be sent to a responder.

In operation 665, information of a request is provided to a guide. In at least one embodiment, a first guide to accept a request is provided with the information of the request. A guide may be provided with access to search resources which may assist the guide to perform a search. Guides may be notified of a request in an order based on a ranking of the guide. A guide may perform an information search to obtain a search result. Control is passed to operation 670 and process 600 continues.

In operation 650, a responder is notified. A responder may be notified in various ways. In at least one embodiment, a responder may be notified using a communication service which was last used by the responder to submit a request. A responder may be notified using a default communication service designated by the responder. Any communication service associated with a responder may be used to notify the responder. Control is passed to operation 650 and process 600 continues.

In operation 655, a determination is made as to whether a request is accepted. If in operation 655 it is determined that a request is accepted, control is passed to operation 660 and process 600 continues. If in operation 655 it is determined that a request is not accepted, control is passed to operation 635 and process 600 continues.

The determination in operation 655 may be made based on various criteria. For example, if a time limit expires it may be determined that a notification is not accepted. Similarly, if a responder sends an acknowledgement, it may be determined that a notification has been accepted.

In operation 660, a request is sent to a responder. For example, query information such as a query, possible responses, etc. may be provided to a responder. Any type of information which is suitable for a device associated with a responder may be provided. For example, an SMS or text message, an IM, and/or a web page may be used to provide information of a query to a responder. In at least one embodiment, a query history of a user of a request may be provided to a responder. Control is passed to operation 670 and process 600 continues

In operation 670, a determination is made as to whether a response is provided. If in operation 670 it is determined that a response is provided, control is passed to operation 675 and process 600 continues. If in operation 670 it is determined that a response is not provided, control is passed to operation 635 and process 600 continues.

The determination in operation 670 may be made based on various criteria. If a message is received from a guide and/or a responder, it may be determined that a response is provided. Likewise, if a message is not received within a time interval after a notification is accepted and/or query information is provided, it may be determined that a response is not provided. If a response is not provided, a responder and/or a guide who received a notification and/or was provided with query information may be determined to be inactive, and subsequently removed from a ranking of guides.

In operation 675, a response is audited. A response may be audited in various ways. In at least one embodiment, an audit may not be performed, and/or may be performed on the basis of statistical sampling. A response may be audited by comparing the response to other responses. For example, a response of a first responder may be compared to a response of a second responder, or a response of a responder may be compared to historical answers. A response may be audited using techniques such as spelling and grammar checking, word comparisons, etc. which may estimate quality of an answer. In at least one embodiment, an examiner may audit a response. In at least one embodiment, a list including keywords, words, named entities and phrases may be used to screen responses which are subsequently reviewed by an examiner. Control is passed to operation 680 and process 600 continues.

In operation 680, a determination is made as to whether an audit is good. If in operation 680 it is determined that an audit is good, control is passed to operation 685 and process 600 continues. If in operation 680 it is determined that an audit is not good, control is passed to operation 635 and process 600 continues.

The determination in operation 680 may be made based on various criteria. If a spelling and grammar check is acceptable, and predetermined words are present and/or absent, a number of responses are in agreement, a review by an examiner, who may be a guide and/or a responder, is acceptable, etc. it may be determined that an audit is good.

In operation 685, an answer is sent to a user. An answer may be delivered to a user via any communication service associated with the user. An answer may include any media which may be delivered using a communication service and a device of the user. For example, an SMS message might be deliver to a user mobile device. Any number of responses may be delivered to a user as any or all of an answer. Control is passed to operation 690 and process 600 continues

In operation 690, process information is recorded. Information regarding a user, a guide, a responder, a request, a resource, an advertisement, a user, etc. may be recorded and/or updated. For example, a rating may be adjusted, a keyword, category, type, guide, responder, time, user, answer, number of responders, number of responses, quality of responses, etc. of a request may be recorded. In at least one embodiment, process information is recorded in the database 120 (FIG. 1). Control is passed to operation 605 and process 600 continues.

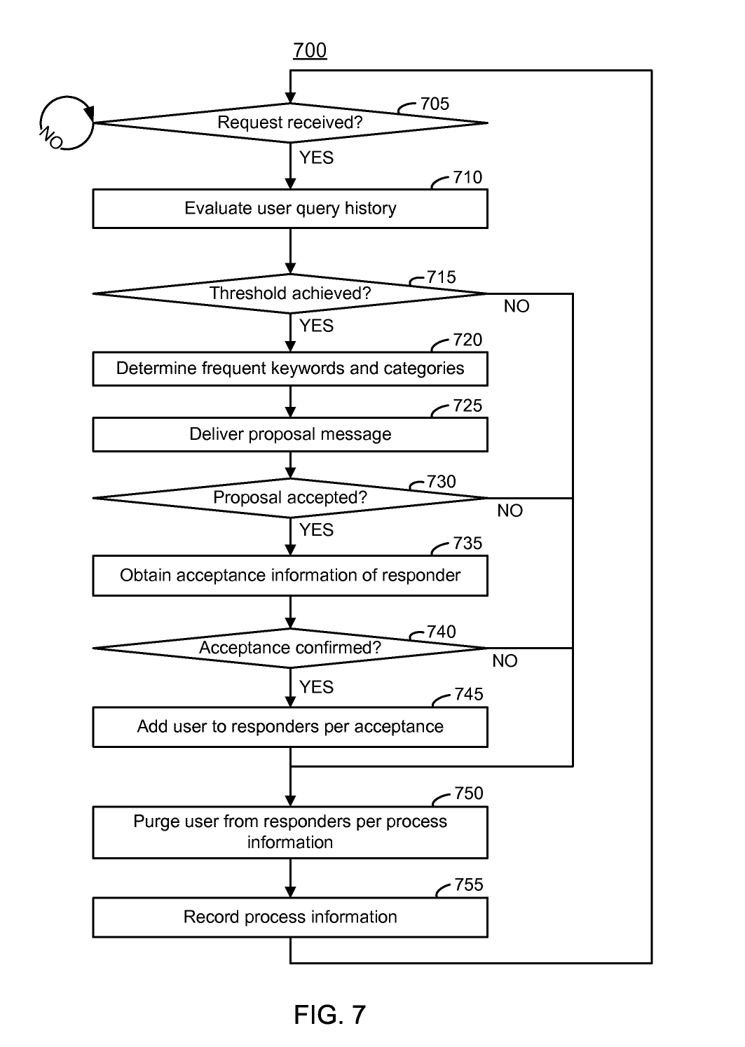

As illustrated in FIG. 7, a process 700 for contacting and registering a responder is provided. The process 700 may be used to create an maintain records associated with responders. For example, the process 700 may be executed when a user submits a query in order to determine whether a user may be invited to become a responder. Invitations may be sent to users at any time to determine whether a user is willing to become a responder. Invitations may be preferentially delivered when a user is actively making use of a service provided by the search system 130 (FIG. 1). The process 700 may be performed in whole or in part by any suitable element of the system 100 (FIG. 1). In at least one embodiment, the process 700 is operative on a server associated with the search system 130.

In operation 705 (FIG. 7) a determination is made as to whether a request is received. If it is determined in operation 705 that a request is not received, control remains at operation 705 and process 700 continues. If it is determined in operation 705 that a request is received, control is passed to operation 710 and process 700 continues.

The determination in operation 705 may be made using various criteria. A request may be a request received from a user. In at least one embodiment, if a message is received at a server associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. In at least one embodiment, if a message is received at a server associated with the search system 130, it may be determined that a request is received.

In operation 710 a query history of a user submitting a request is evaluated. Keywords, categories, alerts, queries, answers, queries received by the user, queries answered by the user, advertisements, temporal information, etc. of a user may be obtained and/or analyzed. For example, a number of queries, answers, and/or occurrences of a keyword, or system usage frequency, frequency of queries regarding a category, etc. may be analyzed. Control is passed to operation 715 and process 700 continues.

In operation 715, a determination is made as to whether a threshold is achieved. If in operation 715, it is determined that a threshold is achieved, control is passed to operation 720 and process 700 continues. If in operation 715 it is determined that a threshold is not achieved, control is passed to operation 750 and process 700 continues.

The determination in operation 715 may be made based on various criteria. If a number of queries submitted exceed a pre-determined value, it may be determined that a threshold is achieved. Criteria such as a number of queries associated with a topic, a number of queries in a given time interval, a number of alerts, a number of responses to items such as advertisements may be used individually or in combination to determine whether a threshold is achieved. Any suitable criteria may be used to determine whether a threshold is achieved.

In operation 720 frequent keywords and categories associated with a user are determined. For example, if a user has submitted queries including keywords associated with sports teams, the category ‘Sports’ may be determined as a frequent category. Likewise, if a user has submitted queries including a named entity, has a recurring query or alert associated with a topic, etc. a frequent keyword and/or category may be determined on that basis. If a user has previously declined a proposal, a topic, keyword, location and/or category associated with the declined proposal may be excluded or ranked lower in consideration of frequent categories and/or keywords. Control is passed to operation 725 and process 700 continues.

In operation 725 a proposal message is delivered. A proposal message may ask a user whether the user is willing to receive notifications and/or requests. For example, requests associated with other users, and/or assigned based on other activities. A proposal message may mention a specific category, keyword, and/or type of request. A proposal message may be delivered using a web page, an API, a text or MMS, SMS message, and/or any communication services associated with a user. Control is passed to operation 725 and process 700 continues.

In operation 730, a determination is made as to whether a proposal is accepted. If in operation 730, it is determined that a proposal is accepted, control is passed to operation 735 and process 700 continues. If in operation 730 it is determined that a proposal is not accepted, control is passed to operation 750 and process 700 continues.

The determination in operation 730 may be made based on various criteria. For example, if a user responds to a proposal message, activates a control in a user interface, sends a predetermined message, etc. it may be determined that a proposal is accepted. It may be determined that a proposal is not accepted if no response is received, if a user replies with a predetermined message, if a user interface control is activated, etc.

In operation 735 acceptance information of a responder is obtained. If an acceptance message is an opt-in for a specific keyword, location, or category, it may be that no further acceptance information is required. A user may be asked to confirm acceptance of receiving messages. A user may be required to confirm specific information regarding the user as required by law, regulations, and/or business rules. A user may be able to select desired and/or undesired keywords, and/or other filtering criteria to be applied to requests. A user may be able to designate communication services which may be used to deliver requests and/or notifications. Control is passed to operation 740 and process 700 continues.

In operation 740, a determination is made as to whether user acceptance is confirmed. If in operation 740, it is determined that user acceptance is confirmed, control is passed to operation 745 and process 700 continues. If in operation 740 it is determined that user acceptance is not confirmed, control is passed to operation 750 and process 700 continues.

The determination in operation 740 may be made based on various criteria. If a user does not provide information, provides conflicting and/or unacceptable information, and/or otherwise does not meet a requirement to be accepted as a responder, it may be determined that user acceptance is not confirmed. In at least one embodiment, it may always be determined that user acceptance is confirmed.

In operation 745 a user is added as a responder per acceptance. Information associated with a proposal message, collected as acceptance information, determined based on user actions, etc. may be recorded and associated with a responder. An initial rating and/or ranking of a responder may be determined. Control is passed to operation 750 and process 700 continues.

In operation 750 a responder is purged per process information. A ranking and/or rating, keyword, category, profile, etc. may be added and/or removed from records associated with a responder. For example, if a responder has declined a proposal message, or provided blocked keywords, eliminated recurring queries, received poor quality ratings, etc. a responder may be ranked lowly and/or removed from a ranking of an attribute used to select a responder. Control is passed to operation 755 and process 700 continues.

In operation 755, process information is recorded. In at least one embodiment, information of acceptance of a proposal, acceptance information, ratings and/or rankings of a responder, information of communication services, information of keywords, categories, responders, and users may be recorded. Any information associated with the process 700 may be recorded. In at least one embodiment, process information is recorded in the database 120 (FIG. 1). Control is passed to operation 705 and process 700 continues.

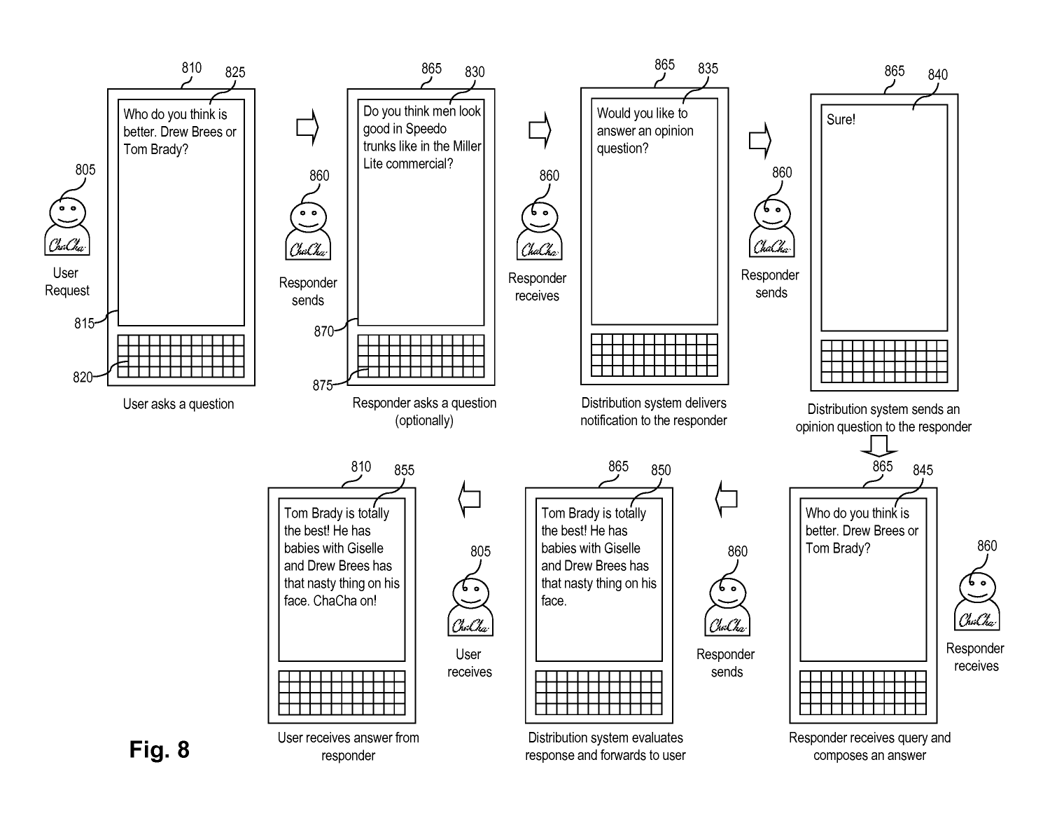

An exemplary sequence of messages between a user, a responder, and/or a search system is illustrated in FIG. 8. While a specific sequence of messages is depicted, the message exchanges might occur in any suitable sequence, and any reasonable combination of messages and responses which accomplishes the equivalent functionality might be used. A user 805 may compose a request using a user system 810. The user system 810 may include a display device 815, and an input device 820. The user 805 may compose and transmit a user query message 825 to the search system 130 (FIG. 1). A responder 860 may optionally compose a responder query message 830 using the responder system 865. The responder system 865 may include a responder display device 870, and a responder input device 875. While simplified responder and user systems are used for the purposes of illustration, no limitation is implied thereby. In a preferred embodiment, a responder who has recently submitted a query may be ranked higher than other responders.

If the responder 860 is selected to receive a notification of the user query message 825, the responder 860 may receive a user query notification 835. If the responder 860 is willing to accept a request, the responder 860 may compose and transmit an acceptance message 840. The acceptance message 840 may include a keyword, and/or other information indicating acceptance. Responsive to the acceptance message 840, the responder may receive a system query message 845. The query message 845 may include the query of the user 805. The query message 845 may include answers, search results, etc. which may request acceptance and/or opinion. The query message 845 may request a free-form answer. Responsive to the query message 845, the responder 860 may send a responder answer message 850. The responder answer message 850 may include any type of information. The responder answer message may be modified automatically and/or using human assistance to produce a user answer message 855. The user answer message 855 may include augmented and/or modified content of the responder answer message 850.

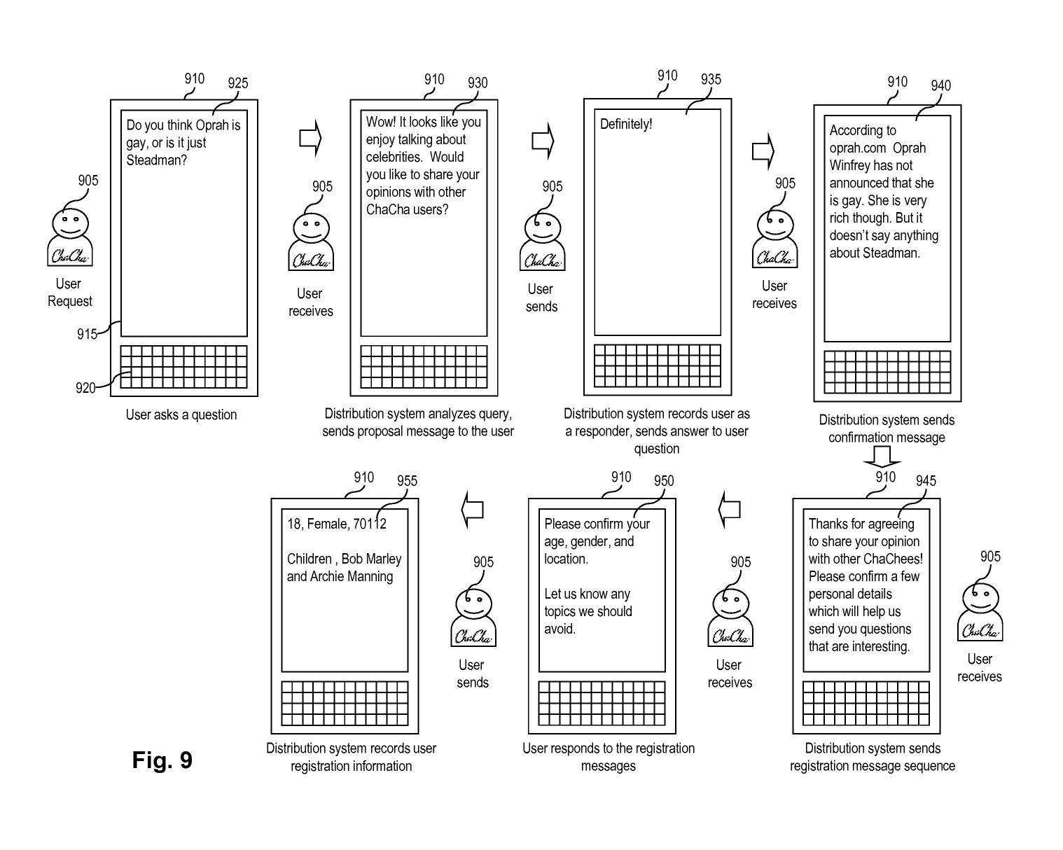

An exemplary sequence of messages for registering a user as a responder is illustrated in FIG. 9. The messages in FIG. 9 may be exchanged by a user and a system such as the search system 130 (FIG. 1). A user 905 may compose a request message 925 using a user system 910. The user system 910 may include a display device 915 and an input device 920. The user 905 may submit the request message 925. Responsive to the request message 925 the user 905 may receive a proposal message 930. The proposal message 930 may indicate a topic (i.e., ‘Celebrities’) or category of requests which might be delivered to the user 905. The user 905 may indicate acceptance by sending a proposal acceptance message 935. The proposal acceptance message 935 may include a keyword, and/or other acceptance indicator. At some time, the user 905 might receive an answer message 940 responsive to the request message 925. Responsive to the proposal acceptance message 935 the user 905 may receive a responder confirmation message 945, which may optionally include a registration information request message 950. The user 905 may respond to the registration information request message 950, the user may compose and transmit a responder registration message 955. Information in the responder registration message 955 may be stored and may be used to select requests directed to the user 905.

While the messages in FIG. 8 and FIG. 9 have been illustrated as a single messages, and single transaction exchanges, it will be immediately obvious to one of ordinary skill in the art that any number of messages may be used as needed to accomplish the intent of the communications illustrated. Although the exchange has been depicted using a simple user interface for the purposes of illustration, any suitable types of user interfaces and devices may be used to respond to user requests and to deliver requests to and register a responder.

Using the methods and systems described herein selective distribution of requests to users when processing requests for information is performed. User interests and categories of queries to which a user might respond are determined based on queries, answers, explicit selections and information requested and/or provided by a user. If a user meets suitable criteria, the user may be notified of the opportunity to receive queries associated with the areas of interest identified. If a user accepts to receive notifications of requests, the user may be recorded as a responder. Registration information may be solicited from a responder. If additional areas of interest are determined, a responder may be offered the opportunity to respond to requests associated with those opportunities.

When a query is received, the query may be processed automatically to determine a classification of the query. A query may be evaluated to determine whether the query can receive a programmatic response. If a programmatic response is not available, the query may be directed to a person who may respond based on interpretation of the query, or expediter. A responder may be selected as an expediter based on a ranking of the responder among expediters. If a searcher is required to respond to a request, a responder may be ranked versus other searchers to determine whether a request will be directed to the responder. After a response is received, an answer may be reviewed by a person who audits the response or examiner. A responder may be ranked versus other examiners to determine whether answers will be directed to the responder.

A ranking of a responder to receive a query may be modified based on various types of information. A responder who is currently logged in, or has recently been active may be more likely to receive a notification of a request. A responder who has recently accepted a notification and/or responded to a query may be more likely to be selected to receive a notification of a request. If a responder has recently responded to an advertisement, or other information, a ranking of the responder may be increased.

While the system and method herein have been described in the application of a search service, other types of systems might benefit similarly. For example, polling systems, advertising systems, information retrieval systems and/or any system wherein peer-to-peer expertise may be shared may benefit from the systems and methods described herein.

In a system which responds to user requests for information, introduction of a human assistant may improve an ability to respond to a generic user request. A person may be able to easily recognize the intent of a user request based on context or other cues which an automated system may be unable to resolve. For this reason, systems including human searchers or ‘guides’ have found good acceptance in the marketplace. For example, the ChaCha® search service has answered over two billion user queries. Such a system is successful if it can be advertising supported, which requires that a query can be answered at a cost which an advertiser is willing to pay.

Systems such as Aardvark have attempted to replicate the ChaCha® question and answer model by using a social network to distribute questions. However, such systems to date have met with limited success for various reasons. In particular, as the responders are not compensated, a low completion rate (below 85%) occurs within a twenty-four hour period. If a user is expecting a reply in less than three minutes, the expectation will likely not be satisfied.

Various types of web properties have been developed in order that a user may post a question and receive a response. For example, forums for topics from sports to cancer to audio video equipment are active. However, such forums do not typically respond to a user query in a short time. Several hours or more may pass before any response is posted, if ever. Likewise blogs which may relate to a topic or topics may provide a response to a user request, but the time to respond may be long, and is generally constrained to a limited number of responders who are available at any given time. Likewise, a user may micro publish a question on a social media site such as the Twitter® or Facebook® services. However, such a query is not anonymous, and may be inappropriate for some users.

Games and/or other forms of virtual worlds on sites such the Facebook, or quiz websites naturally expose a large number of users to various tests of skill. For example, Facebook games such as the Farmville® or Mafia Wars™ games may have millions of active users. However, such systems are not readily adapted to respond to a random request for information. An off-topic or irrelevant question would not make for a suitable and popular experience for a user.

In light of these and other issues, a method and system whereby requests for information may be selectively distributed to a network of responders would be greatly appreciated.

A system is provided which enables a user to submit a request for information or query to a search service. A search service may analyze a request to determine an appropriate response to the request and provide a response to a user request. Based on analysis of a request and/or system conditions the request may be directed to any number of suitable potential responders. A search service system may include a user system which may be used to submit a request, a guide system which may be used to process the request and/or produce a response, a database including records for storing information associated with processing a request, a search server which matches requests to stored information, determines a destination for a request, and receives a response produced for the request, and a distribution system which dispatches queries to one or more users of a service associated with the distribution system.

The system may achieve an improved use of human searchers when responding to a user request. A database of potential responders is maintained. When it is determined that a query may be answered by a low cost responder the query may be directed to a server associated with a network including the responder. A query may be analyzed in various ways using automated and/or human-assisted processes. A time interval may be associated with a query, which may be used to determine when a query is routed to a responder. A responder may be ranked and/or rated based on factors such as answer quality, timeliness and frequency. A ranking and/or rating may be associated with a type, category, keyword, profile, and/or other parameters associated with a request.

A system is provided for responding to requests from users. A user device may originate a request or query, which is provided to a search system which may include a server and a database. A search system may process a user request to determine whether an automated response may be provided. If an automated response is available, the response which may include an advertisement may be provided to a user device. If an automated response may not be provided, a search system may parse content and/or other information associated with a request in order to determine how a request is best processed. A category and/or type may be associated with a request. A value associated with the request may be determined. A cost associated with various response options may be calculated. An availability of various response options may be determined. A request is directed to a responder based on a ranking of the responder for the request. Ranking of a responder may include consideration of at least one of value, cost, type and availability of the request and/or the responder. In at least one embodiment, a human assistant or guide may process a query to determine a responder. In at least one embodiment, if a response is not received within a pre-determined time interval, a query may be routed to an alternate responder. A request may be submitted and/or received using any suitable communication services accessible to the search system, a responder, and/or a user.

A guide may be registered to respond to requests. A responder may be registered. A registered responder may be associated with a category, keyword, profile, etc. A database including information of guides, resources, responders, users, queries, keywords, categories, and/or other items may be used to determine a suitable response to a query. A guide may perform various tasks and may be trained to perform the tasks. A guide may be compensated based on the type of task which is performed. Compensation of a guide may be determined based on factors such as answer quality, transactions, a rank of a guide, etc.

A value associated with a request may be determined based on various factors. A characteristic of a user such as targeting information associated with the user may be used to determine a value of a user request. For example, if a user is associated with targeting information of advertisements and/or other items of high value, a request of the user may be determined to have a high value. A user history may be used to determine a value associated with a user request. For example, frequency of use, response, conversion, etc., or duration in terms of requests, time, responses, etc., may be used to determine a value of a user request.

A cost associated with a request may be determined based on various factors. A cost associated with an available guide may be used to determine a cost associated with a request. A value associated with other requests may be used to determine a cost associated with a request. A time interval associated with responding to a request may be used to determine a cost associated with a request. A number of requests pending may be used to determine a cost associated with request. A probability that a type of responder will be able to respond to a request may be used to determine a cost associated with a request. Any combination of factors associated with a request may be used to determine a cost associated with a request.

A responder may be any resource which may provide a response or search result responsive to receipt of a request. For example, a human searcher, a user, an automated search system, and/or a distributor system may be a responder. A distributor system may respond to a request using human and/or automated processing of a request. A distributor system may provide requests to blogs, news services or forums, may present requests in a gaming environment such as a quiz, a game simulation, and/or a social network service such as a news feed, or may display requests as tasks in any sort of interactive environment. A distributor system may include stored information which may be used to provide a response to a request. For example, a distribution system may spider and/or otherwise process media accessible to the distribution system in order to create and/or update an index of content which may match a request. Aggregation of content of blogs and/or forums may be advantageous due to the fragmented nature of forums wherein a ratio of threads and views per post seldom exceeds twenty. Most forum threads are updated less than once per day. However, there are dozens or hundreds of active forums on various topics.

A distributor system may register with a search service. A registration process may include providing access information, contact information, and may include a functionality verification process whereby a request and response functionality is confirmed. A number of characteristics may be associated with a distributor system such as keywords, categories, profiles, cost, etc. A distributor system may provide access to any number of forums, blogs, and/or other systems whereby a query may be posted.

A request for information may be submitted using various communication services. Any communication service such as email, IM, TCP/IP, SMS, MMS, EMS, voice, wired and/or wireless communication may be used to submit a request. Similarly, requests may be distributed using any communication services compatible with a recipient. In at least one embodiment, requests may be distributed to individuals as IM, SMS, MMS, or email messages via a wireless device.

As used herein, a “request” means a request for information, products, and/or services. A request, or search request, task or query may, include various types of media and may be provided by any user system which may establish communication with a server and/or other devices associated with a search service.

A “user” is a person who submits a request and may receive any type of information responsive to a request. A user may be any person and/or entity which may request information, provide information, and may provide compensation to an operator of an information exchange or search system.

An “advertiser” is any person and/or entity which may provide promotional information or “advertisements” to be delivered to a user. An advertisement may take various forms and/or may include media of any sort which can be delivered to a user device. A “result”, “response” or “search result” is any information which has been determined to be a response to a request. A result may include an advertisement.

A “resource” is any system, person, entity, and/or other source of information. A resource may be used to provide a response, and may be accessible to a user, and/or guide on a selective basis and/or an unrestricted basis. In at least one embodiment, a resource may be exclusive to a distributor system.

A “guide”, or human searcher, or searcher, is a person and/or entity which may perform a search for information. A guide may perform and/or respond to various requests in various roles. A guide who processes a query which may be transferred to another guide may be referred to as an “expediter” or “ambassador” guide. A guide who receives a query and provides or locates a search for the query may be referred to as a “specialist” or “generalist” or “searcher”. A specialist may perform a search using resources associated with an area of specialization which has been associated with the guide. A generalist may perform a search responsive to a query which is not specific to a particular area of expertise. A guide who vets, approves, reviews and/or revises an answer prior to delivery of the answer or response may be referred to as an “examiner”, “judge”, “vetter” or “reviewer”. An item may be any real and/or virtual object which may be tracked using a record.

The terms voice and speech are used interchangeably herein. A user, a guide, a distributor system, and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, regular mail, and/or any other type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, or any other communication device might be used to establish a communication session.

Communication between a user, a guide, a resource, a distributor and/or a search system may include conversion of text to speech and speech to text. Any type of conversion and/or other processing of information which may facilitate communication between a user, a guide, a resource, an owner and/or a search system may be performed by any elements connected by a suitable communications network. For example, transcription, translation, interpretation, etc., may be used to process a request. Any type of media which can be sent and/or received using a communication system may be part of a communication session. A communication session may be conducted using any or all communication services associated with a user, a guide, a resource, a distributor and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a distributor, a member of a network of a distributor, a resource, and/or a result may be rated. Rating information may be obtained from a user, a guide, a distributor and/or an administrator. Rating information may be used to select a user, a guide, a resource, a distributor, a request, a response, a communication service, and/or any item based on information associated with an item indicated in a database. A search service may be compensated by advertising revenue. Advertising and/or content may be delivered to a user, distributor, and/or a guide using any communication service associated with a user, distributor, and/or a guide.

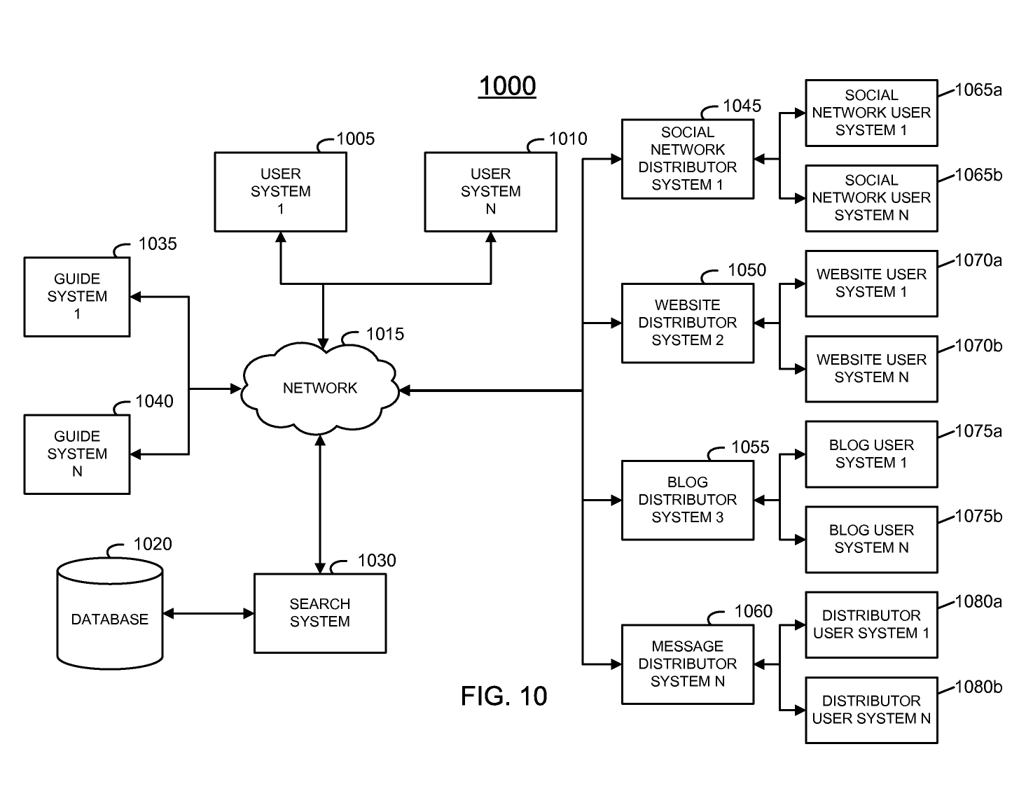

As illustrated in FIG. 10, a system 1000 includes user systems 1005, 1010, a network 1015 such as the Internet, a search system 1030, a database 1020, which may comprise various records, guide systems 1035, 1040, distributor systems 1045, 1050, 1055, 1060 and distributor user systems 1065a, 1065b, 1070a, 1070b, 1075a, 1075b, 1080a, 1080b.

While only a few systems associated with a user, a guide, a distributor, a distributor user system and a search system are depicted in FIG. 10, it is within the scope of the disclosure for multiple systems for a user, a guide, a distributor, a distributor user and a search system to be utilized. In particular it is envisioned that many user, guide, distributor, distributor user and search system systems may be implemented. A search system may be a composed of many components as described further herein.

Any user system (e.g. the user system 1005) can be used to submit a request to the search system 1030 and/or receive a result and/or other information. Any user system may receive a response, and/or may provide compensation to the search system 1030.

The network 1015 may be a global public network of networks (the Internet) and/or may consist in whole or in part of one or more private networks and communicatively couples the user systems 1005, 1010, the guide systems 1035, 1040, the distributor systems 1045, 1050, 1055, 1060, and the and distributor user systems 1065, 1070, 1075, 1080, with the other components of the system 1000 such as the search system 1030, and the database 1020. The network 1015 may include one or more wireless networks which may enable wireless communication between the various elements of the system 1000. For example, the search system 1030 may receive messages which may be routed via a wireless network controlled by a wireless service provider to the user systems 1005, 1010. A wireless service provider may receive messages from the guide systems 1035, 1040, via a wireless network which is a part of the network 1015, and provide the messages to the search system 1030 via an internet connection which is part of the network 1015. Similarly a voice or IP communication via wired and/or wireless communication might be established between any elements of the system 1000.

The search system 1030 allows interaction to occur among the user systems 1005, 1010, the guide systems 1035, 1040, the distributor systems 1045, 1050, 1055, 1060, and the distributor user systems 1065, 1070, 1075, 1080. For example, a request can be transmitted from the user system 1005 to the search system 1030, which may provide information obtained from the database 1020, which may include an advertisement provided by a distributor who is a user (e.g. an operator of the distributor system 1050) to the user system 1005. Similarly, a response from a guide operating the guide system 1035 might be routed to the search system 1030, which might process the response and provide a message to the user system 1005. Any type of communication between users, guides, distributors, distributor users, and/or resources may be mediated and/or facilitated by the search system 1030 and/or other elements of the system 1000.

The search system 1030 is communicatively coupled with the database 1020. As will be described herein in further detail below, the database 1020 includes non-transient data that is processed in association with operation of the embodiments. Although FIG. 10 illustrates the database 1020 as a separate component of the system, the database 1020 may be integrated with the search system 1030. Further, the records maintained in the database 1020 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 1020 may reside in any suitable elements of the system 1000. Any or all elements of the system 1000 may include a portion of or the entire database 1020.

The user systems 1005, 1010, the guide systems 1035, 1040, the distributor systems 1045, 1050, 1055, 1060, and the distributor user systems 1065, 1070, 1075, 1080, and the search system 1030 may include equipment, software, systems and/or personnel required to send and/or receive messages between a user system 1005, 1010, the guide systems 1035, 1040, the distributor systems 1045, 1050, 1055, 1060, and the distributor user systems 1065, 1070, 1075, 1080, and/or the search system 1030 using the network 1015. The database 1020 includes information which may allow the search system 1030 to establish communication between any or all of the elements of the system 1000.

A user system, a guide system, a distributor system, a distributor user system, a resource and/or a search system may be a desktop, tablet, or portable PC or Mac®, a mobile phone, a smart phone, a PDA, a server system, a landline phone, a specialized communication terminal, a terminal connected to a mainframe, or any other communication hardware and system. The search system 1030 may include one or more servers, computers, etc. For example, servers such as the PowerEdge® 2900 by Dell, or the BladeCenterJS22 by IBM, or equivalent systems might be used to implement elements of the search system 1030. The search system 1030 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems and/or communication apparatus known in the art may be used as user systems, worker systems, and/or to implement the search system 1030.

A distributor may be required to register with the search system 1030. As part of a registration process, at least one communication method is associated with a distributor. In at least one embodiment, a distributor may register with the search system 1030 and establish a username and password which are associated with the distributor. A distributor may login to the search system 1030 using a web browser functionality of the distributor system 1050 in order to communicate with the search system 1030. Multiple communication services may be associated with a distributor and may allow a communication session to be established between a distributor system such as the distributor system 1050 and a user system, a guide system, a distributor user system such as the website user systems 1070a, 1070b and/or the search system 1030. Multiple identifiers of a distributor may be associated with each other. Information such as IM credentials, an email address, a phone number, a URL, a username, etc., of a distributor may be identified, which may allow the search system 1030 to establish a communication session between a distributor system and a user system, a guide system, a resource system, and/or the search system 1030. An API and/or other information required for exchange of a request and/or a result between a distributor system and the search system 1030 may be provided. When a distributor registers with the search system 1030, the distributor may be associated with one or more keywords, categories, resources, and/or other information. For example a keyword or category may be selected by a distributor, or may be associated with a distributor based on spidering and/or other forms of indexing of resources indicated by the distributor and/or other information provided during and/or after a registration process. Information associated with a distributor may be stored in the database 1020 and may be used for purposes such as matching a distributor to a user request, determining and/or obtaining compensation of a distributor, communicating with a distributor, etc., as will be described further herein below. A distributor may provide identifying information of individual users such as a user of the website user system 1070a, the blog user system 1075a, the distributor user system 1080b, or the social network user system 1065b. For example, if a person is already registered with the distributor system, an anonymous identifier of the person may be provided to the search system 1030. A resource may be associated with a distributor. A resource may be associated with the distributor system 1045 and may be accessible only using the distributor system 1045. A resource which is exclusive to a distributor may allow a distributor to provide access to the resource for distributor system users and/or the search system 1030 on a selective basis. An affiliation may be any affinity or bond or characteristic which may be shared by a group. An affiliation may be, for example, political, geographic, topical, etc. A distributor may designate a guide to be associated with the distributor. For example, should a request associated with a distributor require human assistance, the search system 1030 might cause the request to be preferentially directed to a designated guide.

A guide may be required to register with the search system 1030. As part of a registration process, at least one communication method is associated with a guide. In at least one embodiment, a guide may register with the search system 1030 and establish a username and password which are associated with the guide. A guide may login to the search system 1030 using a web browser functionality of the guide system 1040 in order to communicate with the search system 1030. Multiple communication services may be associated with a guide and may allow a communication session to be established between a guide system such as the guide system 1035 and a user system, a distributor system, a resource system and/or the search system 1030. Multiple identifiers of a guide may be associated with each other. Information such as IM credentials, an email address, a phone number, a URL, a username, etc., of a guide may be identified which may allow the search system 1030 to establish a communication session between a guide system and a user system, a distributor system, a distributor user system, a resource system and/or the search system 1030.

When a guide registers with the search system 1030, the guide may be associated with one or more keywords, categories, resources, and/or other information. For example, a keyword and/or category may be selected by a guide or may be associated with a guide based on skills, preferences, or other forms of evaluations provided to a guide and/or other information provided during and/or after a registration process. Information associated with a guide may be stored in the database 1020 and may be used for purposes such as matching a guide to any item such as a request, search result, etc., determining and/or obtaining compensation of a guide, communicating with a guide, etc., as will be described further herein below.

A resource system may be identified by the search system 1030. In at least one embodiment, the search system 1030 may identify a resource system based on use of the resource system by a guide system. For example, if a guide locates a search result or response using information provided by a resource, the guide may include an identifier such as a Uniform Resource Locator (URL) of the resource used in the search result. In at least one embodiment, a resource system may be identified with a type of information such as advertisements, data regarding a topic, etc. A resource system which may require a particular type of access may be registered with the search system 1030 and may be monitored regarding usage, etc. A resource may be associated with a category and/or keyword. For example, if a resource could provide current weather information, the resource might be associated with the category weather and the keywords ‘partly-cloudy’, ‘thunderstorms’, ‘flood’, etc. In at least one embodiment, a distributor may designate a resource and may associate the resource with the distributor. For example, a distributor may designate a resource which is to be searched, provided, excluded, or otherwise utilized for automated and/or human assisted searches.

A user may be identified by the search system 1030. When a user system, such as the user system 1005, establishes a communication session with the search system 1030, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 1005 and a distributor system, a distributor system user system, a guide system, a resource system and/or the search system 1030. Information of items such as a keyword, a category, a profile, a previous request, a result, etc., may be associated with a user. Information of a user may be stored in the database 1020.

Records may be maintained in the database 1020 which may be used to record the status of various items. Such records may be used to aid the processing of work inputs and production of work outputs. For example, a user may submit a request, which may describe a desired output, and provide access to information and/or materials needed to produce the output. Information indicated in a record may be combined with information in other records, and may be used to produce tables, as further described herein.

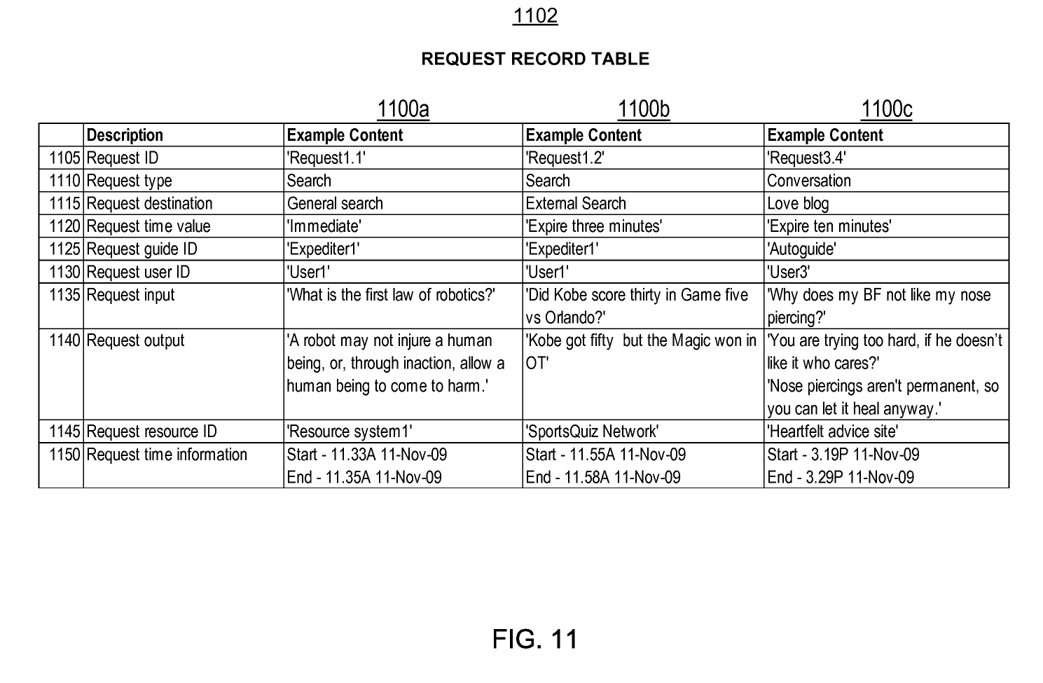

As illustrated in FIG. 11, an exemplary request record table 1102 is provided which may comprise a number of request records 1100 of which one or more may be associated with or resident in the database 1020 (FIG. 10). A request record 1100 may include information of requests which may be distributed. The request records 1100 may include a request ID field 1105, a request type field 1110, a request destination field 1115, a request time value field 1120, a request guide ID field 1125, a request user ID field 1130, a request input field 1135, a request output field 1140, a request resource ID field 1145, and a request time information field 1150.

The request ID field 1105 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a user ID associated with a request is included in the request ID field 1105. In at least one embodiment, a random number is indicated in the request ID field 1105. Using the example in FIG. 11, ‘Request1.1’ is the request ID associated with the request record 1100a.

The request type field 1110 may include information of a type associated with a request. Information indicated in the request type field 1110 may be used to assist in processing of a request. For example, a type associated with a request may be used to rank guides who may be associated with the type of request. Likewise, a type associated with a request may be used to select a distributor to receive a request. A type associated with a request may determine a resource employed in processing the request. A type associated with a request may be used to determine a cost associated with a request. Any request type which may be processed by the search system 1030 (FIG. 10) may be indicated in the request type field 1110. Using the example in FIG. 11, ‘Request3.4’ may be of the request type ‘Conversation’ as indicated in the request record 1100c. This may indicate that a request is determined to be a request which may not require a factual response. A conversational query may have a lower cost if a distributor associated with the request is available. Request types may be associated with various properties. For example, a category, a keyword, and/or other information associated with a request may be used to select a person to receive the request. A request type may designate a type of processing associated with a request such as transcription, translation, timed search, untimed search, etc. A type associated with a request may affect a value associated with a request. For example, an advertisement may be associated with a request based on a type associated with the request.

The request destination field 1115 may include information of a resource to which a request has been directed. Information indicated in the request destination field 1115 may be used to determine a delivery destination for a request, resources to be used to respond to the request, etc. Using the example in FIG. 11, ‘Request1.2’ is selected to be provided to ‘External Search’ as indicated in the request record 1100b. This may indicate that the distributor resource ‘SportsQuiz Network’ as indicated in the request resource ID field 1145 may be provided with the request indicated in ‘Request1.2’.

The request time value field 1120 may include information of a time value associated with a request. Information indicated in the request time value field 1120 may be assigned by a user originating a request, and/or may be determined automatically. Content of the request time value field 1120 may be used to determine when a request expires. For example, if a user submits a request, if the request is directed to a distributor, if a response is not received within a time period indicated in the request time value field 1120, an alternate action may be taken to obtain a result such as submitting the request to a guide, an alternate distributor, an automated resource, etc. Using the example in FIG. 11, ‘Request1.1’ is ‘Immediate’ which may indicate that the request is to receive an immediate response, while ‘Request1.2’ is set to ‘Expire three minutes’ and ‘Request3.4’ is set to ‘Expire ten minutes’. Any type of time information may be indicated in the request time value field 1120.

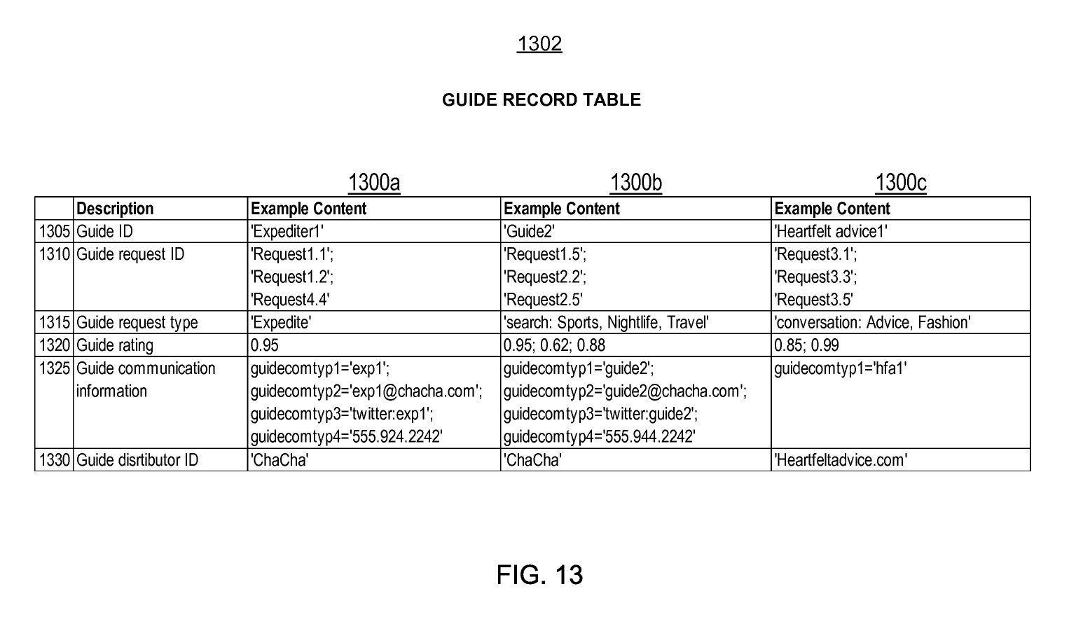

The request guide ID field 1125 may include information of a number of guides associated with a request. Content of the request guide ID field 1125 may be used to obtain information of a guide using a record such as the guide record 1300a (FIG. 13). If a guide is selected to respond to a request, elects to respond to a request, and/or completes a request, an identifier of the guide may be indicated in the request guide ID field 1125. Using the example in FIG. 11, ‘Autoguide’ is associated with ‘Request3.4’ as indicated in the request record 1100c. This may indicate that ‘Request3.4’ has been automatically associated with and directed to the destination ‘Love blog’ as indicated in the request destination field 1115.

The request user ID field 1130 may include information of a number of users associated with a request. Content of the request user ID field 1130 may be used to obtain information of a user associated with a request. For example if a user submits a request, an identifier of the user may be indicated in the request user ID field 1130. Using the example in FIG. 11 ‘User1’ has originated ‘Request1.1’ and ‘Request1.2’ as indicated in the request records 1100a and 1100b. Information of a user associated with a request may be used to determine a value associated with the request. For example, if a user query history is brief, if a user is a new user of a service, if a user has historically provided high or low value associated with requests, a value associated with a request may be affected. Similarly, if a request and/or content of the request input field 1135 has been associated with a plurality of users, a value associated with a request may be affected.

The request input field 1135 may include information of a request. Content of the request input field 1135 may be provided to a person who accepts a request. Content of the request input field 1135 may include any type of information. For example, a pointer to audio, video, text, and/or other media may be indicated in the request input field 1135. As illustrated in FIG. 11, the query ‘What is the first law of robotics?’ is the request input associated with ‘Request1.1’. In at least one embodiment, the request input field 1135 may indicate an original user request, a categorization, and a rewritten user request.

The request output field 1140 may include information of a response associated with a request. Content of the request output field 1140 may be provided to a user responsive to a request. Content of the request output field 1140 may be stored in the database 1020 (FIG. 10). Content of the request output field 1140 may be reviewed by a user, a guide, and/or an administrator. As illustrated in FIG. 11, the response ‘A robot may not injure a human being, or, through inaction, allow a human being to come to harm’ is associated with ‘Request1.1’. While a text response to a query is used for the purposes of illustration, any type of media may be indicated in the request output field 1140. In at least one embodiment, a text response and a URL associated with a source of the text response may be indicated in the request output field 1140. In at least one embodiment, an indicator of a response and a responder may be included in the request output field. As illustrated in FIG. 11, the request record 1100c includes two responses to ‘Request3.4’. This may indicate that multiple users are associated with ‘Love blog’ and may have provided a response to ‘Request3.4’.

The request resource ID field 1145 may include information of a resource associated with a request. Content of the request resource ID field 1145 may indicate a resource which may provide a response to a request. For example, if a guide utilizes a resource to respond to a request, an indicator of the resource may be included in the request resource ID field 1145. A resource to which a request is directed may be indicated in the request resource ID field 1145. For example, a web site selected by a distributor and/or a distributor system user may be indicated in the request resource ID field 1145. Using the example in FIG. 11, ‘Request1.2’ may receive responses from the resource ‘SportsQuiz Network’.

The request time information field 1150 may include information of time associated with a request. Content of the request time information field 1150 may be used for various purposes. For example, a time at which a query was posted and completed may affect compensation of a guide, a rating of a resource and/or distributor, a query, etc. A distributor may review queries based on a ranking or sorting associated with a time stamp, or duration, etc. Using the example in FIG. 11, the query ‘Did Kobe score thirty in game five vs. Orlando?’ was asked at ‘11.55 A 11 Nov. 2009’ and the answer was sent ‘11.58 A 11 Nov. 2009’.

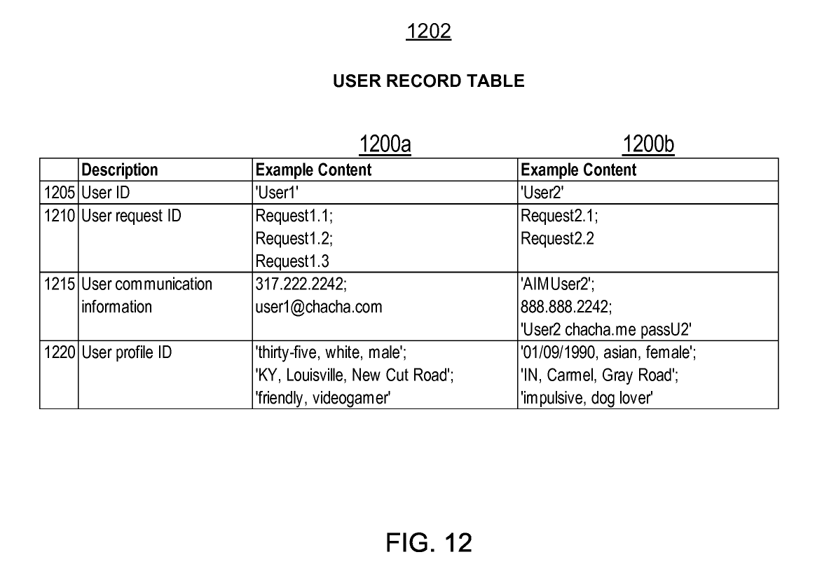

As illustrated in FIG. 12 an exemplary user record table 1202 is provided which may comprise a number of user records 1200 of which one or more may be associated with or resident in the database 1020 (FIG. 10). The user records 1200 may include a user ID field 1205, a user request ID field 1210, a user communication information field 1215, and a user profile ID field 1220.

The user ID field 1205 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 1205. Using the example in FIG. 12, ‘User1’ is the user ID associated with the user record 1200a.

The user request ID field 1210 may include information of a number of requests associated with a user. A user request ID may be, for example, a pointer to a request record associated with a request submitted by a user. If a user submits a request to the search system 1030, a request ID may be added to the user request ID field 1210. Using the example illustrated in FIG. 12, ‘Request2.1’ and ‘Request2.2’ are associated with ‘User2’ as indicated in the user record 1200b. This may indicate that ‘User2’ has submitted ‘Request2.1’ and ‘Request2.2’.

The user communication information field 1215 may include information of a number of communication services associated with a user. Any information which may be used to establish communication with a user may be indicated in the user communication information field 1215. For example, a telephone number, an email address, an IM credential, a URL, a username, a password, and/or other communication information may be indicated in the user communication information field 1215. Using the example in FIG. 12, the phone number ‘317.222.2242’ and the email ‘user1@chacha.com’ are associated with ‘User1’.

The user profile ID field 1220 may include information of a profile associated with a user. For example, demographic, geographic, affiliation, personality, and/or other types of information may be associated with a user. A user may provide profile information as part of a registration process. User profile information may be obtained from a database provided by a third party. User profile information may be determined based on test, polling, query history, peer review, and/or other information associated with a user. A profile associated with a user may be used to select information to be provided to the user. As illustrated in FIG. 12, the demographic information ‘Jan. 9, 1990, asian, female’ is associated with ‘User2’.

As illustrated in FIG. 13, an exemplary guide record table 1302 is provided which may comprise a number of guide records 1300 of which one or more may be associated with or resident in the database 1020 (FIG. 10). A guide record 1300 may include a guide ID field 1305, a guide request ID field 1310, a guide request type field 1315, a guide rating field 1320, a guide communication information field 1325, and a guide distributor ID field 1330.

The guide ID field 1305 includes an identifier of a guide which is preferably unique and is preferably used consistently. A guide ID serves to distinguish a guide record associated with a guide from a guide record associated with other guides. Any number of characters, numbers, and/or other indicators may be used to indicate a guide ID. In at least one embodiment, a random number is indicated in the guide ID field 1305. In at least one embodiment, a pseudonym selected by a guide may be indicated in the guide ID field 1305. Using the example in FIG. 13, ‘Expediter1’ is the guide ID associated with the guide record 1300a.

The guide request ID field 1310 may include information of a number of requests associated with a guide. Content of the guide request ID field 1310 may be used to obtain information of a request. For example, if a guide is selected to respond to a request, an identifier of the request may be indicated in the guide request ID field 1310. Using the example in FIG. 13, ‘Request1.5’, ‘Request2.2’, and ‘Request2.5’ are associated with ‘Guide2’ as indicated in the guide record 1300b. This may indicate that ‘Guide2’ has performed ‘Request1.5’, ‘Request2.2’, and ‘Request2.5’.

The guide request type field 1315 may include information of a number of request types which may be performed by a guide. For example, a category and/or keyword associated with a request, a type of request, temporal information associated with a request, etc., which may be used to determine if a guide is to be presented with a request, may be indicated in the guide request type field 1315. In at least one embodiment, a guide may be assigned to a particular type of request as part of a registration process. A guide may select a type of request which the guide may perform. A guide may be required to pass a test in order to be associated with a type of request. Using the example in FIG. 13, ‘Guide2’ is associated with ‘search: Sports, Nightlife, Travel’, which may, for example, indicate that ‘Guide2’ may be presented with and/or select requests associated with a search for information associated with ‘Sports’, ‘Nightlife’, and ‘Travel’.

The guide rating field 1320 may include information of a number of ratings associated with a guide. For example, quality, timeliness, frequency, peer review, etc., may be used to determine a rating of a guide. A rating of a guide may be used for purposes such as determining compensation for the guide (e.g. bonus points), selecting a guide to respond to a request, matching a request to a guide, etc. A rating may be associated with a type, category, keyword, profile, and/or other parameters associated with a request. In at least one embodiment, the guide request type field 1315 and the guide rating field 1320 may be linked by, for example, a pointer. Using the example in FIG. 13, ‘Expediter1’ has a guide rating of ‘0.95’ associated with the guide request type ‘Expedite’, which may be used to rank ‘Expediter1’ versus other guides associated with the guide request type ‘Expedite’.

The guide communication information field 1325 may include information of a number of communication services associated with a guide. For example, a user name and password, an email address, an IM credential, a phone number, a web page, a physical address, etc., may be indicated in the guide communication information field 1325. Using the example illustrated in FIG. 13, ‘Guide2’ is associated with the login ID ‘guide2’, the email ‘guide2@chacha.com’, the twitter ID ‘twitter.guide2’, and the phone number ‘555.944.2242’. This may indicate that ‘Guide2’ may be contacted using the communication services associated with the respective identifiers.

The guide distributor ID field 1330 may include information of a distributor associated with a guide. For example, a distributor may select and/or qualify a guide to perform an activity associated with an affiliated request of the distributor. As illustrated in FIG. 13, the guide record 1300c ‘Heartfelt advice1’ is associated with the distributor ‘Heartfeltadvice.com’, which may indicate that ‘Heartfelt advice1’ may respond to requests directed to distributor content provided by ‘Heartfeltadvice.com’.

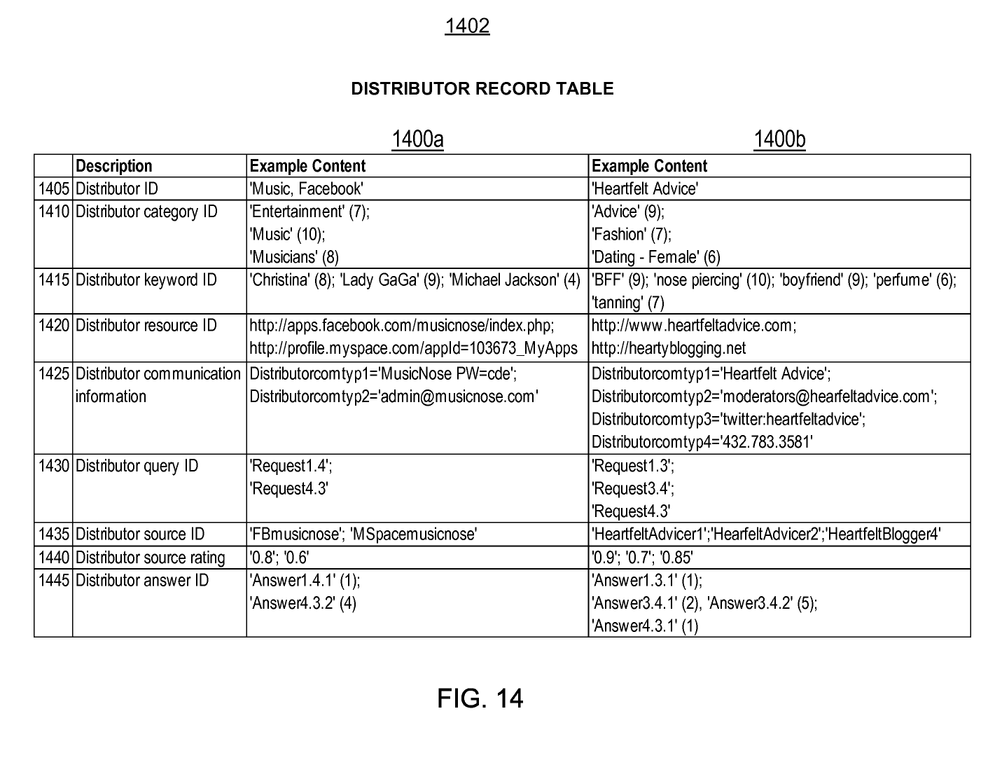

As illustrated in FIG. 14, an exemplary distributor record table 1402 is provided which may comprise a number of distributor records 1400 of which one or more may be associated with or resident in the database 1020 (FIG. 10). A distributor record 1400 (FIG. 14) may include information of distributors. The distributor records 1400 may include a distributor ID field 1405, a distributor category ID field 1410, a distributor keyword ID field 1415, a distributor resource ID field 1420, a distributor communication information field 1425, a distributor query ID field 1430, a distributor source ID field 1435, a distributor source rating field 1440 and a distributor answer ID field 1445.

The distributor ID field 1405 includes an identifier of a distributor which is preferably unique and is preferably used consistently. A distributor ID serves to distinguish a distributor record associated with a distributor from a distributor record associated with other distributors. Any number of characters, numbers, and/or other indicators may be used to indicate a distributor ID. In at least one embodiment, a random number is indicated in the distributor ID field 1405. In at least one embodiment, a pseudonym selected by a distributor may be indicated in the distributor ID field 1405. Using the example in FIG. 14, ‘Heartfelt Advice’ is the distributor ID associated with the distributor record 1400b.

The distributor category ID field 1410 may include information of a category associated with a distributor. Content of the distributor category ID field 1410 may be determined based on actions of a distributor. A distributor may select a category associated with the distributor, may indicate content which is used to associate a category with the distributor, and/or may participate in activities which may cause a category to be associated with the distributor. A category associated with a distributor may be used to select items which may be provided to the distributor. For example, if a distributor determines that a guide may respond to queries associated with the distributor, information of guides associated with the categories indicated in the distributor category ID field 1410 may be provided to the distributor to select a suitable guide for responding to the queries. A category associated with a distributor may be used to select distributed content which may be provided responsive to a request. Using the example illustrated in FIG. 14 the categories ‘Advice’, ‘Fashion’ and ‘Dating—Female’ are associated with the distributor ID ‘Heartfelt Advice’ as indicated in the distributor record 1400b. A category associated with a distributor may be associated with a rating or ranking. For example, the rating ‘7’ is associated with the category ‘Entertainment’ for the distributor ‘Music, Facebook’. A rating and/or ranking associated with a distributor may be used to select a distributor to receive a request. While a single rating or ranking is illustrated, it is envisioned that multiple ratings and/or rankings may be associated with cost, value, performance, response time, etc. of a distributor.

The distributor keyword ID field 1415 may indicate information of a number of keywords associated with a distributor. Content of the distributor keyword ID field 1415 may be determined based on actions of a distributor. For example, a registration process may include a conversation or dialogue, a set of resources indicated by a distributor may be analyzed, responses and/or requests of a distributor may be analyzed using techniques such as word frequency, etc., to associate a keyword with a distributor. A distributor may select a keyword associated with the distributor. A keyword may be associated with a distributor based on a category associated with the distributor. Using the example illustrated in FIG. 14, the keywords ‘BFF’, ‘nose piercing’, ‘boyfriend’, ‘perfume’, and ‘tanning’ are associated with the distributor ID ‘Heartfelt Advice’. A keyword of a distributor may be associated with a rating and/or ranking in a similar manner to a category. In at least one embodiment, a ranking and/or rating associated with a keyword may be given higher weight than a ranking and/or rating associated with a category. A general ranking of a distributor may be determined based on suitable factors, which may be used to determine whether a query will be directed to the distributor.

The distributor resource ID field 1420 may include information of a number of resources associated with a distributor. For example, a distributor may designate content which is to be used for responding to queries, a user associated with a distributor may be provided with a ranked list of resources which may be selected, a distributor may approve a list of resources and/or other suitable methods may be employed to associate resources with a distributor. Using the example in FIG. 14 the websites <<‘http://www.heartfeltadvice.com’>> and <<‘http://heartyblogging.net’>> are resources associated with the distributor ID ‘Heartfelt Advice’. A request may be posted to a resource associated with a distributor to direct the request to the distributor. In at least one embodiment, content of the distributor resource ID field 1420 may indicate an Application Programming Interface (API) associated with a distributor. A standardized API may be used as part of a registration process for a distributor.

The distributor communication information field 1425 may include information of a number of communication services associated with a distributor. For example, a user name and password, an email address, an IM credential, a phone number, a web page, a physical address, etc., may be indicated in the distributor communication information field 1425. Using the example illustrated in FIG. 14, ‘Heartfelt Advice’ is associated with the login ID ‘Heartfelt Advice’, the email ‘moderators@heartfeltadvice.com’, the twitter ID ‘heartfeltadvice’, and the phone number ‘432.783.3581’. This may indicate that distributor ‘Heartfelt Advice’ may be contacted using the associated communication services listed in the distributor communication information field 1425. For example, an email address associated with a distributor may be obtained during and/or after a registration process for a distributor.

The distributor query ID field 1430 may include information of a number of queries associated with a distributor. If a query is directed to a distributor and/or a distributor responds to a query, an identifier of the query may be indicated in the distributor query ID field 1430. Using the example in FIG. 14, the query identifiers ‘Request1.3’, ‘Request3.4’, and ‘Request4.3’ are associated with the distributor ID ‘Heartfelt Advice’.

The distributor source ID field 1435 may include information of a number of sources associated with a distributor. Content of the distributor source ID field 1435 may be modified based on actions of a person. An administrator, a distributor, a guide and/or a user may take actions which may cause a source to be associated with a distributor. A distributor may, for example, select a source to be associated with the distributor. An administrator may select a source to be associated with a distributor based on items such as a rating, a keyword, a category, a profile, an affiliation, etc., associated with the source. A source associated with a distributor may be an indicator of a person associated with the distributor. For example, if a distributor is a gaming website, a user ID of a player might be indicated in the distributor source ID field 1435. Any information which may indicate how a response was produced may be indicated in the distributor source ID field 1435, which may improve routing of requests to a suitable distributor and distribution channel. Using the example in FIG. 14 the sources ‘HeartfeltAdvicer1’, ‘HeartfeltAdvicer2’, and ‘HeartfeltBlogger4’ are associated with the distributor ID ‘Heartfelt Advice’.

The distributor source rating field 1440 may include information of a rating associated with a source. Content of the distributor source rating field 1440 may be used to rank a source. For example, a source with a higher rating may have a higher ranking for responding to queries directed to a distributor. In at least one embodiment, the distributor source ID field 1435 and the distributor source rating field 1440 may be linked by, for example, a pointer. Using the example in FIG. 14, ‘HearffeltAdvicer1’ has a rating of ‘0.9’, ‘HeartfeltAdvicer2’ has a rating of ‘0.7’, and ‘HeartfeltBlogger4’ has a rating of ‘0.85’. This may indicate that a request is more likely to be directed to the distributor ‘Heartfelt Advice’ if ‘HeartfeltAdvicer1’ is available to respond to the request. Content of the distributor source rating field 1440 may be determined in various ways. In at least one embodiment, a distributor may review responses posted from a source associated with the distributor to determine a rating of the source. Ratings of users of responses may be used to determine a rating of a source and/or a distributor.

The distributor answer ID field 1445 may include an identifier or indicator of a number of answers submitted in response to queries set to a distributor. An answer may be associated with a rating and/or ranking which is related to a request. In at least one embodiment, the distributor query ID field 1430 and the distributor answer ID 1445 may be linked by for example a pointer. Using the example in FIG. 14, ‘Answer4.3.2’ and ‘Answer4.3.1’ are associated with ‘Request4.3’. As indicated by the numbers in parentheses, ‘Answer4.3.1’ is ranked first, and ‘Answer4.3.2’ is ranked fourth for ‘Request4.3’. An answer may be ranked and/or rated for any number of requests.

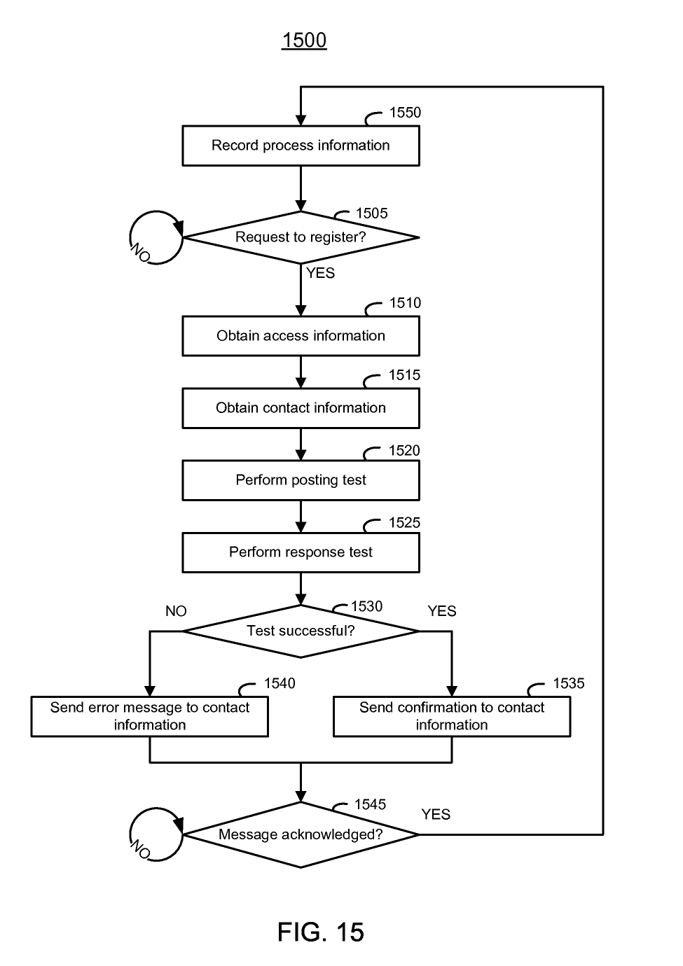

As illustrated in FIG. 15, a process 1500 for registering a distributor is provided. The process 1500 may be performed in whole or in part by any suitable element of the system 1000 (FIG. 10). In at least one embodiment, the process 1500 is operative on a server associated with the search system 1030 (FIG. 10). The process 1500 may be used to register any type of responder. For example, a user of a system such as the LinkedIn® networking service, or the Twitter® blogging service might be registered as a distributor user using credentials already provided by the respective services which have registered as distributor systems. A distributor may or may not include a plurality of users.

In operation 1505 (FIG. 15), a determination is made as to whether a request to register a distributor is received. If it is determined in operation 1505 that a request to register a distributor is not received, control remains at operation 1505 and process 1500 continues. If it is determined in operation 1505 that a request to register a distributor is received, control is passed to operation 1510 and process 1500 continues.

The determination in operation 1505 may be made using various criteria. For example, if a person elects to receive a request as a distributor, receipt of an SMS message associated with a mobile device of the person at a short code may be used to determine that a request to register a distributor is received. A registration request may be received as a web-based request using an API, a web form, etc.

In operation 1510, access information is obtained from a distributor. For example, a user name, a password, and a URL might be obtained. In at least one embodiment, the access information may be used to log on to a distributor site such as a blog, social networking site or forum, in order that queries may be posted. Any information which may be used to send a request and receive a response may be obtained. Control is passed to operation 1515 and process 1500 continues.

In operation 1515, contact information is obtained from a distributor. Contact information may include an email address, an IM credential, a phone number, a web page, a physical address, etc. Contact information of a distributor may be used to communicate with a distributor using an alternate channel to that used for exchanging queries and responses. Control is passed to operation 1520 and process 1500 continues.

In operation 1520, a posting test is performed. A posting test may verify that a query posted according to the access information provided by a distributor does not produce error messages. For example, an HTTP POST request might be transmitted to an address to check for a suitable response from the associated server. Any type of message might be sent, such as an email, an SMS, a voice message, an IM, etc., based on access information obtained. Control is passed to operation 1525 and process 1500 continues.

In operation 1525, a response test is performed. A response test may be used to verify that an expected message is received responsive to a posting. Any type of test which checks for a response to a request delivered in a post test may be a response test. For example, if an API is used to exchange requests and responses, a response received from the API may be confirmed. An SMS, IM, email, voice, or other type of communication may be received during a response test. Control is passed to operation 1530 and process 1500 continues.

In operation 1530, a determination is made as to whether the test is successful. If it is determined in operation 1530 that the test is successful, control is passed to operation 1535 and process 1500 continues. If it is determined in operation 1530 that the test is not successful, control is passed to operation 1540 and process 1500 continues.

The determination in operation 1530 may be made based on various criteria. For example, if an error message was received, if no response was received, if an incorrect response was received, or if any error condition is detected in the posting test and/or the response test it may be determined that the test is not successful. In at least one embodiment, a posting test and/or a response test may include load testing wherein a number of requests and responses in a predetermined time period may be evaluated.

In operation 1535, confirmation of the successful test is sent to contact information. For example, the contact information obtained in step 1515 may be used to independently obtain confirmation of success of the test and/or notify a distributor of success. Control is passed to operation 1545 and process 1500 continues.

In operation 1540, an error message is sent to contact information. An error message may contain additional information as to how to resolve the error. An error message may be provided using any contact information available for a distributor. For example, a summary of test results obtained from the connection test may be provided to an email address associated with a distributor, or an SMS message may be delivered to a mobile phone alerting a distributor that an email message or a blog posting has ‘bounced’, etc. Control is passed to operation 1545 and process 1500 continues.

In operation 1545, a determination is made as to whether a message is acknowledged. If it is determined in operation 1545 that a message is not acknowledged, control remains at operation 1545 and process 1500 continues. If it is determined in operation 1545 that a message is acknowledged, control is passed to operation 1550 and process 1500 continues.

The determination in operation 1545 may be made based on various criteria. If a message including a URL is sent as the error message, receipt of the URL may be used to indicate that a message is acknowledged. If a message is sent to an automated system, a response including security information may be used to determine that a message is acknowledged. A text message keyword, a response to a CAPTCHA (Completely Automated Turing test to tell Computers and Humans Apart), a spoken response, and/or any type of pre-defined response from a communication system associated with a distributor may be used to determine whether a message is acknowledged.

In operation 1550, process information is recorded. Information regarding communication services, performance data, number of registration attempts, error messages, security information, parameters such as keywords, categories, sources, ratings, rankings, etc., associated with a distributor may be recorded. In at least one embodiment, process information is recorded in the database 1020 (FIG. 10). Control is passed to operation 1505 and process 1500 continues.

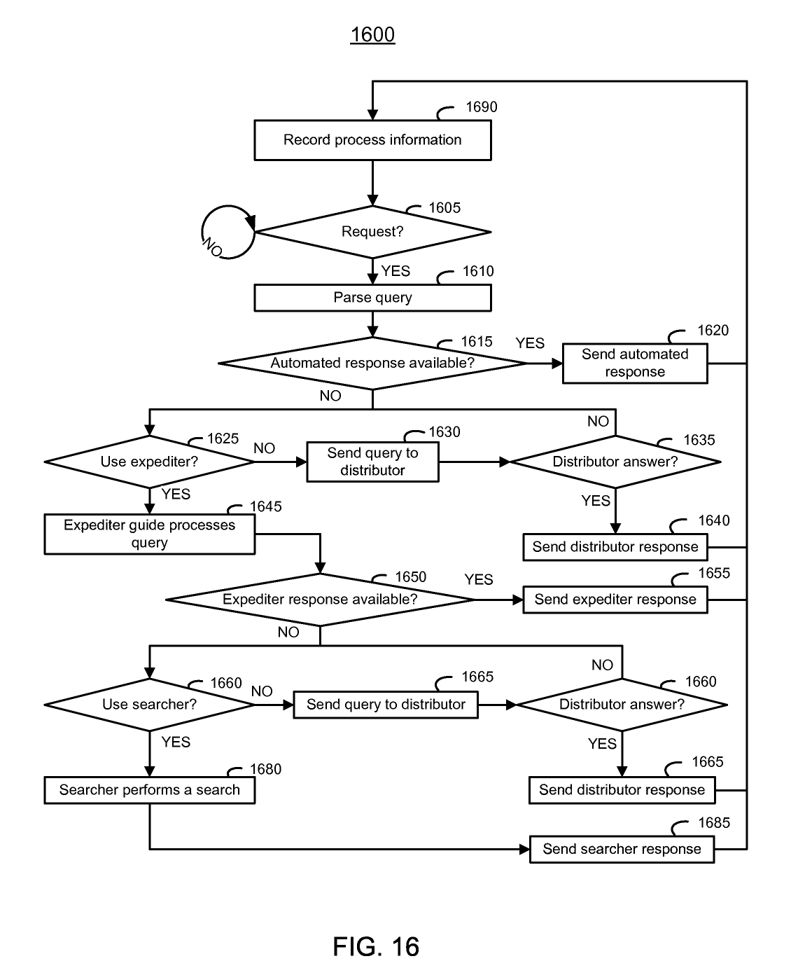

As illustrated in FIG. 16, a process 1600 for responding a request is provided. The process 1600 may be performed in whole or in part by any suitable element of the system 1000 (FIG. 10). In at least one embodiment, the process 1600 is operative on a server associated with the search system 1030 (FIG. 10). The process 1600 may be used to respond to any suitable request.

In operation 1605 (FIG. 16), a determination is made as to whether a request is received. If it is determined in operation 1605 that a request is not received, control remains at operation 1605 and process 1600 continues. If it is determined in operation 1605 that a request is received, control is passed to operation 1610 and process 1600 continues.

The determination in operation 1605 may be made using various criteria. In at least one embodiment, if a message is received at a server associated with the search system 1030 (FIG. 10), it may be determined that a request is received. For example, if an email message, an SMS, EMS, and/or MMS message, an IM, an IP message, and/or a voice message is received at an address associated with the search system 1030 it may be determined that a request is received. In at least one embodiment, if a request is received at a web server a request web page may be provided to a browser functionality of a user system. In at least one embodiment, a request may be an SMS message received from a mobile device. Any communication service which may be accessible to the search system 1030 may be used to submit a request.

In operation 1610, a query is parsed. Parsing of a query may be used to determine how a response to a request may be generated and/or obtained. Parsing may include various types of automated processing. For example, a request may be subject to spelling and/or grammar correction, syntactic analysis such as parts of speech detection, tagging, Penn trees, stemming, named entity analysis, signatures, greetings, and titles may be removed, etc. A request may be compared to a database of stored requests. Comparison of a query to stored requests may be used to determine a categorization of a request. Categories may also be rated. Exemplary algorithms for selecting and rating a categorization associated with a query are presented in T. Kardkov, et. al., The Ferrety Algorithm for the KDD Cup 2005 Problem, 7 SIGKDD Explorer Newsletter no. 2, issue 1931-0145 at 111-116 (2005), and Shruti K. Bhandari and Brian D. Davison, Leveraging Search Engine Results for Query Classication, LU-CSE-07-013, Dept. of Comp. Sci. and Eng., Lehigh Univ. (2007). Any type of automated pre-processing may be performed on a request as part of the parsing operation. Parsing may further be used to assist in determining a value associated with generating a response to a request. A value associated with a request maybe economic value and/or compensation, and/or other forms of consideration. For example, a keyword and/or category associated with a request may be used to select an advertisement, which may affect a value associated with a request. Value determined for a request may be based on earnings associated with responding to the request. For example, if a user has agreed to pay a predetermined amount for a response, that value may be associated with a request. Likewise, a time value may be associated with a request, which may affect value of the request. Control is passed to operation 1615 and process 1600 continues.

In operation 1615, a determination is made as to whether an automated response to a query is available. If it is determined in operation 1605 that an automated response is not available, control is passed to operation 1625 and process 1600 continues. If it is determined in operation 1605 that an automated response is available, control is passed to operation 1620 and process 1600 continues.

The determination in operation 1615 may be based on a pattern match to a query, a match to a previous query, or any algorithm and/or methodology which may be used to map a user query to an automated resource which may respond to the query. A value associated with a request may be used to determine whether an automated response is available for the request. A high value query may require a higher confidence factor that an automated result matches the query. For example, a query associated with a high value topic, keyword, category and/or user may be more likely to receive a human touched answer. A cost associated with responding to a query may be determined. For example based on a number of available resources such as expediters, distributors, etc., a cost to respond using a human assistant may be determined.

In operation 1620, an automated response is sent. An automated response may be sent by any means associated with a user such as, for example, an email message, an SMS, EMS, and/or MMS message, an IM, and/or a voice message. Control is passed to operation 1690 and process 1600 continues.

In operation 1625, a determination is made as to whether an expediter should be used. If it is determined in operation 1625 that an expediter should not be used, control is passed to operation 1630 and process 1600 continues. If it is determined in operation 1625 that an expediter should be used, control is passed to operation 1645 and process 1600 continues.

The determination in operation 1625 may be made according to various criteria. A destination associated with a query may be determined by analyzing information associated with a query to determine a destination to which the query may be posted. Availability of expediters versus a current queue of queries may affect whether an expediter is to be used. For example, queries may be ranked according to value and dispatched to an expediter in order of value. A ranking of available distributors may affect whether an expediter will be used. For example, if a distributor which has a high ranking or rating for a category associated with a query is available, the query may be more likely to be routed to the distributor than to an expediter. A ranking of an expediter and/or a distributor source may affect whether an expeditor will be used. For example, if a highly rated distributor source associated with a category of a query is available, the query may be less likely to be routed to an expediter. A time value associated with a query may affect whether an expediter will be used. For example, if a query with a short time value has already been routed to a distributor, but has not received a response, the query may be routed to an expediter in order to obtain a rapid response. A query destination may include any number of distributors. A query may be persisted on a distributor system for any time period. A distributor may be informed when a response has been provided to a query. A response to a query may be shared with a distributor. A distributor may be compensated for a response.

In operation 1630 (FIG. 16), a query is sent to a distributor. A method for routing queries to distributors is further described herein with respect to FIG. 16. Any number of distributors may be selected to receive a request. Control is passed to operation 1635 and process 1600 continues.

In operation 1635, a determination is made as to whether a distributor has answered. If it is determined in operation 1635 that a distributor has answered, control is passed to operation 1640 and process 1600 continues. If it is determined in operation 1635 that a distributor has not answered, control is passed to operation 1625 and process 1600 continues.

The determination in operation 1635 may be made based on various criteria. If a distributor responds with a message, a predetermined time period expires, a number of response messages are received, a decline message is received, etc., it may be determined that a distributor has answered. For example, if a percentage of a time period associated with the request time value field 1120 (FIG. 11) has passed since a request was directed to a distributor, it may be determined that a distributor has not answered.

In operation 1640, a distributor response is sent. A distributor response may be determined based on a rating and/or ranking of a distributor response. For example, if a response is received from a high ranking distributor, it may be more likely that the response will be sent. A distributor response may be delivered to a guide who may review and/or revise the response. For example, an examiner guide may correct spelling, grammar, and/or edit a response. Any sort of annotations may be made to a response. Actions of an examiner guide may be used to rate and/or rank a response. If more than one response is received, the responses may be provided to a guide to select a response, which may be used to determine a ranking of the response. A distributor response may be delivered to a user via any communication service associated with the user. For example, if a user query is received from a website, multiple responses may be provided, while if a query is received by SMS a limited number of responses may be provided. Control is passed to operation 1690 and process 1600 continues.

In operation 1645, an expediter guide processes a query. For example, an expediter may be provided with information of a user query, as well as results of automated processing of the query. An expediter may determine whether a human searcher is required to provide a response to a query. An expediter may modify, rephrase, categorize, interpret and/or otherwise augment a query. A question type may also be selected by an expediter to better process the query. For example, an expediter may determine whether a query is a conversational query, which may be more likely to receive a response from a distributor. An expediter may also submit a query to an automated resource. An expediter may also select a previous response and/or search result to answer a query. Control is passed to operation 1650 and process 1600 continues.

In operation 1650, a determination is made as to whether an expediter response is available. If it is determined in operation 1650 that an expediter response is available, control is passed to operation 1655 and process 1600 continues. If it is determined in operation 1650 that an expediter response is not available, control is passed to operation 1660 and process 1600 continues.

The determination in operation 1650 may be made based various criteria. For example, an action taken by an expediter, such as, selecting a response, correcting spelling, rewriting a query, selecting a query type, etc., may be used to determine if an expediter has identified a response to a query. For example, an expediter may have written a free-form response to a request, directed a query to an automated resource for translation, stock quotes, etc., indicated that a query requires clarification, etc. An expediter may select a control to explicitly direct a query to a searcher, which may indicate that an expediter response is not available.

In operation 1655, an expediter response is sent to the user. An expediter response may be sent by any communication service associated with a user. For example, an email message, an SMS, EMS, and/or MMS message, an IM, a blog posting, a web page, and/or a voice message may be used to deliver a search result. Control is passed to operation 1690 and process 1600 continues.

In operation 1660, a determination is made as to whether a searcher is to be used. If it is determined in operation 1660 that a searcher is to be used, control is passed to operation 1680 and process 1600 continues. If it is determined in operation 1660 that a searcher is not be used, control is passed to operation 1665 and process 1600 continues.

The determination in operation 1660 may be based on various criteria. An indication by an expediter as to the nature of a query may be used to determine whether a searcher is to be used. For example, if an expediter indicates that a query is a conversational query, it may be more likely that a searcher will not be used. A value associated with a query may be used to determine whether a searcher is to be used. A cost associated with a searcher, a distributor, a resource, etc. may be used to determine whether a searcher is to be used. Availability of searchers, distributors, resources, etc. may be used to determine whether a searcher is to be used. A time value associated with a query may be used to determine whether a searcher is to be used. For example, if a query has a longer time period remaining until an answer is required it may be less likely that a searcher will be used. A category, keyword, profile, location, etc. of a request may affect the probability that a searcher will be used. For example, if a high value is associated with a particular location, it may be more likely that a searcher will be used.

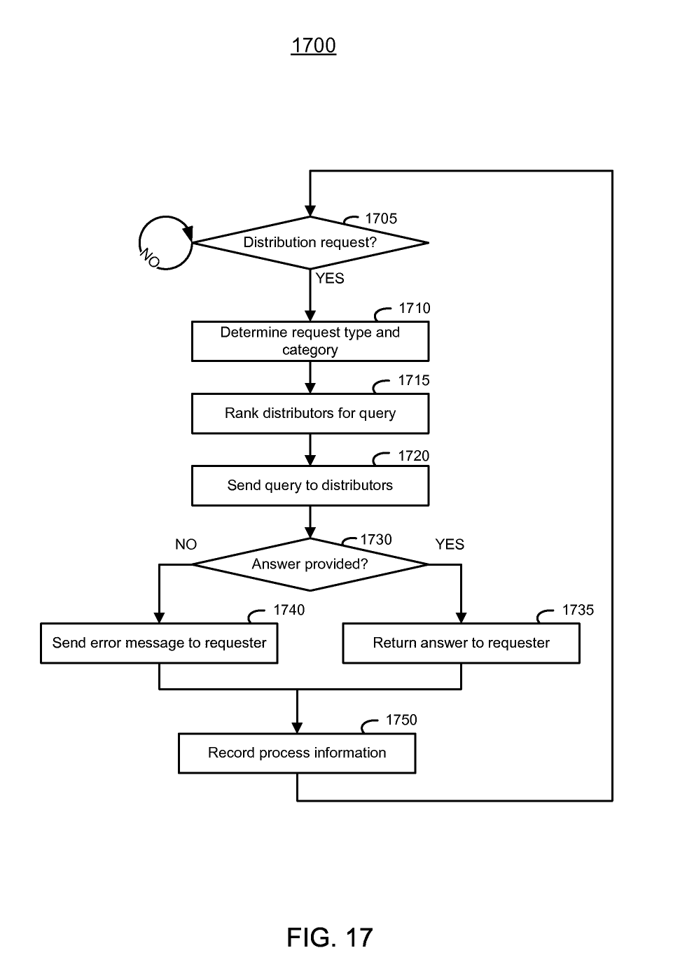

In operation 1665, a query is sent to a distributor. A process for distributing a query to a distributor is further described herein with respect to FIG. 17. Various types of distribution criteria may be used. Distribution criteria may be adjusted based on whether a human assistant has processed a request. For example, if an expediter has processed a request, a human transcriber has transcribed a request, etc., distribution criteria associated with the request may be changed. Likewise, if a request has been previously distributed without receiving a response, distribution criteria may be modified. Control is passed to operation 1670 and process 1600 continues.

In operation 1670, a determination is made as to whether a distributor answered a query. If it is determined in operation 1670 that a distributor has answered a query, control is passed to operation 1675 and process 1600 continues. If it is determined in operation 1670 that a distributer has not answer a query, control is passed to operation 1660 and process 1600 continues.

The determination in operation 1670 may be made based on various criteria. If a distributor responds with a message, a predetermined time period expires, a number of response messages are received, a decline message is received, etc., it may be determined that a distributor has or has not answered. For example, if a percentage of a time period associated with the request time value field 1120 (FIG. 11) has passed since a request was directed to a distributor, it may be determined that a distributor has not answered. Likewise, if a request includes a hyperlink, if the hyperlink is activated, it may be determined that a distributor answered a query.

In operation 1675, a distributor response is sent. A distributor response may be determined based on a rating and/or ranking of a distributor response. For example, if a response is received from a high ranking distributor, it may be more likely that the response will be sent. A distributor response may be delivered to a guide who may review and/or revise the response. For example, an examiner guide may correct spelling, grammar, and/or edit a response. Any sort of annotations may be made to a response. Actions of an examiner guide may be used to rate and/or rank a response. If more than one response is received, the responses may be provided to a guide to select a response, which may be used to determine a ranking of the response. A distributor response may be delivered to a user via any communication service associated with the user. For example, if a user query is received from a website, multiple responses may be provided, while if a query is received by SMS a limited number of responses may be provided. A distributor response may include an indication of a distributor source associated with the response. Control is passed to operation 1690 and process 1600 continues.

In operation 1680, a searcher performs a search. A selected searcher may be provided with a set of tools which may allow the searcher to respond to a query more effectively. A searcher may provide a response or search result for a request or query. A searcher response may be compared to a distributor response to a query. A searcher may be selected based on prior processing of a query. For example, if an expediter, responder, and/or automated answer has previously been rejected, a searcher may be selected based on that information. If a query has been directed to responders associated with a plurality of categories and did not receive a response, a different category might be used to select a searcher. Control is passed to operation 1685 and process 1600 continues.

In operation 1685, a searcher response is sent. A searcher response may be sent by any communication service associated with a user. For example, an email message, an SMS, EMS, and/or MMS message, an IM, a blog posting, a web page, and/or a voice message may be used to deliver a search result. Control is passed to operation 1690 and process 1600 continues.

In operation 1690, process information is recorded. In at least one embodiment, information of a request, a response, a distributor, a distributor source, an expediter, a searcher, a user, a resource, a keyword, a profile, and a category are recorded. For example information may be recorded in the database 1020 (FIG. 10). A rating of any item associated with a request may be determined based on information of processing the request such as time, ability to locate a result, ratings by a user, ratings by a distributor, etc. Control is passed to operation 1605 and process 1600 continues.

While the process 1600 has been described in terms of a separate path whereby a query is processed by a searcher and/or an expediter or distributed to a distributor, in at least one embodiment, a query may be routed to a distributor as well as being routed to an expediter and/or a searcher. A comparison of results and/or responses associated with a distributor to results associated with an expediter and/or searcher may be used to determine a rating of a searcher, expeditor, and/or a distributor. A response or result associated with a distributor may be provided to an expediter when the search result is determined to match a query. A selection of a response associated with a distributor may be used to determine a rating associated with the response, and may be used to determine a ranking of the response, a distributor, a resource, a distributor source, a searcher, etc. In other words, a query may follow multiple possible paths in series and/or in parallel and in any suitable sequence in various embodiments.

As illustrated in FIG. 17, a process 1700 for distributing a query is provided. A query might be served to operators of websites on a cost-per-action basis. In such an embodiment, an operator of a web property might agree to accept queries and to be paid based on a number of answers provided by users of the web properties and/or accepted by the search system 1030 (FIG. 10). For example, a website might provide topical pages regarding celebrities, financial matters, sports, etc. If a person responded to a query posted on the web properties, an operator of the property might receive compensation for the response. This feature might allow targeting of queries by operators of diversified web properties, rather than requiring an operator of a service receiving queries to determine targeting information. The ability to post queries for responses may create an alternate source of revenue for a website operator. The process 1700 may be performed in whole or in part by any suitable element of the system 1000 (FIG. 10). In at least one embodiment, the process 1700 is operative on a server associated with the search system 1030 (FIG. 10). In at least one embodiment, the process 1700 is operative on a server associated with a distributor system such as the distributor system 1045.

In operation 1705, a determination is made as to whether a distribution request is received. If it is determined in operation 1705 that a distribution request is not received, control remains at operation 1705 and process 1700 continues. If it is determined in operation 1705 that a distribution request is received, control is passed to operation 1710 and process 1700 continues.

The determination in operation 1705 may be made based on various criteria. A distribution request may be submitted using various communication services. Any communication service such as email, IM, TCP/IP, SMS, MMS, EMS, voice, wired and/or wireless communication, etc., may be used to submit a distribution request. A distribution request may include information of a query which is to be distributed. Information regarding a user, a category, a location, a profile, a value, a format, a response type, a request type, a confidence factor associated with any items, etc. may be provided in a distribution request.

In operation 1710, a request type and category are determined. Determination of a type, category, etc. may be done using human and/or automated processing of a request. Request types may be associated with various properties of the received requests. For example, a category, a keyword, a profile, a time interval, and/or other information associated with a request may be used to select a recipient of a request. Control is passed to operation 1715 and process 1700 continues.

In operation 1715, a distributor is ranked for a query. A ranking of a distributor may be performed on any basis. For example, factors such as a category, a profile, a keyword, a type, a location, a cost, a value, and an affiliation associated with a request and/or a query may be used to determine a rating and/or a ranking of a distributor for a query. A weighting of a ranking or rating associated with a request and/or a distributor may be adjusted based on content of a distribution request. If a time period associated with a query has been reduced, a distributor associated with a faster response time may receive a higher ranking, or if a query has a high value a quality rating associated with a distributor may have a higher weighting. Historical information of distribution of a query may affect a ranking of a distributor. Control is passed to operation 1720 and process 1700 continues.

In operation 1720, a query is sent to a distributor. A query may be sent based on the communication services specified in a distributor database. In at least one embodiment, a query may be posted to a web page associated with a category and/or keyword of the query. Posting to an associated web page may increase the likelihood that a query will receive a response. In at least one embodiment, a query may be posted to a social networking site such as the Facebook® site, to a forum such as the AVS Forum® site which may be associated with a particular category of requests, and/or to a bulletin board service associated with the topic of the question or query. In at least one embodiment, a query may be posted to a query-based social network. If a query is posted to a social network, the query may be identified as a ‘foreign’ query which has originated outside the social network. For example, a separate window including a number of foreign queries may be provided. In at least one embodiment, a posting regarding a query is a link to a web page which may be used to provide an answer or response to the query. In at least one embodiment, a person responding to a request may be invited to create an account which may allow the person or ‘ad hoc’ searcher to receive compensation relating to the response. Answers or search results associated with the ad hoc searcher or ‘guest’ guide may be identified and may be indicated as a ‘guest’ guide result when presented. A query which is directed to an external site may be posted for a limited time. For example, a query which is posted to a social networking site might be posted as a recommendation, or sponsored link which would have a limited duration, which might be terminated when a specified number of responses are obtained. A query may be targeted to a destination based on targeting information associated with the query and a user of the website. For example, queries associated with a target demographic, geographic, affiliation, orientation, perspective, and/or other profile information may be directed to users of a website who are associated with any or all attributes associated with the query. Control is passed to operation 1730 and process 1700 continues.

In operation 1730, a determination is made as to whether an answer is provided. If it is determined in operation 1730 that an answer is not provided, control is passed to operation 1740 and process 1700 continues. If it is determined in operation 1730 that an answer is provided, control is passed to operation 1735 and process 1700 continues.

The determination in operation 1730 may be made based on various criteria. For example, if no distributor provides an answer within a time period, an insufficient number of responses are received, a request is not accepted by a distributor, an error message is received from a server associated with a distributor, a response message is received, etc. it maybe determined that an answer is or is not received.

In operation 1735 (FIG. 17), an answer is returned to the requester. An answer may be returned to a requester in any suitable way. In at least one embodiment, an answer received from a distributor may be provided to a user via a communication service associated with the user. An answer from a distributor may be ranked by for example, the search system 1030 (FIG. 10) to determine whether the answer may be provided to a user. A distributor system may rank answers received. Control is passed to operation 1750 and process 1700 continues.

In operation 1740, an error message is sent to the requester. An error message may be sent directly to a user. In at least one embodiment, if an error message is received from a distributor, the search system 1030 (FIG. 10) may direct the request to an alternate resource, may provide an automated response, and/or may distribute the request to other distributors. Control is passed to operation 1750 and process 1700 continues.

In operation 1750, process information is recorded. In at least one embodiment, information of items such as a request, a response, a distributor, an expediter, a distributor source, a user, a resource, a keyword, and/or a category are recorded. For example, process information may be recorded in the database 1020 (FIG. 10). A rating of any item associated with a request may be determined based on information of processing the request such as time, ability to locate a result, ratings by a user, ratings by a distributor, ratings by guides, etc. Control is passed to operation 1705 and process 1700 continues.

A distributor system may deliver queries to users of blog and/or forum sites. For example, a distributor system may post queries regarding topics to forums and/or blogs associated with a topic, or may analyze content of forums and/or blogs to locate relevant responses to queries. A distributor may aggregate information from multiple sources, and may provide a response based on aggregated information.

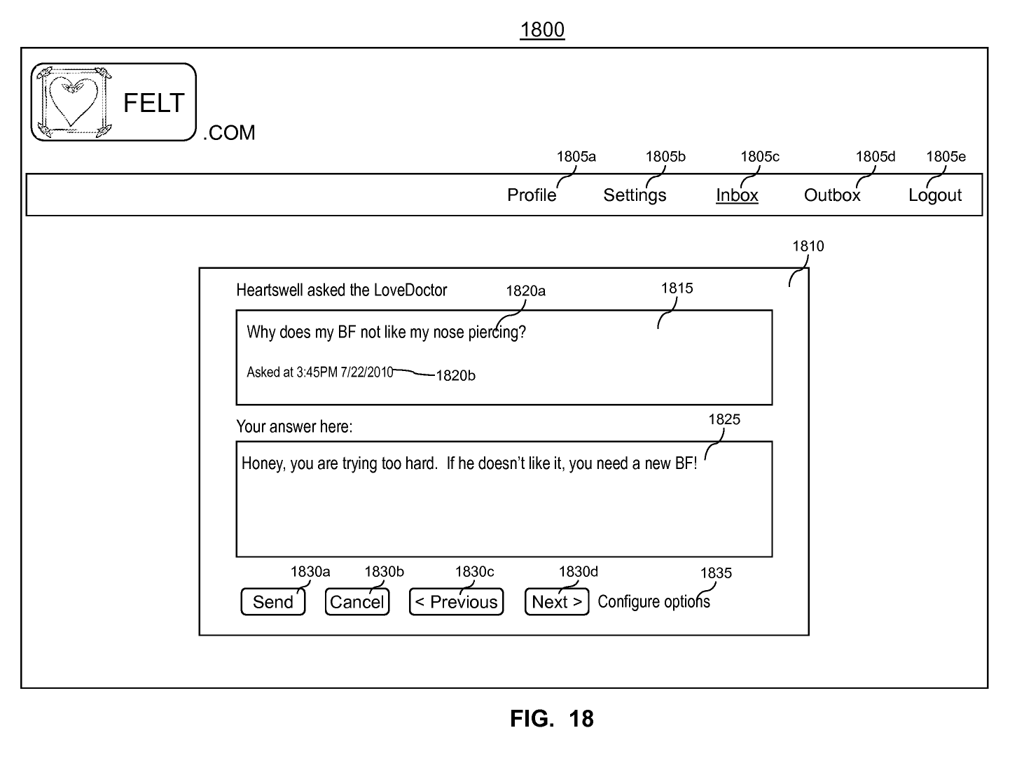

A GUI 1800 which may be provided for responding to a query in a forum is illustrated in FIG. 18. The GUI 1800 would typically be that which is native to the blog, forum, etc., in order to meet user needs and expectations. The response GUI 1800 may include selection controls 1805, a dialogue window 1810, a query window 1815, query indicators 1820, an answer window 1825, action buttons 1830, and an options control 1835. The GUI 1800 may be provided on a display device associated with a system such as the website user system 1070a (FIG. 10).

The selection controls 1805 may be used to select an activity. An active selection control 1805 may be indicated in any suitable manner. As illustrated in FIG. 18, the ‘Inbox’ selection control 1805c is active as indicated by the underline. An active selection control may be indicated by color, graphics, or other suitable indication. The ‘Profile’ selection control 1805a may be used to select a profile web page (not shown). The ‘Settings’ selection control 1805b may be used to select a GUI (not shown) which may be used to change the settings associated with the user account, such as communication options, contact information, personal data, etc. The ‘Inbox’ selection control 1805c may be used to cause the GUI 1800 to be provided. The ‘Outbox’ selection control 1805d may be used to cause the user's Outbox to be provided. The ‘Logout’ selection control 1805e may be used to login and logoff. A system may be for example a distributor system such as the ‘distributor system 2’ distributor system 1050 (FIG. 10).

The dialogue window 1810 (FIG. 18) may provide information of a query which has been distributed. The query window 1815 may indicate information of a query requesting a response. The query indicator 1820a may indicate a query such as a query distributed to the distributor system 1050. The query indicator 1820b may be used to indicate information regarding a query such as the time and date of the query. The response indicator 1825 may be used to indicate a response to the query indicated in the query window 1815. The ‘Send’ action button 1830a may be used to submit a response to a query. The ‘Cancel’ action button 1830b may be used to clear the content of the response indicator 1825. The ‘Next’ action button 1830d may be used to advance to a subsequent request. The ‘Previous’ action button 1830c may be used to return to a previous request. The configure options control 1835 may be used to configure options such as categories and/or keywords of queries, preferences such as demographic, geographic, or affinities associated with queries, etc., which may improve targeting of requests to a responder.

A distributor system may present queries using a quiz environment, such as that provided by funtrivia.com. A quiz may include new and/or historical queries which may be used to determine accuracy and/or a rating of players providing answers to queries. A site such as this provides an environment in which distributed queries should be similar to that of an existing user experience with a game website.

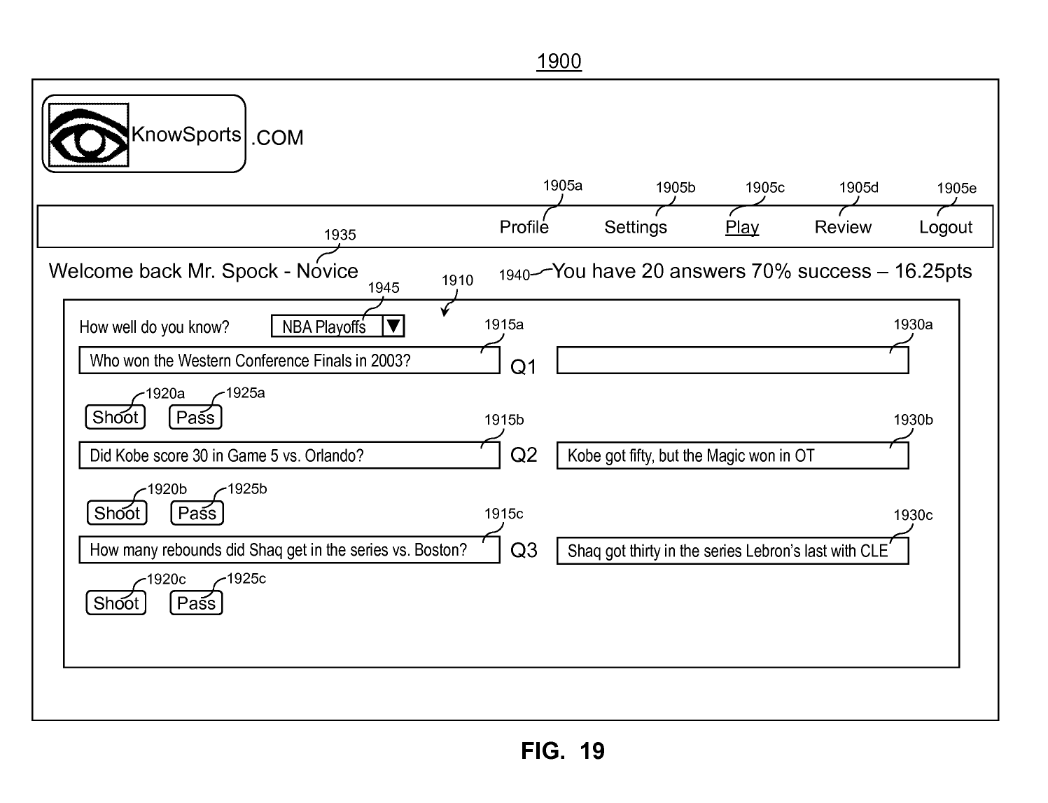

A GUI 1900 which may be provided for responding to a query in an on-line quiz website is illustrated in FIG. 19. The GUI 1900 may include selection controls 1905, a game playing window 1910, query indicators 1915, query acceptance controls 1920, query decline controls 1925, answer indicators 1930, an expertise level indicator 1935, a scorecard indicator 1940, and a topic selection control 1945. The GUI 1900 may be provided on a display device associated with a system such as the distributor user system 1080a (FIG. 10).

The selection controls 1905a-1905e (FIG. 19) may be used to navigate through the quiz environment. As illustrated in FIG. 19, the ‘Play’ selection control 1905c is active as indicated by the underline. The game playing window 1910 may include any number of queries associated with a selected expertise as indicated in the topic selection control 1945. The query indicators 1915a-1915c may be used to indicate a query included in a quiz. The query acceptance controls 1920a-1920c may be used to indicate that the user has provided a response to the query and is ready to submit the response. The query decline controls 1925a-1925c can be used to indicate that the user has declined to provide a response to the query. Activation of the query decline control 1925a may cause an alternate query to be provided in the query indicator 1915a. The answer indicators 1930a-1030c may be used to indicate a response to the associated query. For example, the response indicator 1930b indicates that the response ‘Kobe got fifty, but the Magic won in OT’ corresponds to the query ‘Did Kobe score 30 in Game 5 vs. Orlando?’ indicated in the query indicator 1915b. The expertise level indicator 1935 displays a level that the user has obtained in an expertise quiz environment. The user ‘Mr. Spock’ illustrated in FIG. 19 has achieved ‘Novice’ level. The scorecard indicator 1940 may be used to display a success rate for a user in the expertise quiz environment. Scoring information may be indicated in any suitable manner. The scorecard indicator 1940 indicates that ‘Mr. Spock’ has a seventy percent success rate for the twenty answers provided, and has accumulated sixteen and one quarter points. The topic selection control 1945 may be used to select a topic area for queries presented. For example, the drop-down indicator of the topic selection control 1945 indicates that queries associated with ‘NBA Playoffs’ will be provided.

A social networking and/or other game may be used to distribute queries. A query may be incorporated within the user experience of a game and/or may be presented overtly to a player.

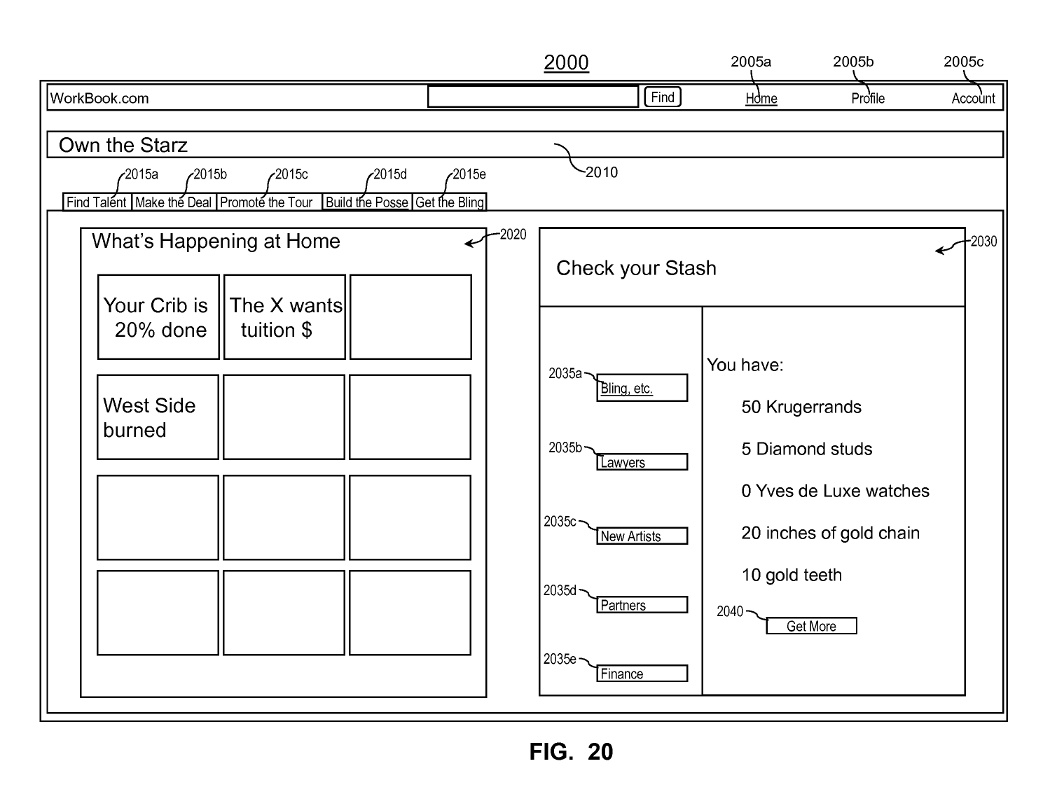

A GUI 2000 which may be provided for responding to a query in a social networking game is illustrated in FIG. 20. A website might present queries in a game-like environment. For example, a game might allow access to a next level of play if a user responds to a particular query. A response might be judged based on responses of others. For example, a response to an objective query might be compared to responses of other players to determine whether the response is ‘correct’. Likewise a subjective response might be accepted if it is grammatically correct. A game environment might include a variety of actions which might include responding to queries. Any number of queries presented to a game participant may be queries from other users, and/or may be queries with known responses. The social network game environment GUI 2000 may include navigation controls 2005, a game environment indicator 2010, activity controls 2015, an activity window 2020, a status window 2030, browse controls 2035, and action buttons 2040.

The navigation controls 2005 may be used by the user to navigate around the social networking site. For example, the ‘Home’ navigation control 2005a returns the user to the home page of the networking site while the ‘Profile’ navigation control 2005b allows a user to view a user profile, and the ‘Account’ navigation control 2005c may be used to review account information associated with a user and the social network distributor website. The ‘Home’ navigation control 2005a is active as indicated by the underline. The game environment indicator 2010 within the social networking site allows the user to play games through the social networking site. A game may be sponsored by the site, other users, a distributor, etc. The activity controls 2015a-2015e allow the user to select different activities within the game. For example, clicking on the “Build the Posse” activity control 2015d displays the activity window 2020 as illustrated in FIG. 20. The status window 2030 indicates information of the status of a game currently selected. The browse controls 2035a-2035e may be used to provide status information associated with various scoring information of a selected game. An active browse control 2035 may be indicated in any suitable way. The underline of the ‘Bling, etc.’ browse control 2035a indicated that a status associated with ‘Bling, etc.’ is provided in the status window 2030. The status window 2030 indicates that the user has accumulated fifty Krugerrands, five Diamond studs, zero Yves de Luxe watchers, twenty inches of gold chain, and ten gold teeth in the game “Own the Starz”. The action button 2040 allows the user to perform an action associated with the status of the game. For example, the “Get More” action button 2040 can be clicked on by the user to upgrade the user's status and collect more items by responding to queries and/or taking other actions within the game environment.

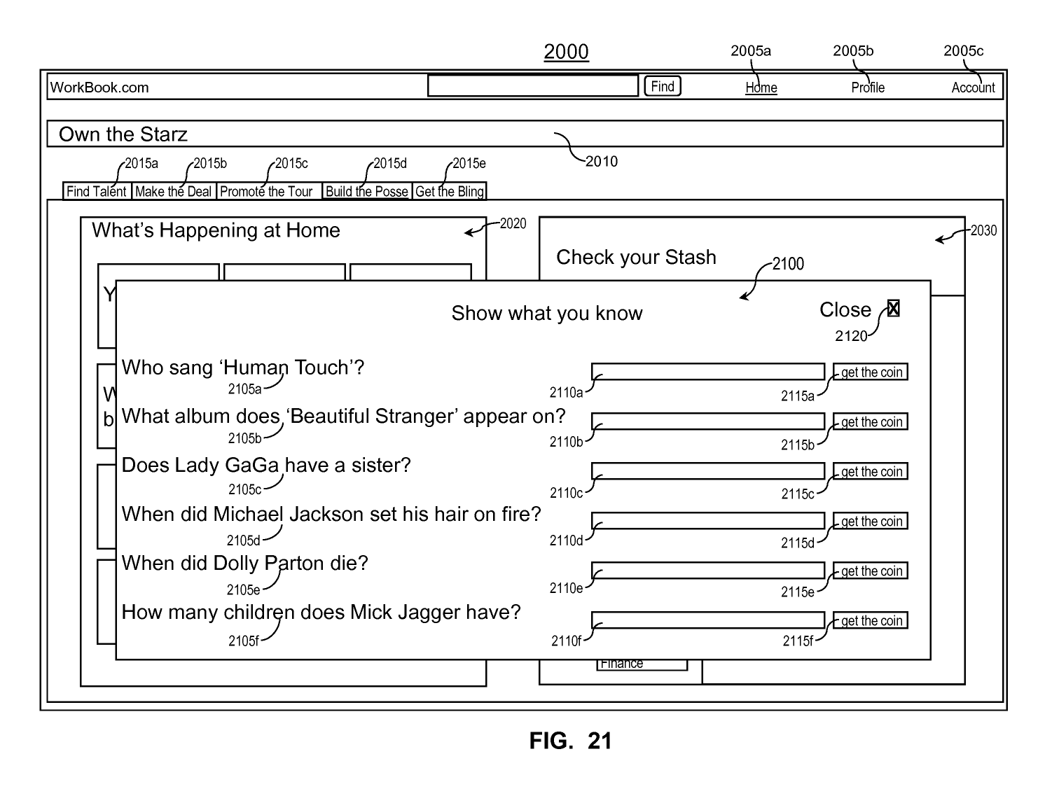

A GUI 2100 for responding to a query in a social networking game environment is illustrated in FIG. 21. The GUI 2100 may appear responsive to activation of the action button 2040 (FIG. 20). For example, the GUI 2100 may be a ‘pop-up’ window. The GUI 2100 may include query indicators 2105, response indicators 2110, answer submission controls 2115, and a window closure control 2120.

Any number of query indicators 2105 may appear in the GUI 2100. The queries indicated in the query indicators 2105a-2105f may be any mixture of previously answered queries, new queries and/or other queries of any sort. The response indicators 2110a-2110f may be used to indicate an answer to a query presented in the query indicators 2105a-2105f. The answer submission controls 2115a-2115f may be used to submit a response to a query. For example, if a user elects to respond to the query ‘Does Lady GaGa have a sister?’ displayed in the query indicator 2105c, an answer may be entered in the response indicator 2110c, and submitted using the answer submission control 2115c. Answers may be rewarded and/or penalized in any manner the game chooses with rewards that may be used in the play of the game environment. The window closure button 2120 may be used to close the GUI 2100. Scoring of answers may be performed immediately and/or on a delayed basis.

In at least one embodiment, queries may be distributed using SMS or other forms of messaging such as IM, MMS, email, etc. A person may elect to receive queries associated with a topic, affiliation, keyword, etc. For example, a person might elect to receive queries about a sports team, about a sport, about a city, about a business, about an organization, etc. Further a time period or other indicator of availability may be established for communication systems which may not include and/or provide presence information.

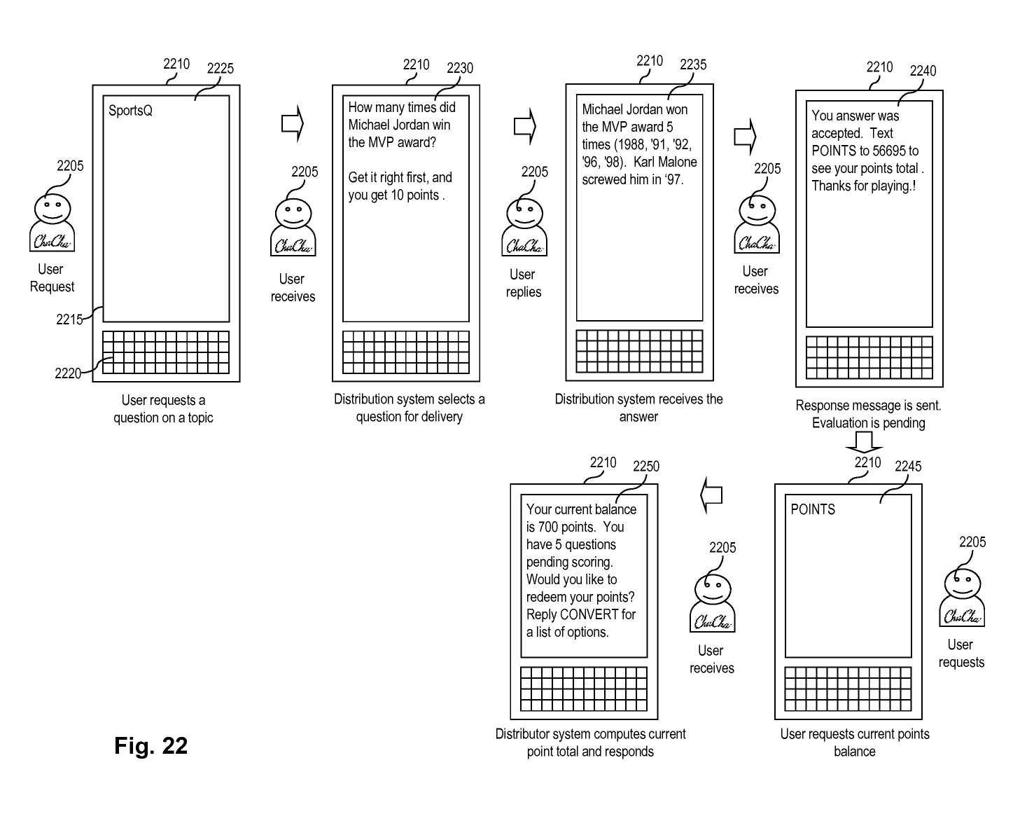

FIG. 22 illustrates a sequence of messages for distributing and responding to a request in an SMS environment. A user 2205 sends in a request via SMS from a user device 2210. The user device 2210 may include a display screen 2215 and an input device 2220. A user request message 2225 indicating that a user is wiling to accept a query may be sent to a distributor system such as the distributor system 1060 (FIG. 10). For example, the keyword “SportsQ” may indicate that the user 2205 wishes to respond to a query related to a sports topic. A distribution system may respond with a query message 2230. A distribution system response may be selected and delivered automatically and/or using the assistance of a person. The query message 2230 includes the question “How many times did Michael Jordan win the MVP award?” The query message may include information of a reward the user may receive. Using the example in FIG. 22, the user may receive ten points for providing a correct answer first. The user 2205 may transmit an answer message 2235. The answer message 2235 including a user response may be received by a distribution system, which may provide an answer to a user and/or the search system 1030 (FIG. 10). The user 2205 may receive a confirmation message 2240. The confirmation message 2240 may include information regarding acceptance and/or rejection of a response, information regarding accessing information regarding the user 2205, an advertisement, etc. The user 2205 may send a status request message 2245 to an address associated with a distributor system (i.e. ‘56695’) in order to learn an accumulated point value associated with the user 2205. The user 2205 may receive various types of status information based on messages from the user 2205. Responsive to the status request message 2245, the user 2205 may receive a user status message 2250. As indicated in the user status message 2250, a user may be informed of current point totals, which may or may not include responses pending review and/or acceptance. A point total associated with a user may be used to select a query to be delivered to the user. Any type of scoring may be used. While the messaging communication has been described with a single sequence of messages associated with a query and a response, it is anticipated that a user may for example elect to receive any number of queries, and/or may elect to receive queries until a message indicates that the user desires to cease receiving queries. While the distributor systems have been illustrated as separate components, any or all of the distributor systems may be incorporated in the search system 1030 (FIG. 10) in embodiments.

A method and system are described whereby queries which have been submitted to a search service may be distributed to various resources which may respond to a query. A query is evaluated to determine a compensation or reward or return or value associated with the query. A number of resources are identified and registered with the search service which may respond to a query. A system which may receive, distribute and respond to queries may be identified. A search system may selectively distribute a user query to one or more distributor systems for a response.

Distribution of queries may be balanced between internal resources such as paid searchers and/or expediters and external resources such as websites, social networks, blogs, interactive gaming, news sites, and/or other systems which provide advice and/or entertainment to users. Based on content of a query, and information associated with the query a value and a response interval may be associated with a query. A value associated with a query may be based on an advertisement available, a type of user submitting the query, time, etc. Responders may be associated with and ranked for any variables associated with a query such as keywords, profiles, locations, demographics, affiliations, response time, etc. A cost may be determined for a response associated with various types of responders. For example, internal resources may have a fixed cost while external resources may have costs associated with transmission, distribution and reception of a response. Any factors may be used to determine cost associated with a response.

A query may be provided to a distributor based on a ranking of the distributor versus other available distributors. For example, a keyword and/or category of a request may be used to rank distributors based on a probability that the distributor will respond to a request in a pre-determined time interval. If a query has high value, and the calculated probability of a response in the required time interval is less than a pre-determined value, the query may be processed by an internal resource. Likewise, if a query has been sent to a distributor for a time period, and no response has been received, the query may be dispatched to an internal resource. A search system may use various ranking and value determinations to balance system capacity based on a number of queries pending processing.

A rating of a responder may exist at various levels of granularity. For example, if a responder includes information of individual users of the system, a rating of the responder may be determined based on information of the individuals available to respond at the time a query is presented. A responder may present queries to users in any way. For example, users of a blog may view queries as postings to the blog. Likewise, users of a game may view and respond to queries within a game framework, and users of a messaging service might receive queries as messages such as email, IM, mobile messaging such as SMS, and/or MMS.

In a system wherein generalized queries are answered the cost to respond to a query is crucial to system performance. If this cost is high, usage of the service may be inhibited. To overcome the reluctance of a user to pay per use, answering services such as search engines are supported by advertising revenue in a manner similar to the Yellow pages or sponsored listings. But the advertising based model may be difficult to support when human intelligence is used. While a person may greatly improve response quality, the cost of human effort is typically much higher than the cost of computation.

In a system processing natural language requests automation is frequently applied to determine whether a stored or programmatic response is available. In many systems, a current search query may be compared to a stored and/or template query such as Regular Expressions (RegEx) in order to determine whether a query is suitable for a programmatic response. However, it is not always possible to determine with certainty whether a person is needed to respond to a query, a classification of a query, or other parameters.

A statistical determination may be effective when a large number of queries is used to build a model such as a Bayesian predictor. But it is inevitable that some number of false positives and/or false negatives will occur. If the threshold for a positive determination is low it may cause erroneous answers (false positives) to be provided resulting in poor quality. If the threshold for a negative determination is high queries which could be answered automatically may be directed to a person resulting in unwanted labor and time to respond.

Because of these and other problems a system for disambiguation using human judgment would be greatly appreciated.

A system is provided which includes a query processing server which receives queries, determines an appropriate response, selects a human assistant to respond to the query when needed, and provides a response to the query

Processing a query by the system may be divided into various layers. A first layer may perform automated processing of a query in order to determine whether a human assistant should be utilized to respond to a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use.

A second layer of processing may include use of a human assistant utilizing a toolset to analyze a query to locate an existing response for the query. A third layer of processing may utilize a human assistant who performs a search of resources and may extract a search result from the resources. A fourth layer of processing may utilize a human assistant to review answers provided prior to being delivered as a response to a query.

As the layers of processing are utilized, a decision may be made based on a confidence function associated with a query. A confidence function may be computed in various ways using heuristic, automated learning, Bayesian modeling, and/or other forms of computational processing to select between actions to be taken for a query. In lieu of a binary threshold a multi-level decision threshold may be applied to a confidence function. If a trigger value is not met, an action is taken, if a threshold is met, an operation is executed. If the confidence is between the threshold and the trigger, a human assistant may be requested to make a decision between the action and the operation. Based on a decision by a human assistant the action or the operation may be selected for processing the request.

A system is implemented to allow a user to submit a query and receive a response. A response may include any type of media such as text, URL's, audio, video, etc. A response may be produced automatically and/or using the assistance of a person.

Processing of a query may be divided in to various layers. A first layer may consist of automated processing of the query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use, and may be executed and/or modified based on a human assisted decision process.

A second layer of processing may include a human assistant who makes judgments requiring a limited number of actions. In a preferred embodiment a “referee” or human assistant making a number of constrained decisions may be provided. If a query is processed automatically, a confidence value or decision function is computed regarding the query. For example, a matching function for a user query to a stored query, a category to a query, etc. may be computed. In lieu of a single threshold system which may create undesired effects, a plurality of thresholds may be defined. If a decision function exceeds a first threshold, a first action is taken. If a decision function is below a second threshold, a second action is taken. If a decision function is between the first threshold and the second threshold, a third action is taken.

For example, if a query matches a stored query with a confidence greater than 0.97 a stored result matching the query is provided to a user, if the confidence is less than 0.90, the query is provided to an expediter, and if the confidence is between 0.90 and 0.97 the query and the matching query and answer may be provided to a referee. A referee may be able to make a choice between ‘OK’ and ‘No’ for providing the answer associated with the matching question to the user. In this way, a referee may typically process many queries in a short time. Tasks presented to a referee may require seconds of work, and preferably require a single action such as an utterance, user interface action, etc.

A referee may receive multiple single decision or ‘micro-expedite’ tasks in a given session. For example, a referee might be notified of an available task which consists of ten single decision activities. A referee could be presented with each task and a completion control which might be used to indicate whether the group of ten tasks has been completed.

A third layer of processing of a query may include a human assistant who analyzes a query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. An expediter may find a stored response, compose a free-form response, and/or route a query to a searcher for a response.

A fourth layer of processing of a query may include a human assistant who responds to a query or “searcher”. A searcher may receive information of a query including an interpreted query, information of a source of a query, and be provided with resources for performing a search responsive to a query. A searcher may formulate a response based on an interpreted query, and submit the response responsive to a query.

A referee may operate on various types of items as part of various activities associated with processing of a query. As noted above, a referee may determine whether an automated response is suitable or not based on a confidence value assigned to a match to a query. A referee might review a category assigned to a query, a correction of spelling or grammar, a selection of a named entity, resolution of anaphora or exophora, etc. Any type of automated processing wherein a threshold is applied to make a choice might benefit from use of a referee. As any computational logic can be decomposed into a series of binary decisions, a binary decision can be presented to a referee for judgment.

A referee may receive context information associated with a task. Previous user queries, location information, and/or other relevant information may be provided to enhance decision making. Context may be reduced to avoid distraction. A decision of a referee may be used to refine statistical models. Micro-expedite tasks may be presented in a group and/or may be presented sequentially. For example, when a decision is made for a task, a next task may be requested and/or provided.

By using a human assistant to provide a constrained judgment of a decision which is determined to be ambiguous by automated processing, quality of responses may be improved while labor and time required to respond may be optimized. As an amount of labor required to perform a constrained judgment task is small the added human labor is offset by a decreased need for a more sophisticated human assistant to manage queries which can receive an automated response.

As used herein, a “request” means a request for information, products, and/or services. A request or search request or query may include various types of media, and may be provided by any user system which may establish communication with a server and/or other devices associated with a search service. A request may be referred to as a “search request”, “search query”, or “query”.

A “user” is any person who submits a request and may receive any type of information responsive to a request. A user may be any person or entity. A “guide” is a person who assists in processing a request. A guide may be referred to as a “provider”, “searcher”, “human searcher”, “expediter”, “transcriber”, “specialist”, “referee”, “vetter” or “generalist”. Guides may be assigned various roles. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who processes a request using a toolset including a limited number of options may be referred to as a “vetter” or “referee”. A guide who performs a search for queries regardless of category may be referred to as a generalist. Any guide may perform any role. A guide may preform roles such as translation, recognition, etc.

An “advertiser” is any person and/or entity which may provide promotional information or “advertisements” to be delivered to a user. An advertisement may take various forms and/or may include media of any sort which can be delivered to a user device. A “result”, “response”, “answer”, “reply”, or “search result” is any information which has been determined to be a response to a request. A result may include an advertisement. A result may be any information which is determined to be a response to a request. A “resource” or “search resource” may be any source of information which may provide a search result. A resource may include a search engine, a web server, a software application, an API, printed media, an RSS feed, streaming media, a web page, etc. A “profile” may be any information associated with a person such as demographic data, geographic data, personality data, affiliations, etc. An affiliation may be any sort of connection between persons and/or institutions and/or entities.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, regular mail and/or any other suitable type of communication. A connection or communication session may be established using any hardware device which is capable of utilizing a communication service. For example, a wireless device such as a cell phone, PDA, smart phone, etc., might be used to establish a communication session using voice, SMS, IM, email and/or internet protocols. A desktop, laptop or hardware server system might be used to establish a communication session using IM, email, SMS, MMS, etc. A landline phone, a specialized communication terminal, and/or any other communication apparatus might be used to establish a communication session.

Communication between a user, a guide and/or a search system may include conversion of text to speech and speech to text. Any type of media which can be sent and/or received using a communication system may be part of a communication session. A communication session may be conducted using any or all communication services associated with a user, a guide, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, and/or a request may be rated. Rating information may be obtained from a user, a guide, and/or a system administrator. Rating information may be used to select a user, a guide, a request, a result, and/or any item based on information associated with an item indicated in a database. A search service may be compensated by advertising revenue. Advertising and/or content may be delivered to a user and/or a guide using any communication service associated with a user and/or a guide.

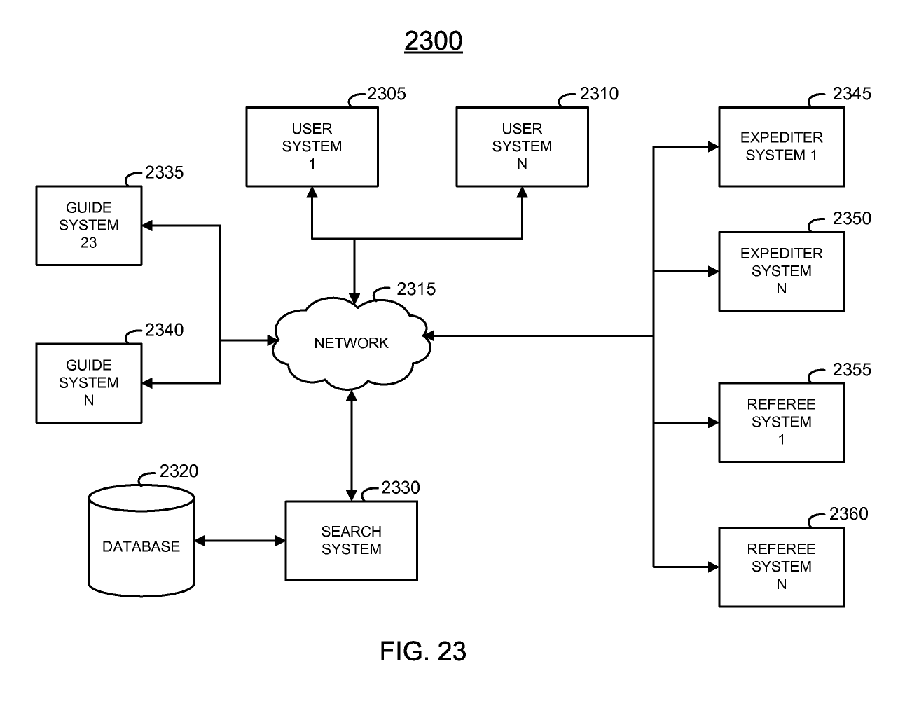

As illustrated in FIG. 23, a system 2300 includes user systems 2305, 2310, a network 2315 such as the Internet, a search system 2330, a database 2320, which may comprise various records, guide systems 2335, 2340, expediter systems 2345, 2350, and referee systems 2355, 2360.

While only a few systems associated with a user, an expediter, a referee, and a guide are depicted in FIG. 23 it is within the scope of the disclosure for multiple systems for a user, expediter, referee, and guide to be utilized. In particular it is envisioned that many user, expediter, referee and guide systems may be implemented. A search system may be a composed of many components as described further herein.

Any user system (e.g. the user system 2305) can be used, to submit a request to the search system 2330 and/or receive a result and/or other information. Any user system may receive a response, and/or may provide compensation to the search system 2330.

The network 2315 may be a global public network of networks (i.e., the Internet) and/or may consist in whole or in part of one or more private networks and communicatively couples the user systems 2305, 2310, the guide systems 2335, 2340, the expediter systems 2345, 2350, and the referee systems 2355, 2360 with the other components of the system 2300 such as the search system 2330, and the database 2320. The network 2315 may include one or more wireless networks which may enable wireless communication between the various elements of the system 2300. For example, the search system 2330 may receive messages which may be routed via a wireless network controlled by a wireless service to the user systems 2305, 2310. A wireless service may receive messages from the guide systems 2335, 2340 via a wireless network which is a part of the network 2315, and provide the messages to the search system 2330 via an internet connection which is part of the network 2315. Similarly a voice communication via wired and/or wireless communication might be established between any elements of the system 2300.

The search system 2330 allows interaction to occur among the user systems 2305, 2310, the guide systems 2335, 2340, the expediter systems 2345, 2350, and the referee systems 2355, 2360. For example, a request can be transmitted from the user system 2305 to the search system 2330, which may provide information obtained from the database 2320, which may include an advertisement provided by an advertiser to the user system 2305. Similarly, a search result from a searcher operating the guide system 2335 and/or an expediter operating the expediter system 2345 might be routed to the search system 2330, which might process the response and provide a message to the user system 2305. Any type of communication between users, expediters, referees and/or guides may be mediated and/or facilitated by the search system 2330, and/or other elements of the system 2300.

The search system 2330 is communicatively coupled with the database 2320. As will be described herein in further detail below, the database 2320 includes data that is processed in association with operation of the embodiments. Although FIG. 23 illustrates the database 2320 as a separate component of the system, the database 2320 may be integrated with the search system 2330. Further, the records maintained in the database 2320 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server and/or computer. Elements of the database 2320 may reside in any suitable elements of the system 2300. Any or all elements of the system 2300 may include any or the entirety of the database 2320.

The user systems 2305, 2310, the guide systems 2335, 2340, the expediter systems 2345, 2350, the referee systems 2355, 2360 and the search system 2330 may include equipment, software, systems and personnel required to send and/or receive messages between the user system 2305, 2310, the guide systems 2335, 2340, the expediter systems 2345, 2350, the referee systems 2355, 2360 and/or the search system 2330 using the network 2315. The database 2320 includes information which may allow the search system 2330 to establish communication between any or all of the elements of the system 2300.

A user system, a guide system, a referee system, an expediter system and/or a search system may be a desktop or portable PC or Mac®, a mobile phone, a smart phone, a PDA, a server system, a landline phone, a specialized communication terminal, a terminal connected to a mainframe, or any other communication apparatus and/or system with the required capabilities. The search system 2330 may include one or more servers, computers, etc. For example, servers such as the PowerEdge® 2900 by Dell, or the BladeCenterJS22 by IBM, or equivalent systems might be used to implement elements of the search system 2330. The search system 2330 may utilize an operating system (OS) such as Microsoft Windows XP®, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, referee systems, expediter systems and/or to implement the search system 2330.

A user may be identified by the search system 2330. When a user system, such as the user system 2305, establishes a communication session with the search system 2330, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 2305 and an expediter system, a referee system, a guide system and/or the search system 2330. Information such as a keyword, a category, a profile, a request, a result, an advertisement, etc., may be associated with a user. A user may be required to provide profile information to the search system 2330. Information of a user may be stored in the database 2320.

A guide may be required to register with the search system 2330. As part of a registration process, at least one communication method is associated with a guide. In at least one embodiment, a guide may register with the search system 2330 and establish a username and password which are associated with the guide. A guide may login to the search system 2330 using a web browser functionality of the guide system 2335 in order to communicate with the search system 2330. Multiple communication services may be associated with a guide and may allow a communication session to be established between a guide system such as the guide system 2335 and a user system, a referee system, an expediter system, and/or the search system 2330. Multiple identifiers of a guide may be associated with each other. Information such as IM credentials, an email address, a phone number, a URL, a username, etc., of a guide may be identified which may allow the search system 2330 to establish a communication session between a guide system and a user system a referee system, an expediter system, and/or the search system 2330.

When a guide registers with the search system 2330 the guide may be associated with one or more keywords, categories, and/or other information. Information associated with a guide may be stored in the database 2320 and may be used for various purposes. Information associated with a guide may be used to rank requests, resources, results, advertisements and/or other information which may be presented to the guide. A ranking of a guide based on ratings associated with an item associated with a request may be used to select a guide. A guide may be selected on a first available basis. In at least one embodiment, payment information is associated with a guide. In at least one embodiment, a guide may be required to undergo testing to determine whether a guide is able to perform any tasks which may be required by an operator of the search system 2330. For example, a guide may be assigned to a role such as translator, transcriber, expediter, generalist, specialist, referee, etc. A guide may be assigned to a specific role, and/or may be able to be associated with multiple roles. A guide may be a paid searcher, may be a volunteer, and/or may be a user electing to respond to a request.

Records may be maintained in the database 2320 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein. An item may be any real and/or virtual object which may be tracked and/or represented by information included in a database such as the database 2320.

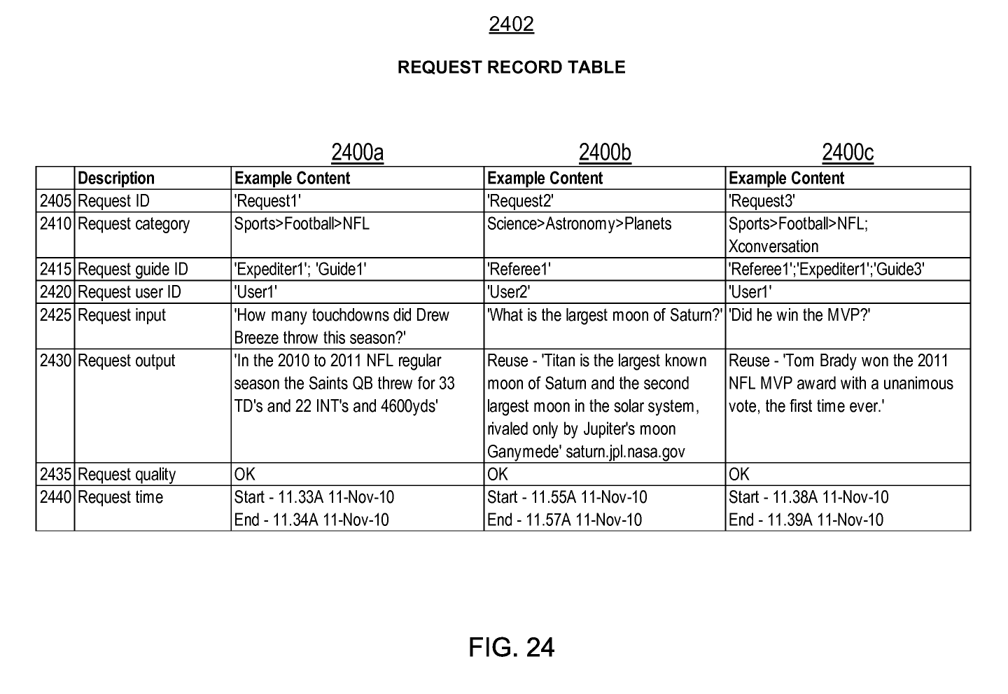

An exemplary request record table 2402 is illustrated in FIG. 24. The request table 2402 may comprise a number of request records 2400 of which one or more may be associated with or resident in the database 2320 (FIG. 23) is provided. The request record table 2402 may include information of requests which may be processed. The request records 2400 may include a request ID field 2405, a request category field 2410, a request guide ID field 2415, a request user ID field 2420, a request input field 2425, a request output field 2430, a request quality field 2435, and a request time information field 2440.

The request ID field 2405 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 2405. In at least one embodiment, a random number is indicated in the request ID field 2405. Using the example in FIG. 24, ‘Request1’ is the request ID associated with the request record 2400a.

The request category field 2410 may include information of a category associated with a request. Information indicated in the request category field 2410 may be used to select an item associated with a request. For example, a category associated with a request may be used to rank guides who may be associated with the category. Likewise, a category associated with a request may be used to rank requests which may be presented to a referee. A category associated with a request may be determined based on factors such as keywords of the query, a profile of a user, a selection of a guide, etc. A category associated with a system taxonomy may be indicated in the request category field 2410. A category may be associated with a request automatically and/or using the assistance of a person. In at least one embodiment, a category may be associated with a request based on a decision by a referee. Using the example in FIG. 24, ‘Request2’ may be categorized as ‘Science>Astronomy>Planets’ as indicated in the request record 2400b. This may indicate that a person or item associated with the category ‘Science>Astronomy>Planets’ may have a higher ranking for responding to ‘Request2’. A category of a request may be associated with a user submitting the request. Similarly, ‘Request3’ is associated with the categories ‘Sports>Football>NFL’ and ‘XConversation’, which may indicate that a referee or guide has selected the category ‘Sports>Football>NFL’ and excluded the category ‘Conversation’ for ‘Request3’ as indicated in the request record 2400c.

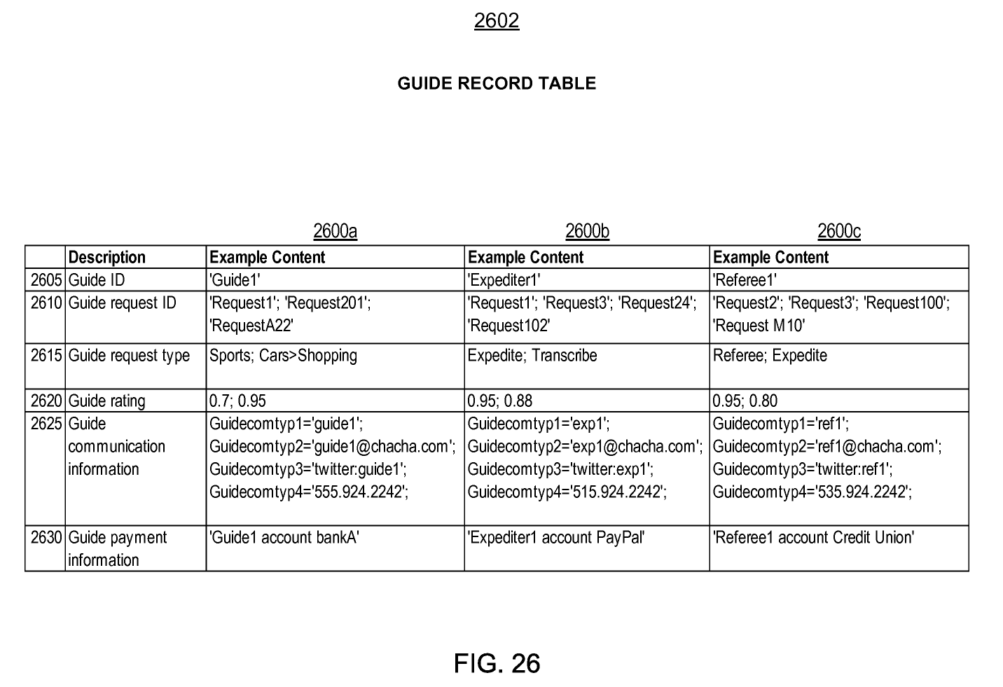

The request guide ID field 2415 may include information of a number of guides associated with a request. Content of the request guide ID field 2415 may be used to obtain information of a guide using a record such as the guide record 2600a (FIG. 26). If a person is selected for a request, elects to receive a request, provides a response to a request, reviews a result of a request and/or completes a request, an identifier of the person may be indicated in the request guide ID field 2415. Using the example in FIG. 24, ‘Expediter1’ and ‘Guide1’ are associated with ‘Request1’. This may for example indicate that ‘Request1’ has been processed by ‘Expediter1’ and completed by ‘Guide1’. Likewise, the query ‘Request2’ indicated in the request record 2400b may have been processed using the assistance of ‘Referee1’. Similarly ‘Request3’ is associated with ‘Referee1’, ‘Expediter1’, and ‘Guide3’. This may for example indicate that ‘Referee1’ determined a category of ‘Request1’, and ‘Expediter1’ selected a previous search result provided by ‘Guide3’ to respond to the ‘Request1’.

The request user ID field 2420 may include information of a number of users associated with a request. Content of the request user ID field 2420 may be used to obtain information of a user associated with a request. For example, if a request is submitted by a user, an identifier of the user may be indicated in the request user ID field 2420. A request may not be associated with a user request. For example, the search system 2330 (FIG. 23) may provide requests to guides which are not directly related to a user request. Using the example in FIG. 24, ‘User1’ is associated with ‘Request1’ and ‘Request3’ while ‘User2’ is associated with ‘Request2’. This may indicate that ‘Request1’ and ‘Request3’ were submitted by ‘User1’ while ‘Request2’ was submitted by ‘User2’.

The request input field 2425 may include information of a request. Content of the request input field 2425 may be provided to a person who accepts a request. Content of the request input field 2425 may include any type of information. For example, a pointer to audio, video, text, and/or other media may be indicated in the request input field 2425. As illustrated in FIG. 24, the query ‘How many touchdowns did Drew Breeze throw this season?’ is the request input associated with ‘Request1’. In at least one embodiment, the request input field 2425 may indicate an original user request, a categorization, and a rewritten user request.

The request output field 2430 may include information of a response associated with a request. Content indicated in the request output field 2430 may be provided to a user responsive to a request. Content of the request output field 2430 may be stored in the database 2320 (FIG. 23). Content of the request output field 2430 may be reviewed by a user, a guide, and/or an administrator. As illustrated in FIG. 24, the response ‘Tom Brady won the 2011 NFL MVP award with a unanimous vote, the first time ever.’ is associated with ‘Request3’ as illustrated in the request record 2400c. While a text response to a query is used for the purposes of illustration, any type of media may be indicated in the request output field 2430. In at least one embodiment, a text response and a URL associated with a source of the text response may be indicated in the request output field 2430.

The request quality field 2435 may include information of a quality rating associated with a request. Content of the request quality field 2435 may affect compensation provided and/or a rating and/or ranking of an item such as a guide, a response, etc. For example, if a guide achieves a specified level of quality performance, additional points may be credited to the guide. A quality rating may be any type of indication, such as a flag, a numeric value, etc. Content of the request quality field 2435 may be produced automatically and/or using the assistance of a person. For example, a confirmation and/or rejection of a response by a referee may be used to determine content of the request quality field 2435. Using the example in FIG. 24, the quality flag ‘OK’ is associated with all the request records 2400, which may indicate that ‘Request1’, ‘Request2’, and ‘Request3’ have passed a quality check. In at least one embodiment, multiple responses may be associated with a request as indicated in the request output field 2430, which may be linked to a quality rating in the request quality field 2435. For example, a plurality of possible responses may be associated with a request, and a referee may select between the possible responses. A selection of a referee may be recorded in the request quality field 2435 which may affect a rating or ranking of a response, a guide, etc.

The request time field 2440 may include temporal information associated with a request. Content of the request time field 2440 may be used for various purposes. For example, completion time of a request may be used to determine a period associated with compensation for completing the request. Temporal or time information associated with a request may be used to determine a rating of the request. For example, if a guide is taking a longer or shorter time than other guides for completing a request, a rating of the guide may be adjusted. Time information associated with a request may be used to select a guide. For example, a referee who has processed requests more rapidly may be more likely to receive a task associated with a request.

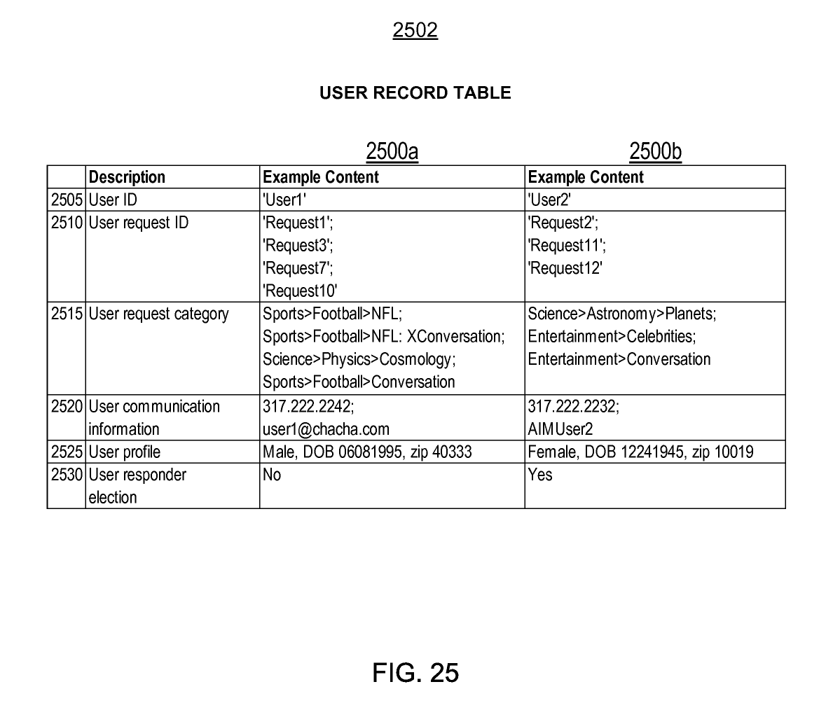

An exemplary user record table 2502 is illustrated in FIG. 25. The user table 2502 may comprise a number of user records 2500 of which one or more may be associated with or resident in the database 2320 (FIG. 23) is provided. The user record table 2502 may include information of users. The user records 2500 may include a user ID field 2505, a user request ID field 2510, a user request category field 2515, a user communication information field 2520, a user profile field 2525, and a user responder election field 2530.

The user ID field 2505 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 2505. Using the example in FIG. 25, ‘User1’ is the user ID associated with the user record 2500a.

The user request ID field 2510 may include information of a number of requests associated with a user. A user request ID may be for example a pointer to a request record associated with a request submitted by a user. If a user submits a request, a request ID may be added to the user request ID field 2510. Using the example illustrated in FIG. 25, ‘Request2’ ‘Request11’ and ‘Request12’ are associated with ‘User2’ as indicated in the user record 2500b. This may indicate that ‘User2’ has submitted ‘Request2’ and ‘Request11’ and ‘Request12’.

The user request category field 2515 may include information regarding a category or type associated with a user request. For example, if a request is directed to a type of processing, a category, etc. a type and/or category associated with the processing may be indicated in the user category type field 2515. In at least one embodiment, the user request ID field 2510 and the request user category field 2515 are linked by for example a pointer. Information of a category associated with a previous request may be used to associate a category with a current request. For example, keywords associated with particular categories may be used to determine a most probable category for a query based on content of the query. A referee may provide information used to assign a category to a request.

The user communication information field 2520 may include information of a number of communication services associated with a user. Any information which may be used to establish communication with a user may be indicated in the user communication information field 2520. For example, a telephone number, an email address, an IM credential, a URL, a username, a password, and/or other communication information may be indicated in the user communication information field 2520. Using the example in FIG. 25, the phone number ‘317.222.2242’ and the email ‘user1@chacha.com’ are associated with ‘User1’.

The user profile field 2525 may include information of a profile associated with a user. For example, demographic, geographic, affiliation, personality, and/or other types of information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 25, ‘Female, DOB Dec. 24, 1945, zip 10019’ are associated with ‘User2’. Profile information may be used to match information provided by a user to other information. For example, a ranking of a guide for a query of a user may be adjusted based on a profile associated with the user.

The user responder election field 2530 may include information of a type of query a user is willing to accept. For example, if a user elects to receive queries which are associated with sports this may be indicated in the user responder election field 2530. In at least one embodiment, a user may be able to elect to receive queries filtered for content, topic, keyword, location, etc. As illustrated in FIG. 25, ‘User2’ has elected to respond to requests. For example, ‘User2’ might act in a guide role such as referee, expediter, searcher, etc.

An exemplary guide record table 2602 is illustrated in FIG. 26. The guide table 2602 may comprise a number of guide records 2600 of which one or more may be associated with or resident in the database 2320 (FIG. 23) is provided. The guide record table 2602 (FIG. 26) may include information of guides. The guide records 2600 may include a guide ID field 2605, a guide request ID field 2610, a guide request type field 2615, a guide rating field 2620, a guide communication information field 2625, and a guide payment information field 2630.

The guide ID field 2605 includes an identifier of a guide which is preferably unique and is preferably used consistently. A guide ID serves to distinguish a guide record associated with a guide from a guide record associated with other guides. Any number of characters, numbers, and/or other indicators may be used to indicate a guide ID. In at least one embodiment, a random number is indicated in the guide ID field 2605. In at least one embodiment, a pseudonym selected by a guide may be indicated in the guide ID field 2605. Using the example in FIG. 26, ‘Guide1’ is the guide ID associated with the guide record 2600a.

The guide request ID field 2610 may include information of a number of requests associated with a guide. Content of the guide request ID field 2610 may be used to obtain information of a request. For example, if a user request has been determined to require a number of tasks to be performed, the search system 2330 (FIG. 1) may assign a unique ID to the requests and may distribute information of the requests to guides. Using the example in FIG. 26, ‘Request1’, ‘Request3’, ‘Request24’ and ‘Request102’ are associated with ‘Expediter1’ as indicated in the guide record 2600b. This may indicate that ‘Expediter1’ has expedited ‘Request1’, ‘Request3’, ‘Request24’ and ‘Request102’.

The guide request type field 2615 may include information of a number of types of requests which may be processed by a guide. For example, a category and/or keyword associated with a request, a type of request, temporal information associated with a request, etc., which may be used to determine if a guide is to be presented with a request may be indicated in the guide request type field 2615. In at least one embodiment, a guide may be assigned to a particular type of request as part of a registration process. A guide may select a type of request which the guide may perform. A guide may be required to pass a test in order to be associated with a type of request. Using the example in FIG. 26, ‘Guide1’ is associated with ‘Sports’ and ‘Cars>Shopping’, which may for example indicate that ‘Guide1’ may be presented with and/or select requests associated with a search for information associated with ‘Sports’ and ‘Cars>Shopping’.

The guide rating field 2620 may include information of a number of ratings associated with a guide. For example, quality, speed, peer review, etc., may be used to determine a rating of a guide. A rating of a guide may be used for purposes such as determining compensation for the guide, selecting a guide to respond to a request, matching a request to a guide, etc. In at least one embodiment, the guide request type field 2615 and the guide rating field 2620 may be linked by, for example, a pointer. Using the example in FIG. 26, ‘Expediter1’ has a rating of ‘0.95’ associated with ‘Expedite’, and a rating of ‘0.88’ associated with ‘Transcribe’ which may be used to rank ‘Expediter1’ versus other guides associated with the request types ‘Expedite’ and ‘Transcribe’. For example, ‘Expediter1’ might be more likely to receive an ‘Expedite’ task than ‘Referee1’.

The guide communication information field 2625 may include information of a number of communication services associated with a guide. For example, a user name and password, an email address, an IM credential, a phone number, a web page, a physical address, etc., may be indicated in the guide communication information field 2625. Using the example illustrated in FIG. 26, ‘Guide1’ is associated with the login ID ‘guide1’, the email ‘guide1@chacha.com’, the Twitter® ID ‘guide1’ and the phone number ‘555.924.2242’. This may indicated that ‘Guide1’ may be contacted using the associated communication services.

The guide payment information field 2630 may include information of a payment method associated with a guide. For example, banking information, a PayPal® account, a Western Union® account, etc., may be indicated in the guide payment information field 2630. Content of the guide payment information field 2630 may be used to provide compensation to a guide. For example, payment may be made by Automated Clearing House (ACH), wire transfer, etc., using information indicated in the guide payment information field 2630.

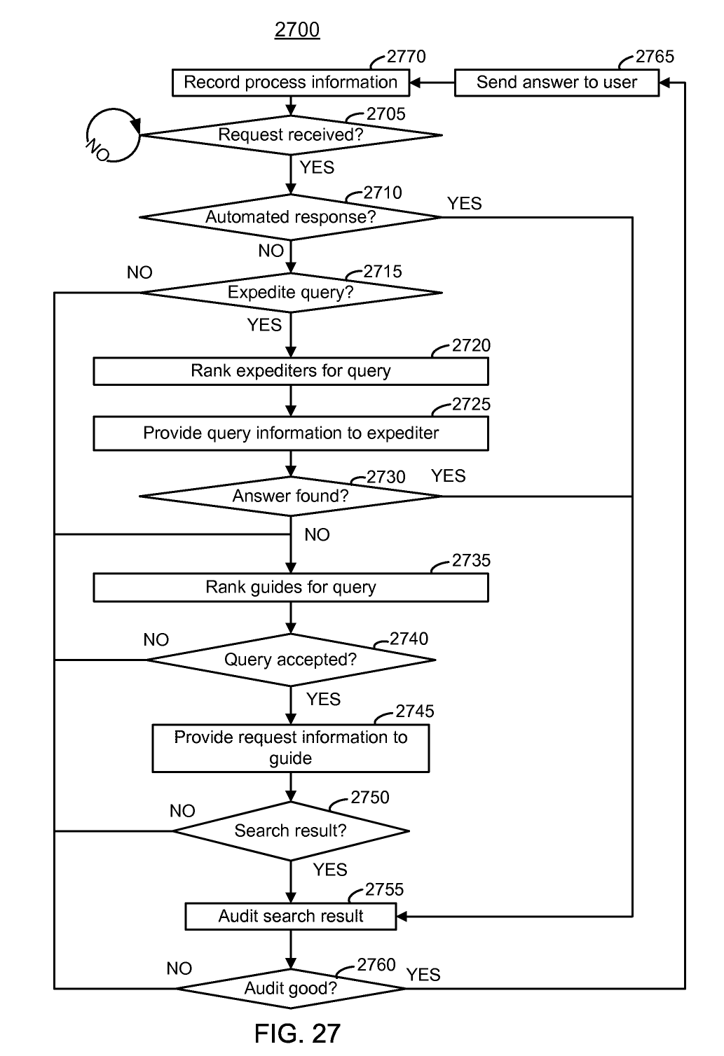

As illustrated in FIG. 27, a process 2700 for responding to a request is provided. The process 2700 may be performed in whole or in part by any suitable element of the system 2300 (FIG. 23). In at least one embodiment, the process 2700 is operative on a server associated with the search system 2330.

In operation 2705 (FIG. 27) a determination is made as to whether a request is received. If it is determined in operation 2705 that a request is not received, control remains at operation 2705 and process 2700 continues. If it is determined in operation 2705 that a request is received, control is passed to operation 2710 and process 2700 continues.

The determination in operation 2705 may be made using various criteria. In at least one embodiment, if a message is received at a system associated with the search system 2330 (FIG. 1), it may be determined that a request is received. For example, if an email message, an SMS, EMS, and/or MMS message, an IM, an IP message, and/or a voice message is received at an address associated with the search system 2330, it may be determined that a request is received. In at least one embodiment, if a message is received at a server associated with the search system 2330, it may be determined that a request is received.

In operation 2710 (FIG. 27) a determination is made as to whether an automated response is acceptable. If it is determined in operation 2710 that an automated response is acceptable, control is passed to operation 2755 and process 2700 continues. If it is determined in operation 2710 that an automated response is not acceptable, control is passed to operation 2715 and process 2700 continues.

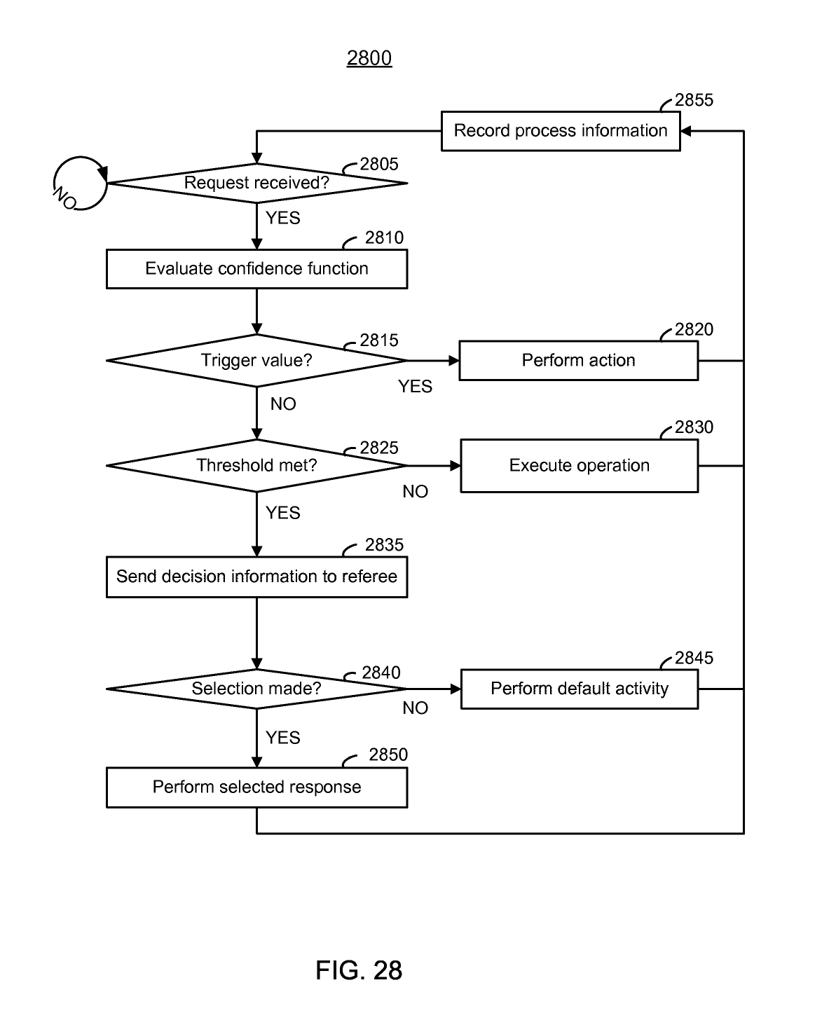

The determination in operation 2710 may be made in various ways. For example, a query may be compared to a template, a Regular Expression (RegEx) expression, a historical query, etc. in order to determine whether an automated response is acceptable. An automated response may be any response that is produced by sending a query to a system which retrieves information without intervention by a person. For example, a search engine, an RSS feed, a database look-up of a query, a program resident on a computer system and/or other programmatic system for retrieving information may provide an automated response. The determination in operation 2710 may be made using the assistance of a guide such as a referee as further described with respect to FIG. 28.

In operation 2715 a determination is made as to whether a query is to be expedited. If it is determined in operation 2715 that a query is to be expedited, control is passed to operation 2720 and process 2700 continues. If it is determined in operation 2715 that a query is not to be expedited, control is passed to operation 2735 and process 2700 continues.

The determination in operation 2715 may be made according to various criteria. A number of available expediters, a confidence factor associated with categorization and/or classification of a query, a number and type of responders and/or guides available may be used to determine whether a query is to be expedited. Levels of activity and/or temporal information may be used to determine whether a query is to be expedited. In at least one embodiment, all queries are expedited. A guide (e.g. a referee) may assist in the determination in operation 2715.

In operation 2720 expediters are ranked for a query. In at least one embodiment, a first available expediter may be a highest ranked expediter. In at least one embodiment, a user may be ranked as an expediter. An expediter may be ranked based on a type, category, rating, profile, etc. which may be associated with a request. Control is passed to operation 2725 and process 2700 continues.

In operation 2725, information of a query is provided to an expediter. An expediter may select a previous query and/or answer, compose a query to be submitted to a database or search engine, reclassify a query, reformulate a query, may direct a query to a guide, etc. An expediter may be presented with a ranked list of previous queries, a plurality of database access interfaces, historical and context information associated with a query, and/or a free-form query response interface, etc. A referee may act as an expediter. Control is passed to operation 2730 and process 2700 continues.

In operation 2730, a determination is made as to whether an answer is found. If in operation 2730 it is determined that an answer is found, control is passed to operation 2755 and process 2700 continues. If in operation 2730 it is determined that an answer is not found, control is passed to operation 2735 and process 2700 continues.

The determination in operation 2730 may be made based on various criteria. If an expediter selects a response based on a previous query, confirms a query can be answered programmatically, indicates that a query must be searched, fails to respond, responds in agreement with other expediters, etc. it may be determined that an answer is found. A referee may assist in the determination in operation 2730

In operation 2735, guides are ranked for a query. A guide may be ranked based on any suitable criteria such as response time, historical activity, percentage and/or number of results, notifications accepted, results accepted, categories and/or keywords associated with a guide, temporal information, a profile, etc. Similarly, a guide who has responded to and/or accepted a high percentage of notifications or requests may be ranked higher. A quality rating of a guide may be used to rank a guide. Control is passed to operation 2740 and process 2700 continues.

In operation 2740, a determination is made as to whether a query is accepted. If in operation 2740 it is determined that a query is not accepted, control is passed to operation 2735 and process 2700 continues. If in operation 2740 it is determined that a query is accepted, control is passed to operation 2745 and process 2700 continues.

The determination in operation 2745 may be made based on various criteria. In at least one embodiment, activation of a control responsive to a notification of an available query may be used to determine whether a query is accepted. In at least one embodiment, if a guide does not accept a query within a pre-determined time period, it may be determined that a query is not accepted, and a ranking of the guide may be lowered.

In operation 2745, information of a request is provided to a guide. In at least one embodiment, a first guide to accept a request is provided with the information of the request. A guide may be provided with access to search resources which may assist the guide to perform a search. A guide may be notified of a request in an order based on a ranking of the guide. A guide may perform an information search to obtain a search result. Control is passed to operation 2750 and process 2700 continues.

In operation 2750, a determination is made as to whether a search result is received. If in operation 2750 it is determined that a search result is received, control is passed to operation 2755 and process 2700 continues. If in operation 2750 it is determined that a search result is not received, control is passed to operation 2735 and process 2700 continues.

The determination in operation 2750 may be made based on various criteria. For example, if a time limit expires it may be determined that a search result is not received. If a searcher responds with a search result, it may be determined that a search result is received.

In operation 2755, a search result is audited. For example, a guide may be presented with information of a query and a search result, which may be reviewed by the guide for quality purposes. In at least one embodiment, the audit operation is optional. In at least one embodiment, a referee may review a search result. In at least one embodiment, a confidence function associated with a request and a search result may be evaluated. An audit may be performed based on any suitable criteria. An audit may be performed based on statistical sampling, a user and/or guide, a query, a confidence function and/or value, etc. Control is passed to operation 2760 and process 2700 continues

In operation 2760, a determination is made as to whether an audit is good. If in operation 2760 it is determined that an audit is good, control is passed to operation 2765 and process 2700 continues. If in operation 2760 it is determined that an audit is not good, control is passed to operation 2735 and process 2700 continues.

The determination in operation 2760 may be made based on various criteria. In at least one embodiment, a referee may assist with the determination in operation 2760. For example, a referee may be provided with information of a request and a search result and may make a decision which is used to determine whether an audit is good. In at least one embodiment, the audit is always good. In at least one embodiment, a value of a confidence function associated with a request is used to determine whether an audit is good.

In operation 2765, an answer is sent to a user. An answer may be delivered to a user via any communication service associated with the user. An answer may include any media which may be delivered using a communication service and/or a device of the user. For example, an SMS message might be delivered to a user mobile device. Any number of responses may be delivered to a user as any or all of an answer. Control is passed to operation 2770 and process 2700 continues

In operation 2770, process information is recorded. Any information regarding a user, a guide, a referee, a result, an expediter, a request, a resource, an advertisement, a profile, etc. may be recorded and/or updated. For example, a rating may be adjusted, a keyword, category, type, guide, referee, expediter, time, user, answer, number of responders, number of responses, quality of responses, etc. of a request may be recorded. In at least one embodiment, process information is recorded in the database 2320 (FIG. 23). Control is passed to operation 2705 and process 2700 continues.

As illustrated in FIG. 28, a process 2800 making a determination using assistance from a guide is provided. The process is illustrated using a few options and a few decision points for the purposes of explanation. However it will be immediately obvious to one of ordinary skill in the relevant art that any number of operations, activities, and judgment criteria may be applied within the spirit and scope of the embodiments herein. The process 2800 may be performed in whole or in part by any suitable element of the system 2300 (FIG. 23). In at least one embodiment, the process 2800 is operative on a server associated with the search system 2330.

In operation 2805 (FIG. 28) a determination is made as to whether a request is received. If it is determined in operation 2805 that a request is not received, control remains at operation 2805 and process 2800 continues. If it is determined in operation 2805 that a request is received, control is passed to operation 2810 and process 2800 continues.

The determination in operation 2805 may be made using various criteria. A request may be a request received from a user. In at least one embodiment, if a message is received at a server associated with the search system 2330 (FIG. 23), it may be determined that a request is received. For example, if an email message, an SMS, EMS, and/or MMS message, an IM, an IP message, and/or a voice message is received at an address associated with the search system 2330, it may be determined that a request is received. In at least one embodiment, if a message is received at a server associated with the search system 2330, it may be determined that a request is received.

In operation 2810 a confidence function is evaluated. A confidence function may be any arbitrary function which indicates a probability of a particular event. For example, a confidence function may be associated with a matching of a query to a category, a matching of a query to another query, a likelihood that a query is of a particular type, a likelihood that a search result is a match to a request, etc. The determinations made in operation 2710, 2715, 2730, 2740, 2750, and 2760 (FIG. 27) might be made based on any number of confidence functions. A confidence function may be continuous, discontinuous, stochastic, etc. A confidence function may be based on any suitable mathematical representation of a decision. Control is passed to operation 2815 and process 2800 continues.

In operation 2815, a determination is made as to whether a trigger value is achieved. If in operation 2815, it is determined that a trigger value is achieved, control is passed to operation 2820 and process 2800 continues. If in operation 2815 it is determined that a trigger value is not achieved, control is passed to operation 2825 and process 2800 continues.

The determination in operation 2815 may be made based on various criteria. In at least one embodiment, a trigger value or threshold is a level which will trigger an automated response if a confidence function exceeds the threshold. A trigger value or threshold may be determined as a static value, may be determined based on a type of decision and/or confidence function, may be adjusted based on system conditions such as loading, time of day, etc.

In operation 2820 an action is performed. For example, if it is very likely that an automated response is suitable, the automated response may be provided. An action may include a human assisted activity. For example, if it is determined that a search by a human searcher is very likely to be required, a query may be directed to a searcher without employing an expediter. Control is passed to operation 2855 and process 2800 continues.

In operation 2825, a determination is made as to whether a threshold is met. If in operation 2825, it is determined that a threshold is not met, control is passed to operation 2830 and process 2800 continues. If in operation 2825 it is determined that a threshold is met, control is passed to operation 2835 and process 2800 continues.

The determination in operation 2825 may be made based on various criteria. For example, if it is very unlikely that an automated response is acceptable, a request may be routed to a searcher such as a guide and/or expediter rather than being routed to a referee. A threshold may be determined as a static value, may be determined based on inputs available to a confidence function, may be adjusted based on system conditions such as availability of guides, types of queries, expected quality functions of various types of requests, etc. For example, if a user is paying directly for a response, a higher certainty may be required for a particular action, or if there is a scarcity of a particular type of guide, a decision threshold which would direct a query to that type of guide may be adjusted while the scarcity persists.

In operation 2830 an operation is executed. For example, if it is very unlikely that an automated response is suitable, a human assistant may be selected to respond to a query. An action associated with a threshold may include an automated activity. For example, if it is determined that a search result is unlikely to be offensive, the search result may pass an audit without human review. Any type of activity may be performed based on a trigger value and/or a threshold as determined to be suitable based on a confidence function and/or a logical decision associated with a confidence function. Control is passed to operation 2855 and process 2800 continues.

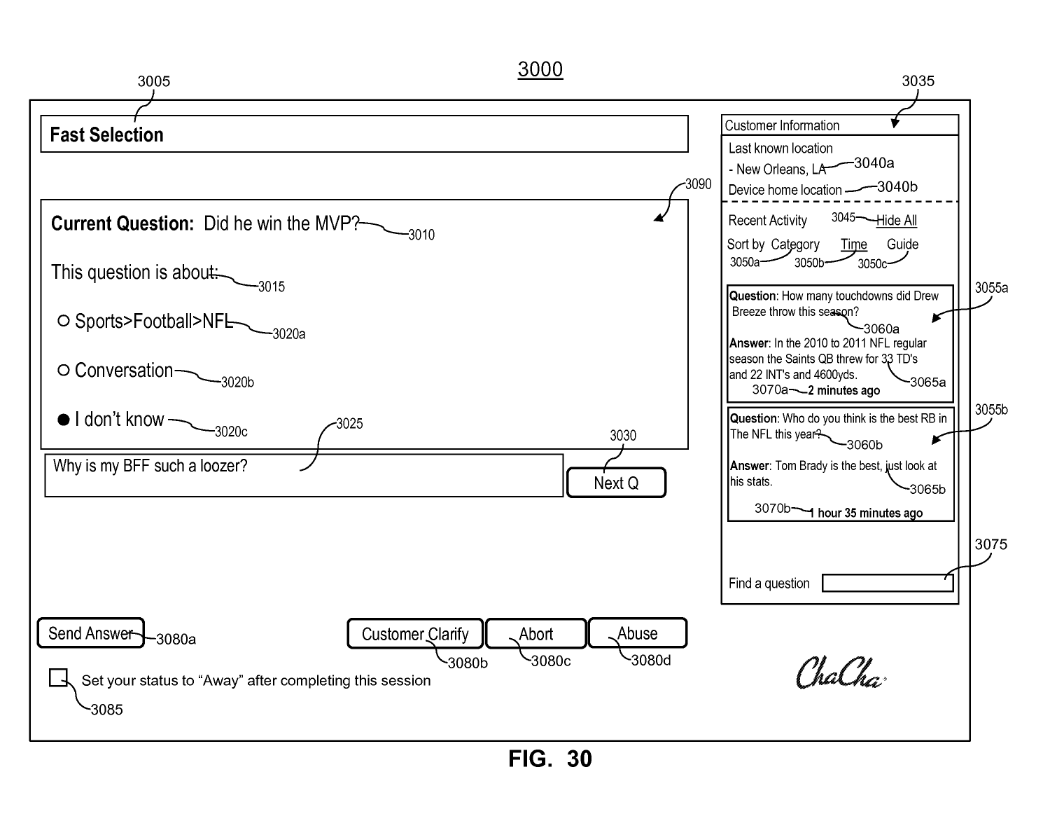

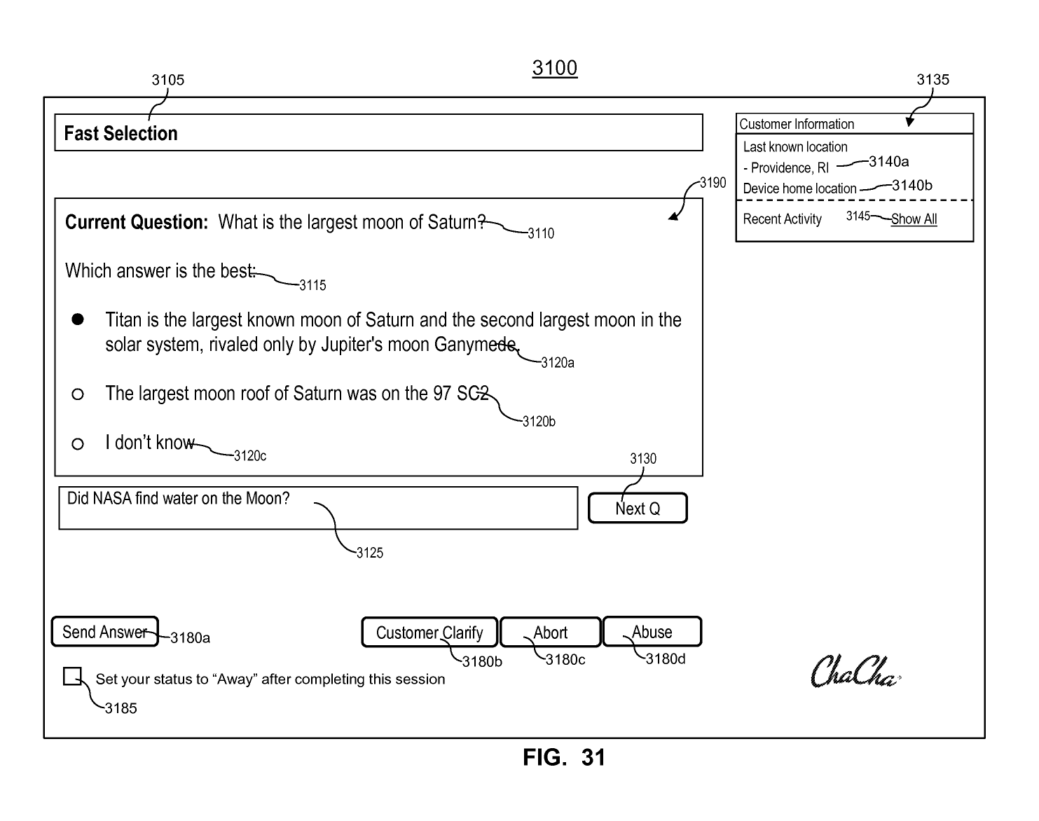

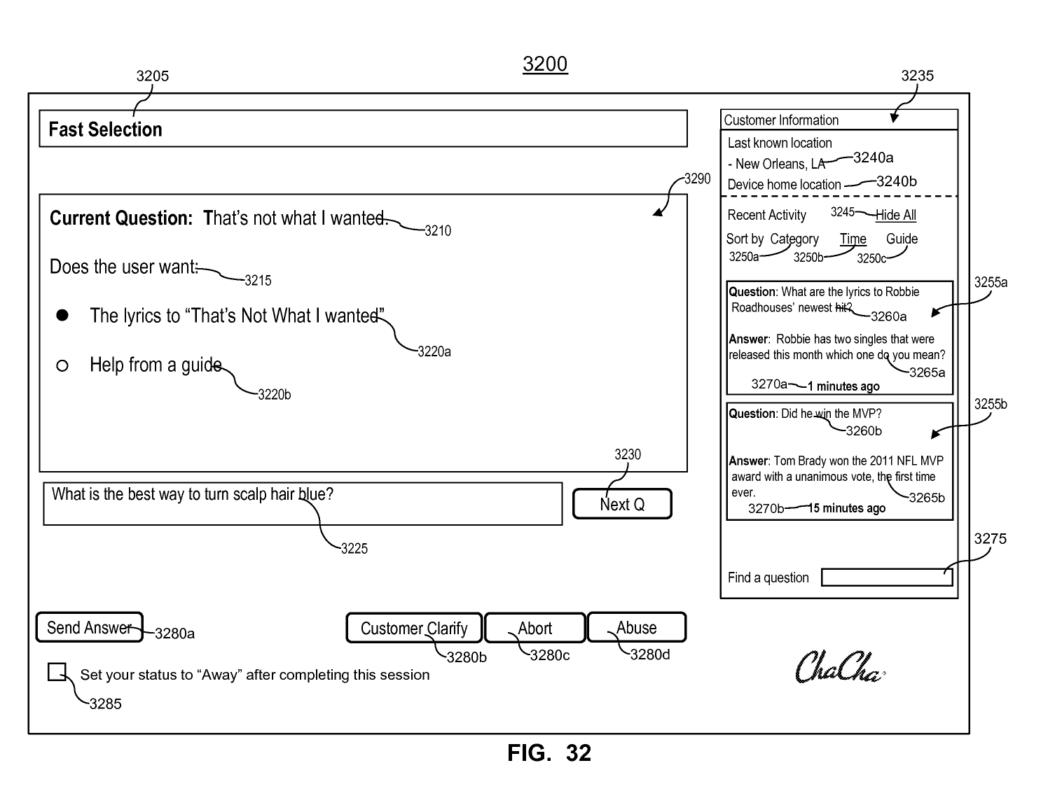

In operation 2835 decision information is sent to a referee. As the confidence function is between the trigger value and the threshold, the decision associated with the confidence function can be considered to be ambiguous. A referee may receive various types of information which are relevant to a request. For example, context information which may be available in order to make a decision may be provided. Exemplary interfaces for a referee are illustrated in FIG. 30, FIG. 31, and FIG. 32. Control is passed to operation 2840 and process 2800 continues.

In operation 2840, a determination is made as to whether a selection is made. If in operation 2840, it is determined that a selection is not made, control is passed to operation 2845 and process 2800 continues. If in operation 2840 it is determined that a selection is made, control is passed to operation 2850 and process 2800 continues.

The determination in operation 2840 may be made based on various criteria. In at least one embodiment, activation of an interface control by a referee may be used to determine whether a selection is made. In at least one embodiment, if an action is not selected within a pre-determined time period it may be determined that a selection is made. In at least one embodiment, an alternate referee and/or multiple referees may be used to determine whether a selection is made. For example, if a first selected referee does not respond, a different referee maybe provided with information of a decision. Similarly, if a number of referees provide a selection, a comparison of selections may be used to determine whether a selection is made. A comparison of selections may be based on a rating or ranking of a referee. A selection by a higher ranking referee may be given greater weight. A referee may make a selection implicitly. A referee may make a selection which may indicate an action is to be taken without explicit knowledge of content of the action.

In operation 2845 a default activity is performed. For example, if a referee does not select an action, or cannot determine an action the system may select a default action. A default action may be based on a threshold applied to a confidence function. A default action might be a selected based on a value of a confidence function. A default activity may be different than an action or operation associated with a trigger value and/or a threshold. Control is passed to operation 2855 and process 2800 continues.

In operation 2850 a selected response is performed. Any operation or action may be executed based on a selection by a referee. For example, if a referee determines that a query refers to a previous query and an automated response is associated with the query referencing the previous query the automated response might be provided to a user. A selected action may be any of a plurality of actions which are determined based on options provided to a referee guide. Control is passed to operation 2855 and process 2800 continues.

In operation 2855, process information is recorded. In at least one embodiment, a decision of a referee, a selected action, a time to interval for a selection, a type of decision and a system condition are recorded. Any information associated with the process 2800 may be recorded. In at least one embodiment, process information is recorded in the database 2320 (FIG. 23). Control is passed to operation 2805 and process 2800 continues.

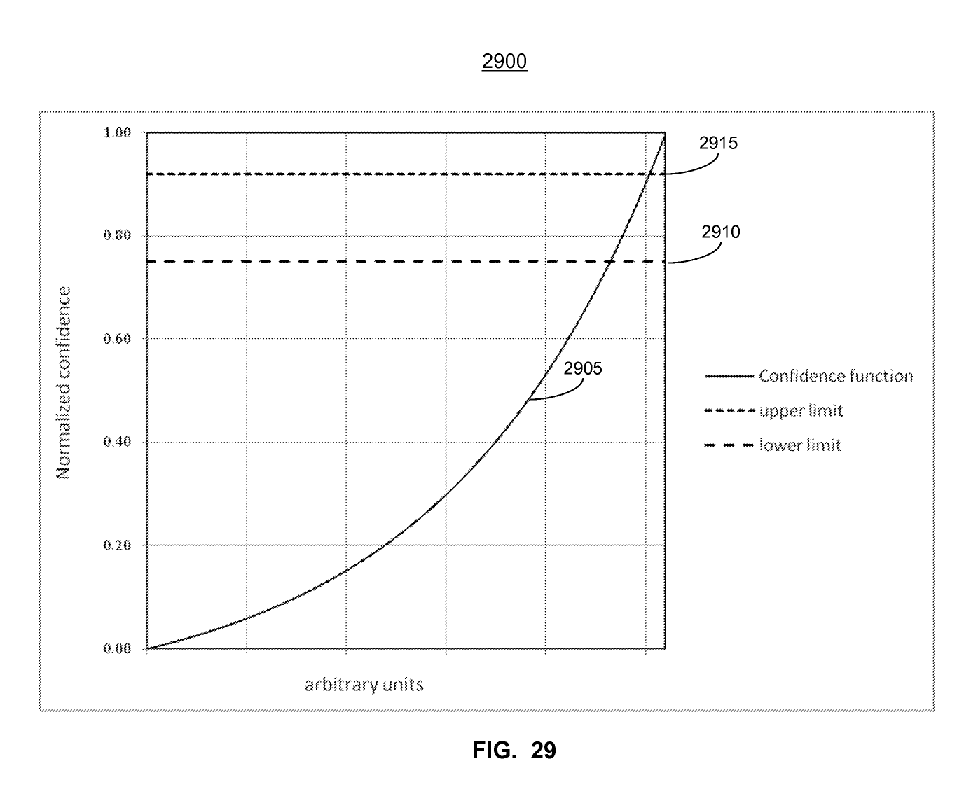

An exemplary confidence function diagram is illustrated in FIG. 29. A confidence function 2905 may be an indication of any type of condition. For example, matching of a first item to a second item, selection of a category of an item, probability that a request may be classified in a particular way, probability that a query is correctly formed, probability that a change should be applied, etc. maybe indicated by a confidence function. While the confidence function 2905 is depicted as a normalized function with values between zero and one, any type of scaling might be applied. While the confidence function 2905 is depicted as a smooth continuous function, other types of functions may be used within the scope of the embodiments disclosed herein. A lower limit 2910 may be used to determine a first action threshold. If the confidence function 2905 is below the lower limit 2910, a first action may be taken. For example, if the confidence function is measuring a probability that a query matches a previous query, and the confidence is less than the lower limit 2910, the query may be automatically directed to a guide. An upper limit 2915 may be used to determine a second action threshold. If the confidence function 2915 is above the upper limit 2915, a second action may be taken. Again using the example of a confidence function matching to a previous query, if the probability of a match exceeds the upper limit 2915, an answer associated with the matching previous query may be provided responsive to a query.

If a value of the confidence function 2905 is between the lower limit 2910 and the upper limit 2915, a decision may be determined to be ambiguous. In this case, a decision between a first action and a second action may be directed to a person. Using the example of a matching of a query to a previous query, a GUI such as the selection GUI 3100 (FIG. 31) may be provided to a guide to resolve an appropriate action.

A categorization GUI 3000 which may be provided to a guide such as a referee guide is illustrated in FIG. 30. The categorization GUI 3000 may include a task type indicator 3005, a decision window 3090, a next query indicator 3025, a next query control 3030, a current query indicator 3010, a selection topic indicator 3015, selection indicators 3020a-3020c, context information window 3035, location indicators 3040a-3040c, an activity indicator 3045a-3045c, context information filters 3050a-3050c, context query windows 3055a, 3055b, context query indicators 3060a, 3060b, context result indicators 3065a, 3065b, context query information indicators 3070a, 3070b, a query search control 3075, action controls 3080a-3080d, and a status control 3085.

The task type indicator 3005 may provide information of a type of task which is being provided. For example, if a guide is able to perform a number of types of tasks, the task type indicator 3005 may be used to inform the guide of a type of task which is presented. The decision window 3090 may include information and controls to allow a specific decision to be made. The current query indicator 3010 may include information of a request which is to be judged. As illustrated, a user query which refers to the previous query in the historical query window 3055a is provided in the current query indicator 3010. The selection topic indicator 3015 may be used to indicate a particular decision which is requested. As illustrated, a decision regarding how the query should be categorized is requested. The selection indicators 3020 may be used to indicate a selection. The selection indicator 3020a may be used to indicate that the query is about ‘Sports>Football >NFL’, the selection indicator 3020b may be used to indicate that the query is about ‘Conversation’ and the selection indicator 3020c may be used to indicate that the subject matter cannot be determined. For example, a filled circle associated with the selection indicator 3020c may indicate that it is activated. In a preferred embodiment, the selection indicators 3020 are mutually exclusive.

The next query control 3030 may be used to obtain information of a next task or query which may be provided. For example, if the next query control 3030 is activated, information associated with the query ‘Why is my BFF such a loozer?’ indicated in the next query indicator 3025 may be provided in the decision window 3090.

The customer information window 3035 may provide information of context associated with a request. The location indicator 3040a may provide information of a location associated with a user device. The location indicator 3040b may provide information of a residence and/or other fixed location associated with a user. The activity indicator 3045 may be used to hide and/or reveal context information when activated. For example, if a confidence function is influenced by context information, the context may be provided in the context information window 3035, which may accelerate processing of a query. The context information filters 3050 may be used to filter information presented in the context information window 3035. For example, the context information filter 3050b may cause context information to be presented in chronological order when activated. Any number or type of context information filter controls 3050 may be provided as needed for a given type of activity.

The context query windows 3055 include information of queries which may provide context for a decision. For example, the context query window 3055a includes information associated with a previous query related to the category ‘Sports>Football>NFL’ by the user submitting the query in the current query indicator 3010. The context query indicators 3060 may be used to provide information of a context query. For example, the context query indicator 3060b indicates content of a previous query which is conversational regarding ‘NFL’. The context result indicators 3065 may be used to provide information of a response associated with a context query. The context query information indicators 3070 may be used to provide additional information regarding a context query. For example, the context query indicator 3070a indicates a time interval associated with the query indicated in the context query window 3055a. The context query search control 3075 may be used to search for a context query. While particular examples of query content and information have been used for the purposes of illustration, after reading the disclosure herein, one of ordinary skill in the art will immediately recognize that other types of information regarding a context query such as a searcher, a user, a category, etc., and other types of media such as audio, images, etc. may be provided as information of a context query.

The action controls 3080 may be used to take various actions. The ‘Send Answer’ action control 3080a may cause a response indicated in the decision window 3090 to be submitted. The ‘Customer Clarify’ action control 3080b may be used to request further information regarding a query. The ‘Abort’ action control 3080c may be used to end an activity. The ‘Abuse’ action control 3080d may be used to report an inappropriate activity. The ‘Away’ status control 3085 may be used to indicate that a guide wishes to cease accepting requests when a current task is completed. The ‘Away’ status control 3085 may be implemented as a ‘check box’ or other equivalent control.

A selection GUI 3100 which may be provided to a guide such as a referee guide is illustrated in FIG. 31. The selection GUI 3100 may include a task type indicator 3105, a decision window 3190, a next query indicator 3125, a next query control 3130, a current query indicator 3110, a selection topic indicator 3115, selection indicators 3120a-3120c, context information window 3135, location indicators 3140a, 3140b, an activity indicator 3145, action controls 3180a-3180d, and a status control 3185.

The task type indicator 3105 may provide information of a type of task which is being provided. For example, if a guide is able to perform a number of types of tasks, the task type indicator 3105 may be used to inform the guide of a type of task which is presented. The decision window 3190 may include information and controls to allow a specific decision to be made. The current query indicator 3110 may include information of a request which is to be judged. As illustrated, a user query which may match one or more previous queries is provided in the current query indicator 3110. The selection topic indicator 3115 may be used to indicate a particular decision which is requested. As illustrated, a decision regarding which answer is best for the reference query is requested. The selection indicators 3120 may be used to indicate a selection. The selection indicator 3120a may be used to indicate that the first answer is the best answer to the query, the selection indicator 3120b may be used to indicate that the second answer is a best response, and the selection indicator 3120c may be used to indicate that neither answer is considered acceptable. For example, a filled circle associated with the selection indicator 3120a may indicate that it is activated. In a preferred embodiment, the selection indicators 3120 are mutually exclusive. As illustrated, answers may have similar automated matching scores to a query, while the correct choice is readily apparent to a person.

The next query control 3130 may be used to obtain information of a next task or query which may be provided. For example, if the next query control 3130 is activated, information associated with the query ‘Did NASA find water on the Moon?’ indicated in the next query indicator 3125 may be provided in the decision window 3190.

The customer information window 3135 may provide information of context associated with a request. The location indicator 3140a may provide information of a location associated with a user device. The location indicator 3140b may provide information of a residence and/or other fixed location associated with a user. The activity indicator 3145 may be used to hide and/or reveal context information when activated. For example, if a confidence calculation indicates that previous queries are not related to a current query, the recent activity indicator may default to a state which hides context information in the customer information window 3135.

The action controls 3180 may be used to take various actions. The ‘Send Answer’ action control 3180a may cause a response indicated in the decision window 3190 to be submitted. The ‘Customer Clarify’ action control 3180b may be used to request further information regarding a query. The ‘Abort’ action control 3180c may be used to end an activity. The ‘Abuse’ action control 3180d may be used to report an inappropriate activity. The ‘Away’ status control 3185 may be used to indicate that a guide wishes to cease accepting requests when a current task is completed. The ‘Away’ status control 3185 may be implemented as a ‘check box’ or other equivalent control.

A disambiguation GUI 3200 which may be provided to a guide such as a referee guide is illustrated in FIG. 32. The disambiguation GUI 3200 may include a task type indicator 3205, a decision window 3290, a next query indicator 3225, a next query control 3230, a current query indicator 3210, a selection topic indicator 3215, selection indicators 3220, context information window 3235, location indicators 3240, an activity indicator 3245, context information filters 3250, context query windows 3255, context query indicators 3260, context result indicators 3265, context query information indicators 3270, a query search control 3275, action controls 3280, and a status control 3285.

The task type indicator 3205 may provide information of a type of task which is being provided. For example, if a guide is able to perform a number of types of tasks, the task type indicator 3205 may be used to inform the guide of a type of task which is presented. The decision window 3290 may include information and controls to allow a specific decision to be made. The current query indicator 3210 may include information of a request which is to be judged. As illustrated, a user query which refers to the previous query in the historical query window 3255a is provided in the current query indicator 3210. The selection topic indicator 3215 may be used to indicate a particular decision which is requested. As illustrated, a decision regarding how the query should be directed is requested. The selection indicators 3220 may be used to indicate a selection. The selection indicator 3220a may be used to indicate that the query is requesting song lyrics, the selection indicator 3220b may be used to indicate that the query is requesting assistance from a guide. For example, a filled circle associated with the selection indicator 3220a may indicate that it is activated. A default state of the selection indicators 3220 may be established based on a confidence function associated with a decision. In a preferred embodiment, the selection indicators 3220 are mutually exclusive.

The next query control 3230 may be used to obtain information of a next task or query which may be provided. For example, if the next query control 3230 is activated, information associated with the query ‘What is the best way to turn scalp hair blue?’ indicated in the next query indicator 3225 may be provided in the decision window 3290.

The customer information window 3235 may provide information of context associated with a request. The location indicator 3240a may provide information of a location associated with a user device. The location indicator 3240b may provide information of a residence and/or other fixed location associated with a user. The activity indicator 3245 may be used to hide and/or reveal context information when activated. For example, if a confidence function is influenced by context information, the context may be provided in the context information window 3235, which may accelerate processing of a query. The context information filters 3250a-3250c may be used to filter information presented in the context information window 3235. For example, the context information filter 3250b may cause context information to be presented in chronological order when activated. Any number or type of context information filter controls 3250 may be provided as needed for a given type of activity.

The context query windows 3255 include information of queries which may provide context for a decision. For example, the context query window 3255a includes information associated with a previous query related to song lyrics by the user submitting the query in the current query indicator 3210. The context query indicators 3260 may be used to provide information of a context query. For example, the context query indicator 3260b indicates content of a previous query which is a reference to another previous query. The context result indicators 3265 may be used to provide information of a response associated with a context query. Using the example illustrated, the context result indicator 3265a may be useful in making a decision indicated in the decision window 3290. The context query information indicators 3270 may be used to provide additional information regarding a context query. For example, the context query indicator 3270a indicates a time interval associated with the query indicated in the context query window 3255a. The context query search control 3275 may be used to search for a context query. The context query search control 3275 may be implemented as a search box and a button, a drop-down list, a query predictor, etc. as are well known in the art.

The action controls 3280 may be used to take various actions. The ‘Send Answer’ action control 3280a may cause a response indicated in the decision window 3290 to be submitted. The ‘Customer Clarify’ action control 3280b may be used to request further information regarding a query. The ‘Abort’ action control 3280c may be used to end an activity. The ‘Abuse’ action control 3280d may be used to report an inappropriate activity. The ‘Away’ status control 3285 may be used to indicate that a guide wishes to cease accepting requests when a current task is completed. The ‘Away’ status control 3285 may be implemented as a ‘check box’ or other equivalent control.

While particular examples of query content and information have been used for the purposes of illustration, after reading the disclosure herein, one of ordinary skill in the art will immediately recognize that other types of information regarding a context query such as a searcher, a user, a category, etc., and other types of media such as audio, images, etc. may be provided as information of a context query. While the interfaces herein have been described using particular types of controls and elements, no limitation is implied thereby. Any controls or elements which are well known in the art which provide equivalent functionality may be used to implement the interfaces described herein within the scope and spirit of the embodiments herein. Any elements of the interfaces may be suppressed and/or presented in any suitable sequence for operating the embodiments.

While a few examples of decisions which might be made using human assistance based on a confidence function have been used for the purposes of illustration, no limitation is implied thereby. Any decision which is made using a confidence function may benefit from the methods and systems described herein. Query processing decisions regarding semantic processing, interpretation, context, etc. might be implemented using the system and methods described. Likewise, pattern recognition, image analysis, and/or any task which may use a predictor to make a decision could benefit from the embodiments disclosed herein.

Using the methods and systems described herein, an improved processing of a query or query may be realized. A human assistant may resolve a particular decision based on context associated with the decision. The human assistant may be selected to respond to any type decision making. A threshold is established at which a human assistant may be required. By permitting different action levels, quality may be improved, while cost and time to respond may be reduced.

When a decision is to be made based on a confidence function two or more thresholds may be applied. A high confidence or a low confidence may cause a respective automated action to be executed. If confidence is between a high confidence and a low confidence level, context of a decision associated with a confidence function is provided to a human assistant. A human assistant may evaluate context information and may determine a decision or action to be taken.

A confidence function may more easily learn from binary decisions by a human assistant making judgments. Such inputs may have advantages for machine learning as they may represent decisions which are internal mental processes of a person which might not be readily observable based on task inputs and outputs alone.

While the methods and systems described herein are disclosed in the context of human assisted processing of queries, many other types of human-machine hybrid systems might benefit from the systems. For example, systems which perform automated tasks such as controlling equipment, detecting changes in images, detecting abnormal conditions, etc. might operate normally in the ‘high’ or ‘low’ confidence areas. But if a false positive or false negative would have serious consequences, an automated system might request small but swift human intervention to confirm and/or make a decision. For example, a security system monitoring a plurality of cameras might request human attention when probability of an intruder was unclear, or an automated equipment navigation system might request human assistance when it was unable to determine if an object is a fixed obstacle or a shadow. The ratio of human monitors to automated monitors might be greatly reduced, while preserving sensitivity to potentially false negative detections of dangerous or critical conditions.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, FLASH etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method of processing a query, comprising:
receiving a query;
ranking, by a processor, a plurality of responders based on the query and a plurality of queries and responses received from and by the plurality of responders; and
notifying the plurality of responders of the query based on the ranking.

2. The method of claim 1, comprising:
ranking a responder based on content of the query and content of the plurality of queries and responses.

3. The method of claim 1, comprising:
ranking a responder based on a location associated with the query and the plurality of queries.

4. The method of claim 1, comprising:
ranking a responder based on chronological information associated with the query and the plurality of queries.

5. The method of claim 1, comprising:
ranking a responder based on chronological information associated with the query and the plurality of responses received from the responder.

6. The method of claim 1, comprising:
notifying a responder of the query subsequent to receiving a question from the responder, and prior to providing an answer to the question.

7. The method of claim 1, comprising:
removing a responder from the ranking when determining that the responder has been inactive for a predetermined time period.

8. The method of claim 1, comprising:
removing a responder from the ranking when determining that the responder has not responded to a predetermined number of queries associated with a parameter of the query.

9. The method of claim 1, comprising:
ranking a responder based on recurring requests associated with the responder.

10. The method of claim 1, comprising:
determining a ranking of a responder based on a category of the query wherein the responder distributes queries to a plurality of websites and the responses are received from users of the websites.

11. The method of claim 1, comprising:
determining whether to send the query to a responder based on an expected economic value associated with the query and a cost associated with the responder.

12. The method of claim 1 comprising:
computing a probability that a response to the query can be generated automatically;
performing an action when determining that the probability is above a value;
executing an operation when determining that the probability is below a threshold; and
directing a decision based on the query to a human assistant when determining the probability is between the threshold and the value.

13. The method of claim 12 comprising:
performing the action using a search resource determined by the query.

14. The method of claim 12 comprising:
performing the operation by an algorithmic process selected by the query.

15. The method of claim 1 comprising:
delivering an invitation to a user based on requests submitted by the user; and
registering the user as a responder when determining that the user has accepted the invitation.

16. The method of claim 13 comprising:
receiving a selection of a keyword from the responder; and
ranking the responder and the query based on the keyword.

17. The method of claim 13 comprising:
associating a keyword with a category;
associating the user with the category when the keyword is detected in a request submitted by the user;
notifying the user of the query when the query is associated with the category.

18. The method of claim 1 comprising:
ranking a responder based on queries received from the responder;
ranking the responder based on questions accepted by the responder and responses of the responder to the queries;
ranking the responder based on a time interval between receipt of the query and receipt of a response or a request from the responder;
inviting a user to be the responder based on a number of queries submitted by the user;
choosing a category of queries to be directed to the responder based on a plurality of keywords indicated by the queries;
ranking the responder based on a keyword selected by the responder;
receiving a request for an alert from the user; and
adjusting a rank of the category when the category is associated with the alert.

19. A non-transient computer readable storage medium storing therein a program for causing a computer to execute an operation, comprising:
receiving a query;
ranking a plurality of responders based on the query and a plurality of queries and responses received from and by the plurality of responders; and
notifying the plurality of responders of the query based on the ranking.

20. A system, comprising:
a search service device receiving a query, ranking a plurality of responders based on the query and a plurality of queries and responses received from and by the plurality of responders, and notifying the plurality of responders of the query based on the ranking.
